(19) United States
(12) Patent Application Publication
(10) Pub. No.: US 2025/0250941 A1
(43) Pub. Date: Aug. 7, 2025

(54) GAS TURBINE ENGINE

(71) Applicant: General Electric Company, Evendale, OH (US)

(72) Inventors: Daniel John Oehrle, West Chester, OH (US); Randy M. Vondrell, Newport, KY (US); Apolinario Barra Ruiz, Querétaro (MX)

(21) Appl. No.: 19/185,681

(22) Filed: Apr. 22, 2025

Related U.S. Application Data
(63) Continuation-in-part of application No. 18/824,100, filed on Sep. 4, 2024.
Application No. 18/824,100 is a continuation of application No. 17/972,720, filed on Oct. 25, 2022, now Pat. No. 12,104,539.

(51) Int. Cl. F02C 7/32; B64D 27/12

(52) U.S. Cl. CPC F02C 7/32; B64D 27/12

(57) ABSTRACT

A gas turbine engine defines an axial direction and a radial direction and comprises a turbomachine having an unducted primary fan, a core engine a combustor casing enclosing a combustor and defining an outer surface, a core cowl surrounding at least a portion of the core engine. The outer surface of the core cowl defines a peak cowl diameter (D) in the radial direction, and the outer surface of the combustor casing defines a maximum combustor casing diameter (d) along the radial direction. The core engine defines an overall core axial length (L) along the axial direction and an under-core cowl axial length (L1) along the axial direction. The gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L). The CDR is between 2.7 and 3.5 and the CLR is between 0.25 and 0.50.

### CROSS-REFERENCE TO RELATED APPLICATIONS

This application is a continuation in part application of U.S. application Ser. No. 18/824,100, filed Sep. 4, 2024, which is a continuation application of U.S. application Ser. No. 17/972,720 filed Oct. 25, 2022. Each of these applications are hereby incorporated by reference in their entireties.

### FIELD

The present disclosure relates to a gas turbine engine, such as an aeronautical gas turbine engine.

### BACKGROUND

A gas turbine engine generally includes a turbomachine. The turbomachine includes several engine accessories such as controllers, pumps, heat exchangers and the like that are necessary for operation. These engine accessories and engine systems may be mounted to the turbomachine.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is perspective view of an exemplary aircraft in accordance with an exemplary embodiment of the present disclosure.

FIG. 2 is a schematic cross-sectional view of a ducted turbofan gas turbine engine in accordance with an exemplary embodiment of the present disclosure.

FIG. 3 is a schematic cross-sectional view of a portion of the ducted turbofan gas turbine engine shown in FIG. 2, in accordance with an exemplary embodiment of the present disclosure.

FIG. 4 is a schematic cross-sectional view of a three-stream engine in accordance with an exemplary embodiment of the present disclosure.

FIG. 5 is an enlarged view of an exemplary fan blade according to exemplary embodiments of the present disclosure.

FIG. 6 is a schematic cross-sectional view of a portion of a core engine of the gas turbine engine as shown in FIG. 4, according to an exemplary embodiment of the present disclosure.

FIG. 7 is a front view of a portion of the gas turbine engine as shown in FIGS. 4 and 6, mounted to a portion of an exemplary wing according to exemplary embodiments of the present disclosure.

FIG. 8 is a schematic cross-sectional view of the gas turbine engine as shown in FIG. 4, according to an exemplary embodiment of the present disclosure.

FIG. 9 is a schematic cross-sectional view of the gas turbine engine as shown in FIG. 4, according to an exemplary embodiment of the present disclosure.

FIG. 10 is a schematic illustration including an engine component, a portion of a core cowl structure, an exemplary fastener and a portion of a core engine structure according to exemplary embodiments of the present disclosure.

FIG. 11 is a schematic illustration including an engine component, a portion of a core cowl structure, an exemplary fastener and a portion of a core engine structure according to exemplary embodiments of the present disclosure.

FIG. 12 is a schematic illustration including an engine component, a portion of a core cowl structure, a push-pull mechanism, and a portion of a core engine structure according to exemplary embodiments of the present disclosure.

FIG. 13 is a schematic illustration including an engine component, a portion of a core cowl structure, a push-pull mechanism, and a portion of a core engine structure according to exemplary embodiments of the present disclosure.

FIG. 14 is a graphical representation illustrating a relationship between CDR and CLR and showing relationships between the various parameters of Expressions (1) and (2) according to exemplary embodiments of the present disclosure.

FIG. 15 is a schematic cross-sectional view of a ducted turbofan engine in accordance with an exemplary embodiment of the present disclosure.

FIG. 16 is a graphical representation illustrating initial compression length ratio (ICLR) values for gas turbine engines in accordance with various exemplary embodiments of the present disclosure.

FIG. 17 is a schematic cross-sectional view of a gas turbine engine in accordance with an exemplary embodiment of the present disclosure.

FIG. 18 is a schematic view of an exemplary gearbox.

FIG. 19 is a schematic view of an exemplary computing system.

FIG. 20 is a schematic view of an exemplary heat exchanger assembly.

FIG. 21 is a schematic view of a gas turbine engine with a variable pitch fan.

FIG. 22 is a schematic view of a hybrid-electric gas turbine engine.

FIG. 23 is a cross-sectional view of a gas turbine engine in accordance with another exemplary aspect of the present disclosure.

FIG. 24 is a cross-sectional view of a gas turbine engine in accordance with still another exemplary aspect of the present disclosure.

FIG. 25 is a cross-sectional view of a cowl assembly in accordance with an exemplary aspect of the present disclosure.

FIG. 26 is a cross-sectional view of a cowl assembly in accordance with another exemplary aspect of the present disclosure.

FIG. 27 is an aft looking forward view of a cowl assembly in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or aircraft and refer to the normal operational attitude of the gas turbine engine or aircraft. For example, with regards to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

H ere and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “cowl” includes a housing, casing, or other structure that at least partially encases or surrounds a portion of a turbomachine or gas turbine engine.

The phrases “from X to Y” and “between X and Y” each refers to a range of values inclusive of the endpoints (i.e., refers to a range of values that includes both X and Y).

The term “propulsive efficiency” refers to an efficiency with which the energy contained in an engine's fuel is converted into kinetic energy for the vehicle incorporating the engine, to accelerate it, or to replace losses due to aerodynamic drag or gravity.

A s used herein, the term “rated speed” with reference to a gas turbine engine refers to a maximum rotational speed that the gas turbine engine may achieve while operating properly. For example, the gas turbine engine may be operating at the rated speed during maximum load operations, such as during takeoff operations.

The term “standard day operating condition” refers to ambient conditions of sea level altitude, 59 degrees Fahrenheit, and 60 percent relative humidity.

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, at a static flight speed, and/or at 86 degree Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

Conventional turbofan engine design practice has been to provide an outer nacelle surrounding the fan to provide relatively efficient thrust for the turbofan engine at high fan speeds (compared with an unducted fan). Such a configuration may generally limit a permissible size of the fan (i.e., a diameter of the fan). Generally, a turbofan engine includes a fan to provide a desired amount of thrust without overloading the fan blades (i.e., without increasing a disk loading of the fan blades of the fan beyond a certain threshold), and therefore to maintain a desired overall propulsive efficiency for the turbofan engine. The inventors of the present disclosure seek to drive the fan diameter higher, thereby to reduce fan pressure ratio while maintaining the same level of thrust to improve fuel efficiency. By increasing the fan diameter, however, an installation of the turbofan engine becomes more difficult. In addition, if an outer nacelle is maintained, the outer nacelle may become weight prohibitive with some larger diameter fans.

The inventors of the present disclosure found that for a three-stream gas turbine engine having an unducted primary fan (the outer nacelle removed) and a ducted secondary fan, with the secondary fan providing an airflow to a third stream of the gas turbine engine, an overall propulsive efficiency of the gas turbine engine that results from providing a high diameter fan may be maintained at a high level, while reducing the size of the primary fan. Such a configuration may maintain a desired overall propulsive efficiently for the gas turbine engine, or unexpectedly, may in fact increase the overall propulsive efficiency of the gas turbine engine. Further, by including a third stream, an axial length of the core engine may be reduced relative to the overall engine axial length by allowing for a portion of the airflow through the engine to flow through the third stream. This reduces an overall weight of the engine. However, the core engine must maintain a sufficient size to produce enough power to drive the primary fan and the ducted secondary fan.

Further, removing the outer nacelle and reducing the overall axial length of the core engine significantly reduces engine accessory storage space. A diameter of a core cowl may be increased to make room for the accessories between an engine casing and an inner surface of the core cowl, however, the core cowl diameter cannot be too large due to potential performance penalties such as excessive drag and installation difficulties.

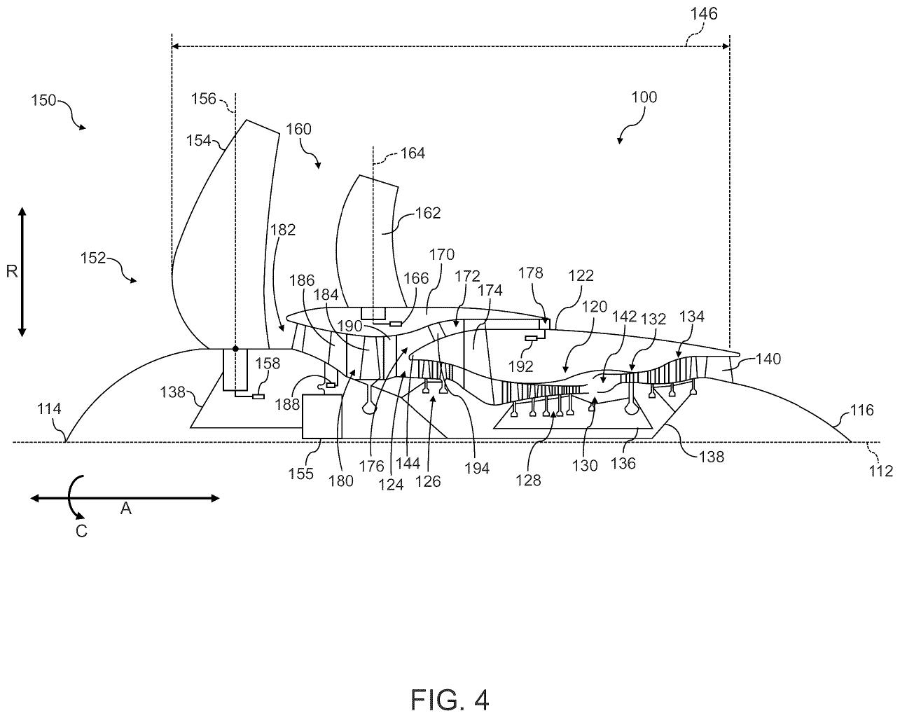

The inventors proceeded in the manner of designing a gas turbine engine with a given core cowl diameter, core diameter, core axial length, and overall engine axial length; checking the propulsive efficiency of the designed gas turbine engine; redesigning the gas turbine engine with varying core cowl diameters, core diameters, core axial lengths, and overall engine axial lengths; rechecking the propulsive efficiency of the redesigned gas turbine engine; and then making accommodations when, for example, it was found that subsystem sizes increased due to certification requirements and/or power requirements, or servicing needs impacted where to locate things during the design of several different types of gas turbine engines, including the gas turbine engine described below with reference to, e.g., FIGS. 4 through 8.

During the course of this practice of studying and evaluating various cowl diameters, core diameters, core length, and engine length considered feasible for best satisfying mission requirements, it was discovered that certain relationships exist between a core cowl diameter ratio (which is equal to a peak cowl diameter divided by a maximum combustor casing diameter) and a core cowl length ratio (which is equal to an under-core cowl axial length divided by an overall core axial length). In particular, the inventors of the present disclosure have found that these ratios can be thought of as an indicator of the ability of a gas turbine engine to provide sufficient packaging space between the core engine combustor casing and the core cowl for packaging/mounting various accessories and/or engine systems, while also having a core engine capable of producing sufficient power to drive primary and secondary fans, particularly in more complex engine designs. In some embodiments, the inventors found that selectively coupling one or more engine components such as an engine accessory or system component to one of the core cowl or to the engine improves accessibility for inspection, repair, and maintenance and improves weigh loads on the core engine.

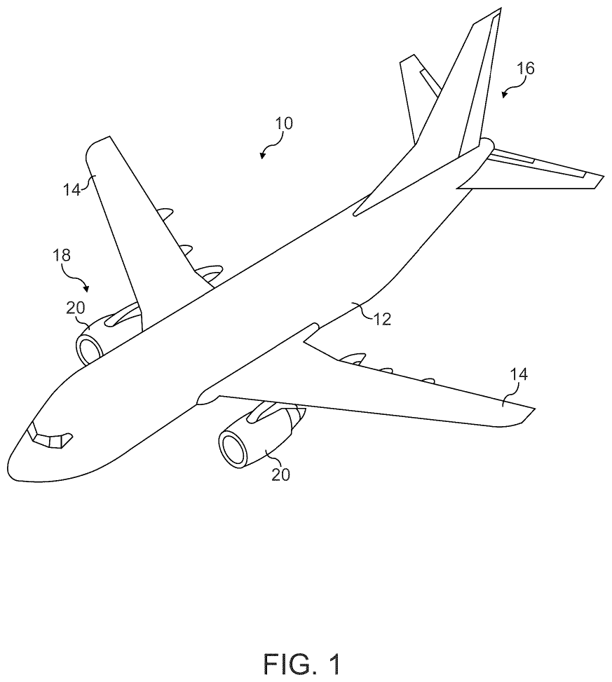

Referring now to the drawings, FIG. 1 is a perspective view of an exemplary aircraft 10 that may incorporate at least one exemplary embodiment of the present disclosure. As shown in FIG. 1, the aircraft 10 has a fuselage 12, wings 14 attached to the fuselage 12, and an empennage 16. The aircraft 10 further includes a propulsion system 18 that produces a propulsive thrust to propel the aircraft 10 in flight, during taxiing operations, etc. Although the propulsion system 18 is shown attached to the wing(s) 14, in other embodiments it may additionally or alternatively include one or more aspects coupled to other parts of the aircraft 10, such as, for example, the empennage 16, the fuselage 12, or both. The propulsion system 18 includes at least one engine. In the exemplary embodiment shown, the aircraft 10 includes a pair of gas turbine engines 20. Each gas turbine engine 20 is mounted to the aircraft 10 in an under-wing configuration. Each gas turbine engine 20 is capable of selectively generating a propulsive thrust for the aircraft 10. The gas turbine engines 20 may be configured to burn various forms of fuel including, but not limited to unless otherwise provided, jet fuel/aviation turbine fuel, and hydrogen fuel.

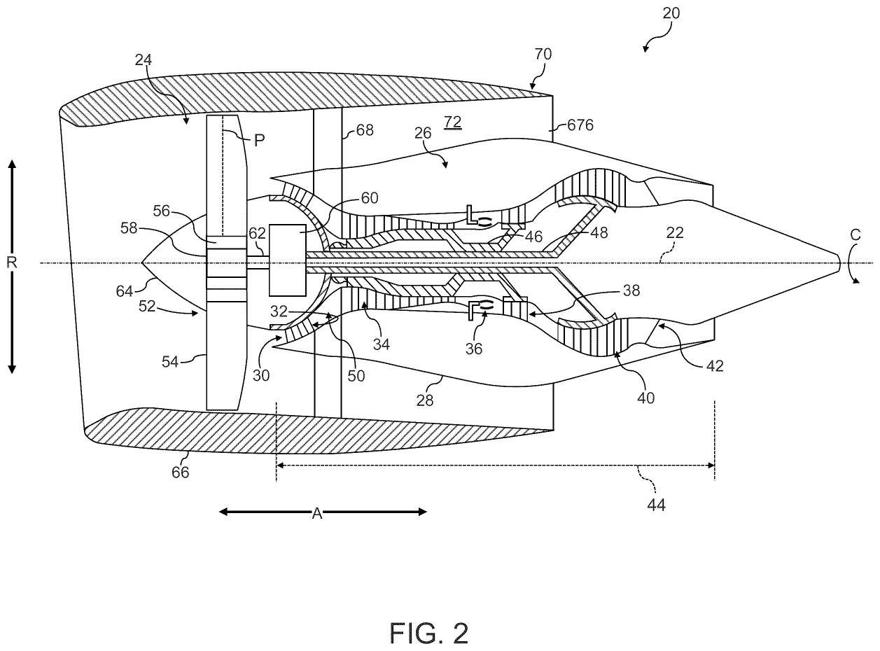

FIG. 2 is a cross-sectional side view of a gas turbine engine 20 in accordance with an exemplary embodiment of the present disclosure. M ore particularly, for the embodiment of FIG. 2, the gas turbine engine 20 is a multi-spool, high-bypass turbofan jet engine, sometimes also referred to as a “turbofan engine.” As shown in FIG. 2, the gas turbine engine 20 defines an axial direction A (extending parallel to a longitudinal centerline 22 provided for reference), a radial direction R, and a circumferential direction C extending about the longitudinal centerline 22. In general, the gas turbine engine 20 includes a fan section 24 and a turbomachine 26 disposed downstream from the fan section 24.

The exemplary turbomachine 26 depicted generally includes an engine housing, casing, or core cowl 28 that defines an annular core inlet 30. The core cowl 28 at least partially encases, in serial flow relationship, a compressor section including a booster or low-pressure compressor 32 and a high-pressure compressor 34, a combustion section 36, a turbine section including a high-pressure turbine 38 and a low-pressure turbine 40, and at least a portion of a jet exhaust nozzle 42. Together, these components or sections make up a core engine 44 of the turbomachine 26.

A high-pressure shaft 46 drivingly connects the high-pressure turbine 38 to the high-pressure compressor 34. A low-pressure shaft 48 drivingly connects the low-pressure turbine 40 to the low-pressure compressor 32. The compressor section, combustion section 36, turbine section, and jet exhaust nozzle 42 together define a working gas flow path 50 through the gas turbine engine 20.

For the embodiment depicted, the fan section 24 includes a fan 52 having a plurality of fan blades 54 coupled to a disk 56 in a spaced apart manner. As depicted, the fan blades 54 extend outwardly from disk 56 generally along the radial direction R. Each fan blade 54 is rotatable with the disk 56 about a pitch axis P by virtue of the fan blades 54 being operatively coupled to a suitable pitch change mechanism 58 configured to collectively vary the pitch of the fan blades 54, e.g., in unison. The fan blades 54, disk 56, and pitch change mechanism 58 are together rotatable about the longitudinal centerline 22 by the low-pressure shaft 48.

In an exemplary embodiment, as shown in FIG. 2, the gas turbine engine 20 further includes a power gearbox or gearbox 60. The gearbox 60 includes a plurality of gears for adjusting a rotational speed of the fan 52 relative to a rotational speed of the low-pressure shaft 48, such that the fan 52 and the low-pressure shaft 48 may rotate at more efficient relative speeds. The gearbox 60 may be any type of gearbox suitable to facilitate coupling the low-pressure shaft 48 to the fan 52 while allowing each of the low-pressure turbine 40 and the fan 52 to operate at a desired speed. For example, in some embodiments, the gearbox 60 may be a reduction gearbox. Utilizing a reduction gearbox may enable the comparatively higher speed operation of the low-pressure turbine 40 while maintaining fan speeds sufficient to provide for increased air bypass ratios, thereby allowing for efficient operation of the gas turbine engine 20. Moreover, utilizing a reduction gearbox may allow for a reduction in turbine stages that would otherwise be present (e.g., in direct drive engine configurations), thereby providing a reduction in weight and complexity of the engine.

Referring still to the exemplary embodiment of FIG. 2, the disk 56 is connected to the gearbox 60 via a fan shaft 62. The disk 56 is covered by a rotatable front hub 64 of the fan section 24 (sometimes also referred to as a “spinner”). The front hub 64 is aerodynamically contoured to promote an airflow through the plurality of fan blades 54. Additionally, the exemplary fan section 24 includes an annular fan casing or outer nacelle 66 that circumferentially surrounds the fan 52 and/or at least a portion of the turbomachine 26. The nacelle 66 is supported relative to the turbomachine 26 by a plurality of circumferentially spaced struts or outlet guide vanes 68 in the embodiment depicted. Moreover, a downstream section 70 of the nacelle 66 extends over an outer portion of the turbomachine 26 to define a bypass airflow passage 72 therebetween.

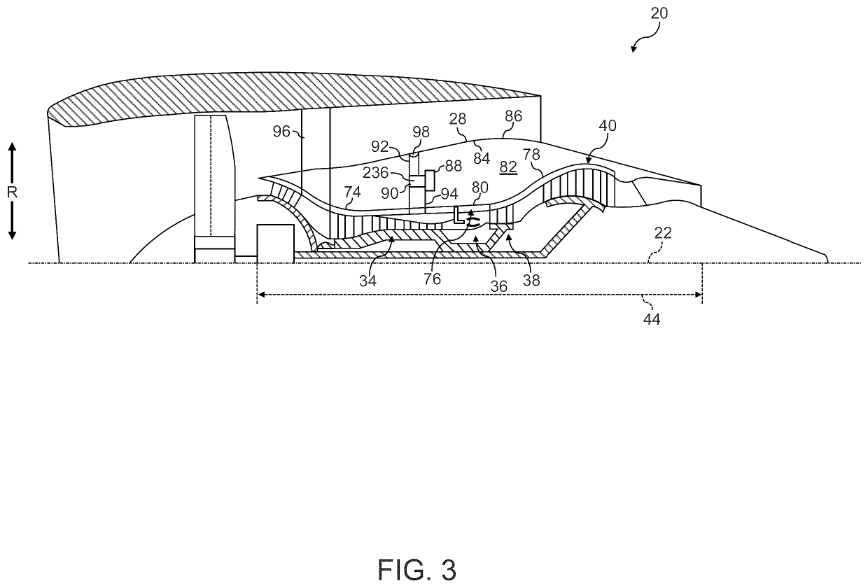

FIG. 3 is a schematic cross-sectional view of a portion of the core engine 44 of the gas turbine engine 20 as shown in FIG. 2, according to an exemplary embodiment of the present disclosure. As shown in FIG. 3, the high-pressure compressor 34 is encased within a compressor casing 74. The combustion section 36 is encased within a combustor casing 76. The high-pressure turbine 38 and the low-pressure turbine 40 are encased within one or more turbine casing(s) 78. The combustor casing 76 defines an outer surface 80. A void or space 82 is defined between an inner surface 84 of the core cowl 28 and the outer surface 80 of the combustor casing 76. The core cowl 28 further includes an outer surface 86 radially spaced from the inner surface 84 with respect to radial direction R. In exemplary embodiments, at least one engine component 88 is coupled to the core cowl 28 inner surface 84. The at least one engine component 88 may include but is not limited to valves, electronics including engine and system controllers, fire and overheat detection system components, fire extinguisher components, heat exchangers, pumps, generator, etc.

In exemplary embodiments, engine component 88 is selectively coupled to the core engine 44 or the core cowl 28. When the engine component 88 is coupled to the core cowl 28, the engine component 88 travels with the core cowl 28 when pivoted away from the core engine 44. When the engine component 88 is coupled to the core engine 44, the engine component 88 stays coupled to the core engine 44 when the core cowl 28 is pivoted away from the core engine 44. In exemplary embodiments and as previously presented, the engine component 88 is one of a heat exchanger, a sensor, a controller, a pump, a duct, a valve, fire and overheat detection system components, fire extinguisher components, or a generator. It should be appreciated that this list is not all inclusive of possible engine components that may be selectively coupled to the core cowl 28 or the core engine 44.

In exemplary embodiments, the engine component 88 is selectively coupled to the core engine 44 or the core cowl 28 via a fastener 90. As shown in FIG. 3, the fastener 90 may be disposed between a core cowl structure 92 such as a strut or bracket, and a core engine structure 94 such as a strut, a casing or bracket. The core cowl structure 92 may be fixedly coupled to the core cowl 28, such that the core cowl structure 92 moves with the core cowl 28, as described below. By contrast, the core engine structure 94 is not moveable with the core cowl 28 and instead may be fixedly coupled to a stationary and structural component of the core engine 44, such as the compressor casing 74 (as in the embodiment depicted), or one or more of the combustor casing 76, turbine casing 78, or a support frame such as a compressor frame 96, a mid-frame, or a rear support frame or turbine frame, etc.

The fastener 90 may be fixedly connected to the engine component 88. The fastener 90 may comprise a cam lock type fitting, bayonet fitting, quarter-turn fastener or other mechanical or electromechanical fastener or device that allows selectively coupling the engine component 88 to the core cowl 28 or the core engine 44. In particular embodiments, the core cowl 28 defines or includes an access opening or hatch 98 wherein the fastener 90 is accessible from the access opening 98.

It should be appreciated, however, that the exemplary gas turbine engine 20 depicted in FIGS. 2 and 3 is provided by way of example only, and that in other exemplary embodiments, the gas turbine engine 20 may have other configurations. For example, FIG. 4 is a schematic cross-sectional view of a gas turbine engine 100 according to another example embodiment of the present disclosure. Particularly, FIG. 4 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the engine 100 of FIG. 4 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

As shown in FIG. 4 the engine 100 includes a turbomachine 120 having a fan section 150 that is positioned upstream thereof. Generally, the turbomachine 120 includes, in serial flow order, a compressor section, a combustion section, a turbine section, and an exhaust section. Particularly, as shown in FIG. 4, the turbomachine 120 includes a housing or core cowl 122 that defines an annular core inlet 124. The core cowl 122 further encloses at least in part a low-pressure system and a high-pressure system. For example, the core cowl 122 depicted encloses and supports at least in part a booster or low-pressure (“LP”) compressor 126 for pressurizing the air that enters the turbomachine 120 through core inlet 124. A high-pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low-pressure” are used with respect to the high-pressure/high speed system and low-pressure/low speed system interchangeably. Further, it will be appreciated that the terms “high” and “low” are used in this same context to distinguish the two systems and are not meant to imply any absolute speed and/or pressure values.

The high energy combustion products flow from the combustor 130 downstream to a high-pressure turbine 132. The high-pressure turbine 132 drives the high-pressure compressor 128 through a high-pressure shaft 136. In this regard, the high-pressure turbine 128 is drivingly coupled with the high-pressure compressor 128. The high energy combustion products then flow to a low-pressure turbine 134. The low-pressure turbine 134 drives the low-pressure compressor 126 and components of the fan section 150 through a low-pressure shaft 138. In this regard, the low-pressure turbine 134 is drivingly coupled with the low-pressure compressor 126 and components of the fan section 150. The low-pressure shaft 138 is coaxial with the high-pressure shaft 136 in this example embodiment. After driving each of the high-pressure turbine 132 and the low-pressure turbine 134, the combustion products exit the turbomachine 120 through a rear support frame or turbomachine exhaust nozzle 140. A core engine 146 of the gas turbine engine 100 is defined as the part of the gas turbine engine 100 that extends from the fan section 150 to the rear support frame or turbomachine exhaust nozzle 140.

Accordingly, the turbomachine 120 defines a working gas flowpath or core duct 142 that extends between the core inlet 124 and the rear support frame or turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream. The fan section 150 includes a fan 152, which is the primary fan in this example embodiment. For the depicted embodiment of FIG. 4, the fan 152 is an open rotor or unducted fan 152. In such a manner, the engine 100 may be referred to as an open rotor engine. Moreover, it will be appreciated that the fan section 150 includes a single fan 152, and the fan 152 is the only unducted fan of the gas turbine engine 10 depicted.

As depicted, the fan 152 includes a plurality or an array of fan blades 154 (only one shown in FIG. 4). The fan blades 154 are rotatable, e.g., about the longitudinal axis 112. As noted above, the fan 152 is drivingly coupled with the low-pressure turbine 134 via the low-pressure shaft 138. For the embodiments shown in FIG. 1, the fan 152 is coupled with the low-pressure shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 4) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 4 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan housing or fan cowl 170.

As shown in FIG. 4, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low-pressure turbine 134 (e.g., coupled to the low-pressure shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 4) arranged in a single stage, such that the ducted fan 184 may be referred to as a single stage fan. The fan blades of the ducted fan 184 can be arranged in equal circumferential spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially extending and circumferentially spaced stationary struts 174 (only one shown in FIG. 4).

The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The exemplary engine 100 shown in FIG. 4 also defines or includes an inlet duct 180. The inlet duct 180 extends between the engine inlet 182 and the core inlet 124 and fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or the leading edge 144 of the core cowl 122. In the embodiment depicted, the inlet duct 180 is wider than the core duct 142 along the radial direction R. The inlet duct 180 is also wider than the fan duct 172 along the radial direction R.

Notably, for the embodiment depicted, the engine 100 includes one or more features to increase an efficiency of a third-stream thrust, Fn3S (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112.

Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third-stream thrust, Fn3S, during one or more engine operating conditions. Further, by introducing a variability in the geometry of the inlet guide vanes 186 and the fan exhaust nozzle 178, the engine 100 may be capable of generating more efficient third-stream thrust, Fn3S, across a relatively wide array of engine operating conditions, including takeoff and climb (where a maximum total engine thrust FnTotal, is generally needed) as well as cruise (where a lesser amount of total engine thrust, FnTotal, is generally needed).

Moreover, referring still to FIG. 4, in exemplary embodiments, air passing through the fan duct 172 may be relatively cooler (e.g., lower temperature) than one or more fluids utilized in the turbomachine 120. In this way, one or more heat exchangers 194 may be positioned in thermal communication with the fan duct 172. For example, one or more heat exchangers 194 may be disposed within the fan duct 172 and utilized to cool one or more fluids from the core engine 146 with the air passing through the fan duct 172, as a resource for removing heat from a fluid, e.g., compressor bleed air, oil or fuel.

Although not depicted in detail, the heat exchanger 194 may be an annular heat exchanger extending substantially 360 degrees in the fan duct 172 (e.g., at least 300 degrees, such as at least 330 degrees). In such a manner, the heat exchanger 194 may effectively utilize the air passing through the fan duct 172 to cool one or more systems of the engine 100 (e.g., lubrication oil systems, compressor bleed air, electrical components, etc.). The heat exchanger 194 uses the air passing through duct 172 as a heat sink and correspondingly increases the temperature of the air downstream of the heat exchanger 194 and exiting the fan exhaust nozzle 178.

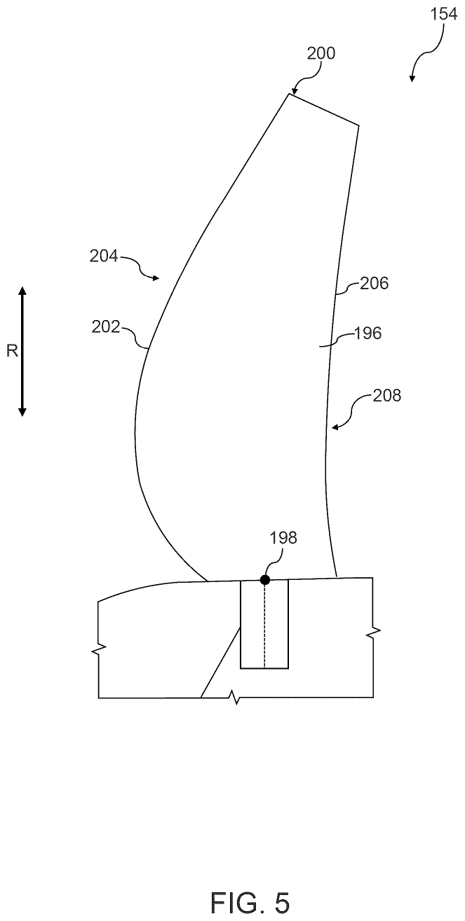

FIG. 5 is an enlarged view of an exemplary fan blade 154 of the plurality or array of fan blades 154 as shown in FIG. 4, according to exemplary embodiments of the present disclosure. As previously presented, each fan blade 154 has an airfoil or blade body 196. The blade body 196 spans in the radial direction R between a root 198 and a tip 200 of the blade body 196. The blade body 196 includes a leading edge 202 that extends along the span between the root 198 and the tip 200 along an upstream or forward portion 204 of the fan blade 154. The blade body 196 further includes a trailing edge 206 that extends along the span between the root 198 and the tip 200 along a downstream or aft portion 208 of the fan blade 154.

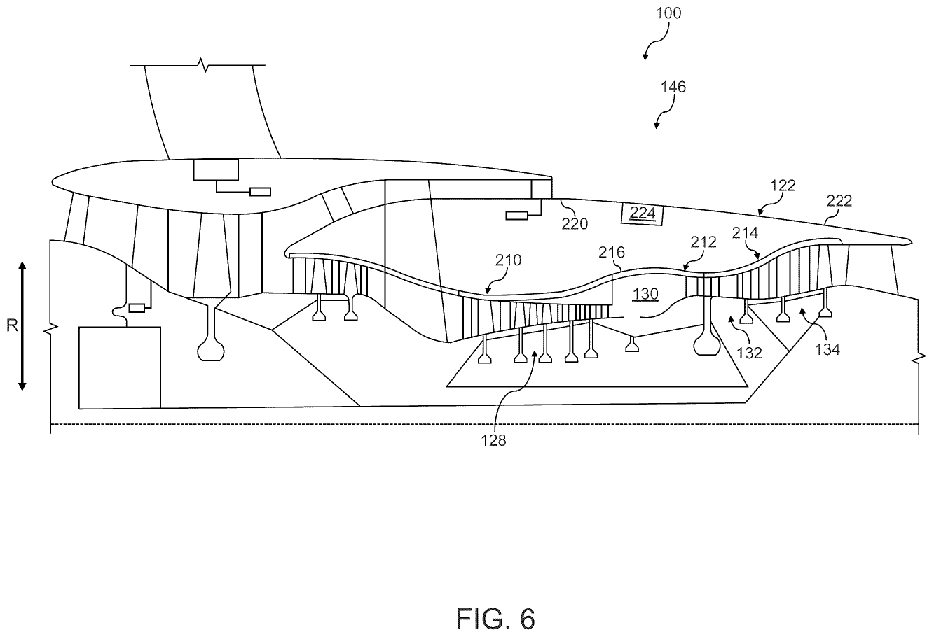

FIG. 6 is a schematic cross-sectional view of a portion of the core engine 146 of the gas turbine engine 100 as shown in FIG. 4, according to an exemplary embodiment of the present disclosure. As shown in FIG. 6, the high-pressure compressor 128 is encased within a compressor casing 210. The combustor 130 is encased within a combustor casing 212. The high-pressure turbine 132 and the low-pressure turbine 134 are encased within one or more turbine casing(s) 214. The combustor casing 212 defines an outer surface 216. A void or space 218 is defined between an inner surface 220 of the core cowl 122 and the outer surface 216 of the combustor casing 212. The core cowl 122 further includes an outer surface 222 radially spaced from the inner surface 220 with respect to radial direction R. In exemplary embodiments, at least one engine component 224 is attached to the core cowl 122 inner surface 220. The at least one engine component 224 may include but is not limited to valves, electronics including engine and system controllers, fire and overheat detection system components, fire extinguisher components, heat exchangers, pumps, generator, etc.

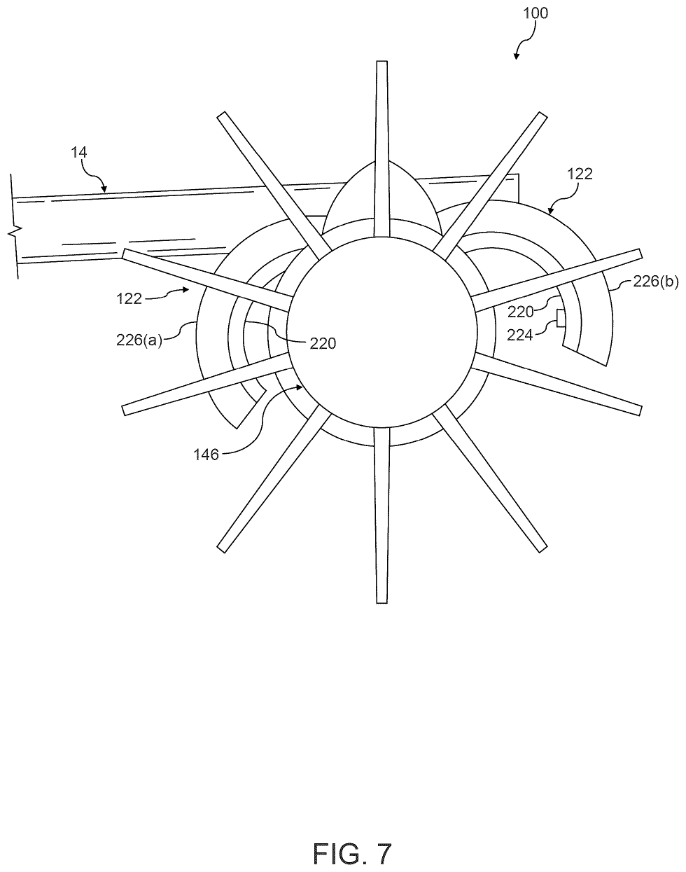

FIG. 7 is a front view of a portion of the gas turbine engine 100 as shown in FIGS. 4 and 6, mounted to a portion of an exemplary wing 14 according to exemplary embodiments of the present disclosure. It should be noted that fan section 150 (shown in FIG. 4) is not shown in FIG. 7 for clarity. As shown in FIG. 7, the core cowl 122 is formed from at least two shells 226(a), 226(b). It should be appreciated that the core cowl 122 shown in FIG. 7 may also be representative of the core cowl 28 shown in FIGS. 2 and 3. The shells 226(a), 226(b) are pivotally mounted to the gas turbine engine 100 to allow the shells 226(a), 226(b) to swing upward and away from the core engine 146, thereby exposing several engine accessories and systems of the core engine 146 such as engine component 224 or engine component 88 from FIG. 3, for inspection, repair, and maintenance. The shells 226(a), 226(b) are shown in FIG. 7 in an at least partially open state. When coupled to the inner surface 220 of the core cowl 122, the one or more engine accessories or engine systems will move with the core cowl 122 when the shells 226(a) and 226(b) are moved between open and closed positions.

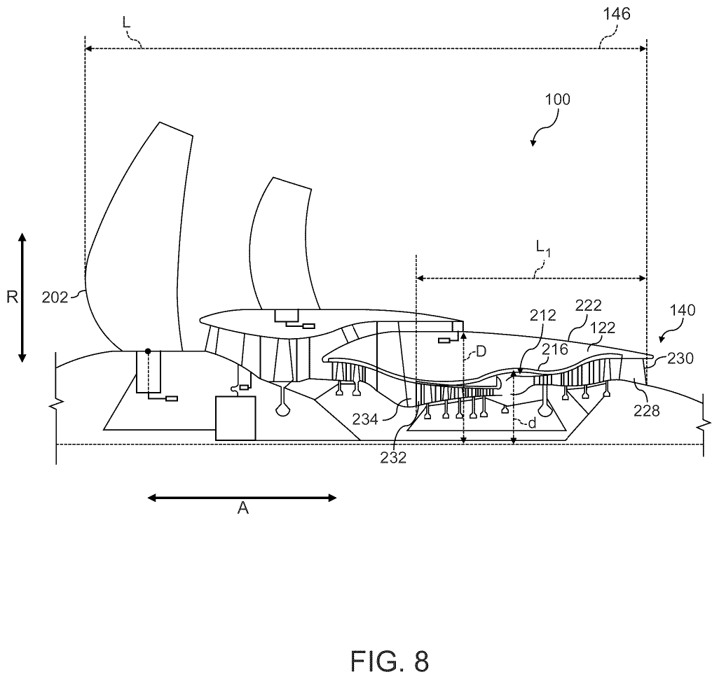

FIG. 8 is a schematic cross-sectional view of the gas turbine engine 100 as shown in FIG. 4, according to an exemplary embodiment of the present disclosure. As shown in FIG. 8 the outer surface 222 of the core cowl 122 defines a peak cowl diameter (D) in the radial direction R with respect to axial centerline 112. The outer surface 216 of the combustor casing 212 defines a maximum combustor casing diameter (d) along the radial direction R with respect to axial centerline 112. The core engine 146 defines an overall core axial length (L) along the axial direction A with respect to axial centerline 112. A n under-core cowl axial length (L1) is defined along the axial direction A with respect to axial centerline 112.

In exemplary embodiments, as shown in FIG. 8, the turbomachine rear support frame or exhaust nozzle 140 includes a strut 228 having a trailing edge 230 within a working gas flowpath of the gas turbine engine 100. The overall core axial length (L) is measured from a forward-most portion of the leading edge 202 of a respective primary fan blade 154 to an aft-most portion of the trailing edge 230 of the strut 228. The gas turbine engine 100 further includes a high-pressure compressor inlet guide vane 232 having a leading edge 234 where the under-core cowl axial length (L1) along the axial direction is measured from the leading edge 234 of the high-pressure compressor inlet guide vane 232 to the trailing edge of the strut 228.

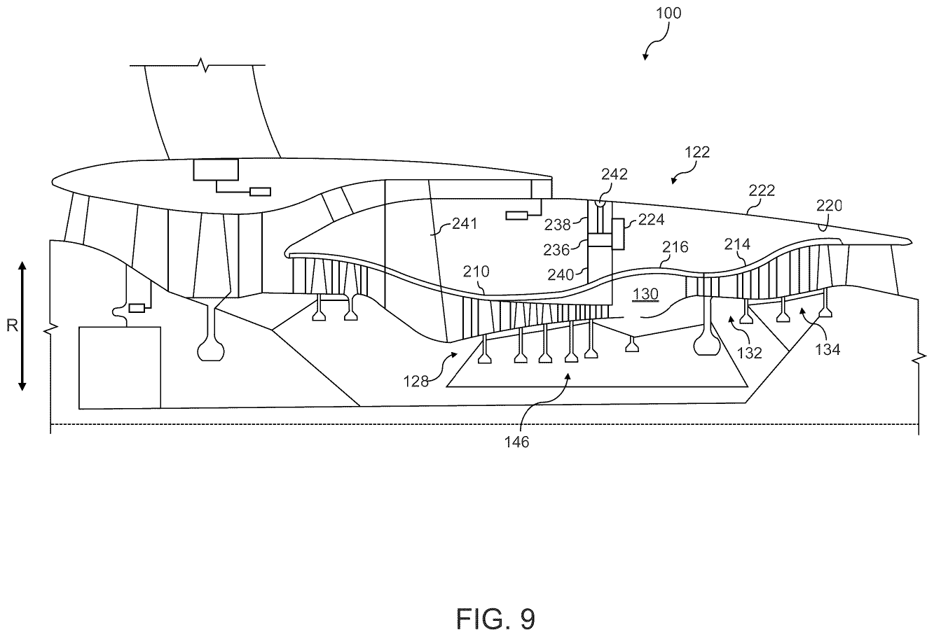

FIG. 9 is a schematic cross-sectional view of the gas turbine engine 100 as shown in FIG. 4, according to an exemplary embodiment of the present disclosure. In exemplary embodiments, engine component 224 is selectively coupled to the core engine 146 or the core cowl 122. When the engine component 224 is coupled to the core cowl 122, the engine component 224 travels with the core cowl 122 when pivoted away from the core engine 146. When the engine component 224 is coupled to the core engine 146, the engine component 224 stays coupled to the core engine 146 when the core cowl 122 is pivoted away from the core engine 146. In exemplary embodiments and as previously presented, the engine component 224 is one of a heat exchanger, a sensor, a controller, a pump, a duct, a valve, fire and overheat detection system components, fire extinguisher components, or a generator. It should be appreciated that this list is not all inclusive of possible engine components that may be selectively coupled to the core cowl 122 or the core engine 146.

In particular, it will be appreciated that in at least certain exemplary embodiments, the engine component 224 may be the controller, such as an engine controller, such as a full authority digital engine control (“FADEC”) controller. As will be appreciated, the gas turbine engine 100 depicted includes an unducted fan (see, e.g., unducted fan 152 in FIG. 4). In such a manner, the gas turbine engine 100 does not include a nacelle surrounding the fan (see, e.g., nacelle 66 surrounding fan 52 in FIG. 2). Without the nacelle, the engine controller may need to be located within the core cowl 122 of the gas turbine engine 100. As will further be appreciated, however, the environment within the core cowl 122 may be much hotter than within a nacelle, particularly closer to the turbomachinery components (e.g., the HP compressor, combustor, and HP turbine). Accordingly, positioning the engine controller outwardly along the radial direction R from the turbomachinery components and, e.g., selectively coupled to the core cowl 122 may reduce a temperature of the engine controller during operation of the gas turbine engine 100 to maintain a temperature of the engine controller below a maximum threshold for the electronics of the engine controller (e.g., below 200 degrees Fahrenheit), and allow for positioning of the engine controller within the core cowl 122. Briefly, a ratio of the peak cowl diameter (D) in the radial direction R and maximum combustor casing diameter (d) along the radial direction R may further facilitate such a positioning of the engine controller.

It should be appreciated, however, that in other embodiments, the engine component 224 may additionally or alternatively be any other suitable component traditionally found within a nacelle of a ducted gas turbine engine, such as a lubrication oil tank, a lubrication oil pump, power electronics (e.g., inverters), electric machines, etc. Moreover, although the engine controller is described as being positioned within the core cowl 122 above, in other embodiments, the engine controller and/or one or more other suitable components traditionally found within a nacelle of a ducted gas turbine engine may be positioned within a pylon used to mount the gas turbine engine to an aircraft (such as to a wing or fuselage of the aircraft).

In exemplary embodiments, the engine component 224 is selectively coupled to the core engine 146 or the core cowl 122 via a fastener 236. A s shown in FIG. 9, the fastener 236 may be disposed between a core cowl structure 238 such as a strut or bracket, and a core engine structure 240 such as a strut, a casing or bracket. The core cowl structure 238 may be fixedly coupled to the core cowl 122, such that the core cowl structure 238 moves with the core cowl 122, as described below. By contrast, the core engine structure 240 is not moveable with the core cowl 122 and instead may be fixedly coupled to a stationary and structural component of the core engine 146, such as the compressor casing 210 (as in the embodiment depicted), or one or more of the combustor casing 212, turbine casing 214, or a support frame such as a compressor frame 241, a mid-frame, or rear support frame (not shown) or turbomachine exhaust nozzle 140 (FIG. 2), etc.

The fastener 236 may be fixedly connected to the engine component 224. The fastener 236 may comprise a cam lock type fitting, bayonet fitting, quarter-turn fastener or other mechanical or electromechanical fastener or device that allows selectively coupling the engine component 224 to the core cowl 122 or the core engine 146. In particular embodiments, the core cowl 122 defines or includes an access opening or hatch 242 wherein the fastener 236 is accessible from the access opening 242.

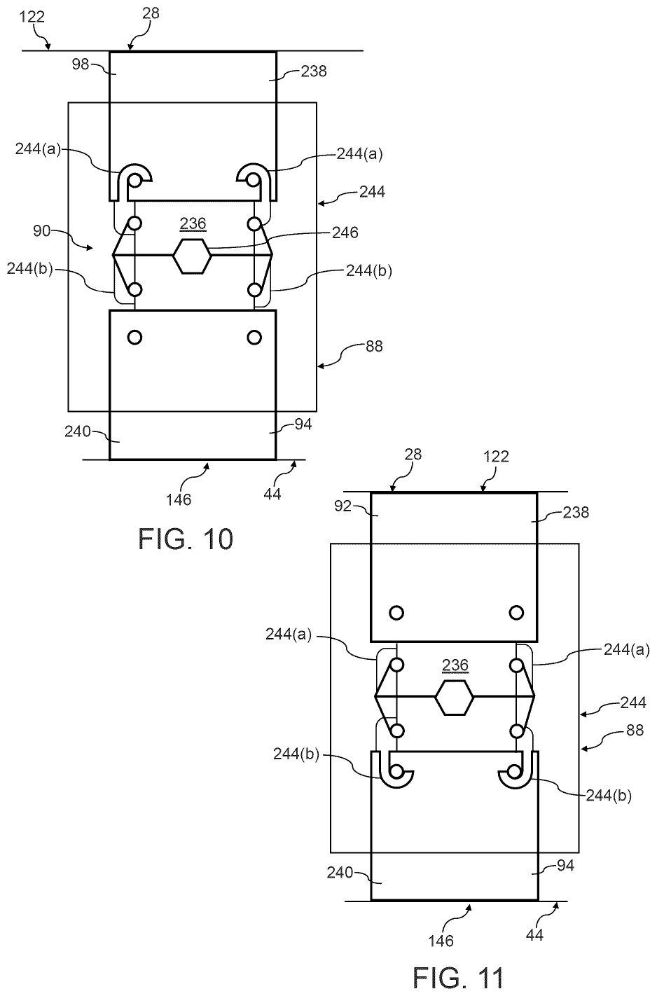

FIGS. 10 and 11 are schematic illustrations including engine component 224 or engine component 88, a portion of core cowl structure 238 or core cowl structure 92, an exemplary fastener 236 or fastener 90, and a portion of the core engine structure 240 or core engine structure 94 according to the present disclosure. In at least one embodiment, as shown in FIG. 10, the fastener 236, 90 includes a first plurality of articulating tabs 244(a) and a second plurality of articulating tabs 244(b). The tabs 244(a), 244(b) may be articulated about a pivot point 246 via a key or tool (not shown). The key or tool may inserted through the access opening 242, 98 shown in FIGS. 9 and 3.

In an exemplary embodiment, as show in FIG. 10, when in a first position the first plurality of tabs 244(a) engages with the core cowl structure 238, 92 and the second plurality of tabs 244(b) disengage from the core engine structure 240, 94, thereby coupling the engine component 224, 88 to the core cowl 122, 28 and decoupling the engine component 224, 88 from the core engine 146, 44. In this configuration, the engine component 224, 88 will travel with the core cowl 122, 28 when it is opened and rotated outward from the core engine 146, 44. In addition, in this configuration, the core cowl 122, 28 may carry the weight load of the engine component 224, 88 during operation of the gas turbine engine 100.

As shown in FIG. 11, when in a second position the first plurality of tabs 244(a) are disengaged from the core cowl structure 238, 92 and the second plurality of tabs 244(b) are engaged with the core engine structure 240, 94 thereby coupling the engine component 224, 88 to the core engine 146, 44, and decoupling the engine component 224, 88 from the core cowl 122, 28. In this configuration, the engine component 224, 88 will be rigidly coupled to the core engine 146, 44 whether the core cowl 122, 28 is opened or closed.

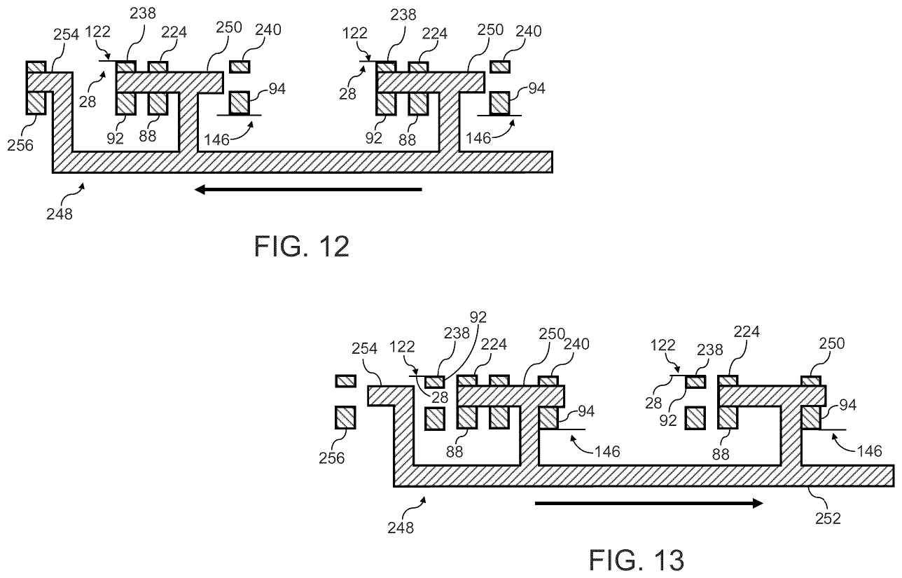

FIGS. 12 and 13 are schematic illustrations including engine component 224, 88, a portion of core cowl structure 238, 92, a push-pull mechanism 248, and a portion of the core engine structure 240, 94 according to exemplary embodiments of the present disclosure. In various embodiments, as shown in FIGS. 12 and 13, the engine component 224, 88 is selectively coupled to the core cowl 122, 28 (FIG. 12) or the core engine 146 (FIG. 13) via push-pull mechanism 248. The push-pull mechanism 248 includes at least one protrusion or pin 250 fixed to a slidable rod 252. In a first position, as shown in FIG. 12, the pin(s) 250 engage(s) with the engine component 224, 88 and the core cowl 122, 28 via the core cowl structure 238, 92 and are disengaged from the core engine 146. In a second position, as shown in FIG. 13, the pin(s) 250 engage(s) with the with the engine component 224, 88 and the core engine 146, 44 via the core engine structure 240, 94 and are disengaged or decoupled from the core cowl 122, 28. In exemplary embodiments, the slidable rod 252 may be manipulated between the first position and the second position by a technician manually. In other embodiments, the slidable rod 252 may be manipulated between the first position and the second position hydraulicly or electrically. The slidable rod 252 will be movable while the core cowl 122, 28 is in a closed or at least partially closed state.

In exemplary embodiments as shown in FIGS. 12 and 13, the push-pull mechanism includes a second pin 254. As shown in FIG. 12 the second pin 254 engages with a door counterbalance mechanism or system 256 when the first pin(s) 250 is/are engaged with the core cowl 122, 28 and the engine component 244, 88. In exemplary embodiments, the door counterbalance mechanism 256 includes either a spring, or pressurized gas strut to counterbalance the weight of the core cowl 122, 28 as it is manipulated between open and closed states.

As alluded to earlier, the inventors discovered, unexpectedly during the course of gas turbine engine design—i.e., designing gas turbine engines having a variety of different primary fan and secondary fan characteristics—and evaluating an overall propulsive efficiency, significant relationships exist in a ratio of a core cowl diameter ratio (CDR), equal to the peak cowl diameter (D) divided by the maximum combustor casing diameter (d), and a core cowl length ratio (CLR), equal to the under-core cowl axial length (L1) divided by the overall core axial length (L). These relationships can be thought of as an indicator of the ability of a gas turbine engine to provide sufficient packaging space between the core engine combustor casing and the core cowl for packaging/mounting various accessories and/or engine systems, while also having a core engine capable of producing sufficient power to drive primary and secondary fans, particularly in more complex engine designs.

As engines become more complex (e.g., hybrid electric/load sharing between shafts, closed-loop thermal management systems, hot fuel, unducted, etc.), a reduction in core cowl size is concomitantly desired for greater overall engine performance. This, along with, in the case of an open rotor design (FIG. 4), the elimination of an outer nacelle enclosing a primary fan of the engine, has posed a significant challenge with engine accessory and engine support system packaging design that was not previously present in earlier engine designs. It will also be appreciated that a reduction in overall core engine axial length results in a reduction in space for packaging various engine accessories and support system components which are typically coupled to the outer nacelle, the core engine casings, or to various support frames of the gas turbine engine, generally beneath the core cowl.

It will be appreciated that a larger core cowl diameter is preferred to accommodate the packaging needs of a particular gas turbine engine design. However, if the core cowl diameter is too large various issues such as excess drag and weight may affect overall engine performance or propulsion efficiency. In addition, or in the alternative, if the core cowl is too large for a particular gas turbine engine design, issues with mounting and installing the engine occur. It will also be appreciated that a smaller core length for a given engine design provides various benefits, including but not limited to, reduced overall engine weight. This particular design is enabled at least in part by the three-stream engine design described above which provides less flow through the engine core for a given thrust output. However, it is to be appreciated that the engine length cannot be too small because of the power required to drive primary and mid-fans of the three-stream engine.

It will moreover be appreciated that elements that previously were previously mounted to nacelle and that are temp sensitive, i.e., electronics, FADEC, have more limited/restricted areas where they can reside within the engine. For example, it was found that for the 3-stream engine embodiment that the FADEC is preferably located in the space located between third stream and outer nacelle, or forward of the compressor

It will moreover be appreciated that inventors considered placement alternatively within the aircraft pylon supporting the engine (not shown in drawings). The discovery, below (Expression (1) and (2)) may be equally insightful and define the packaging size in those cases where some of the engine components normally housed in nacelle are moved to pylon, and where those components are located within the core cowl.

Notably, however, an engine having a core cowl diameter ratio (CDR) within the ranges described herein, particularly when also having a core engine length ratio (CLR) within the ranges described herein, may be particularly suited for mounting one or more of the components traditionally found within a nacelle of a ducted gas turbine engine within the core cowl of the gas turbine engine. For example, an engine having a core cowl diameter ratio (CDR) within the ranges described herein, particularly when also having a core engine length ratio (CLR) within the ranges described herein, may have a sufficient amount of room for these components, and further may have a sufficient amount of separation from hot turbomachinery during operation to allow positioning of one or more of these components within the core cowl, for example, power electronics and a Full Authority Digital Engine Control (FADEC), temperature-sensitive sensors, power cables.

As noted above, the inventors of the present disclosure discovered bounding the relationships defined by the core cowl diameter ratio (CDR) to the core engine length ratio (CLR) can result in a gas turbine engine maintaining or even improving upon a desired propulsive efficiency, while also taking into account the gas turbine engine's packaging concerns, weight concerns, and power requirements. The relationship discovered, infra, can identify an improved engine configuration suited for a particular mission requirement, one that takes into account installation, packaging and loading, power requirements, and other factors influencing the optimal choice for an engine configuration.

In addition to yielding an improved gas turbine engine, as explained in detail above, utilizing this relationship, the inventors found that the number of suitable or feasible gas turbine engine designs incorporating a primary fan and a secondary fan, and defining a third stream, capable of meeting both the propulsive efficiency requirements and packaging, weight could be greatly diminished, thereby facilitating a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

The desired relationships providing for the improved gas turbine engine, discovered by the inventors, are expressed as:

$$CDR = D / d \qquad ( 1 )$$

$$CLR = L 1 / L \qquad ( 2 )$$

where CDR is maximum core cowl diameter D to maximum combustor casing diameter ratio d, and CLR is under-core cowl axial length L1 divided by overall core axial length L.

Values for various parameters of the influencing characteristics of an engine defined by Expressions (1) and (2) are set forth below in TABLE 1:

TABLE 1

| | | Ranges appropriate for using |
|---|---|---|
| Symbol | Description | Expression (1) |
| D/d | Core Cowl Diameter Ratio | 2.7 to 3.5, such as 2.8 to 3.3, |
| | (CDR) | such as 2.9 to 3.1 |
| L1/L | Core Cowl Length Ratio | 0.25 to 0.50, such as 0.3 to |
| | (CLR) | 0.45, such as 0.35 to 0.45, such |
| | | as .40 to .45 |

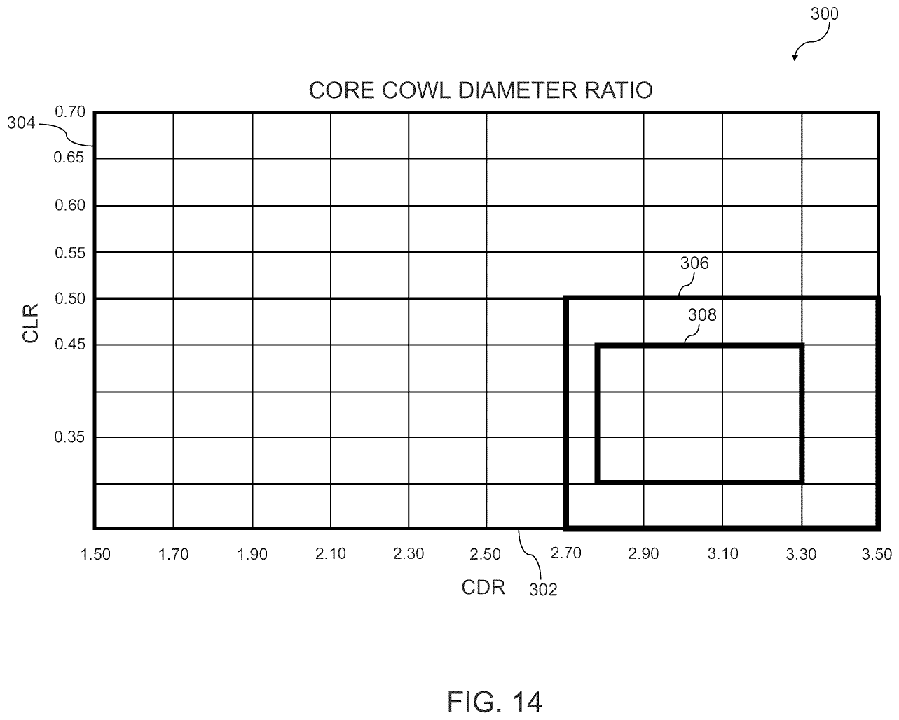

FIG. 14 is a plot 300 illustrating the relationship between CDR and CLR and showing the relationships between the various parameters of Expressions (1) and (2). The plot 300 includes CDR values on an X-axis 302 and CLR values on a Y-axis 304. The plot 300 depicts an area 306 of CDR and CLR values where a gas turbine engine would provide sufficient packaging space between a core engine combustor casing and a core cowl for packaging/mounting various accessories and/or engine systems, while also having a core engine capable of producing sufficient power to drive primary and secondary fans. The plot 300 further depicts an area 308 of CDR and CLR values where a gas turbine engine may provide more desired packaging space between the core engine combustor casing and the core cowl for packaging/mounting various accessories and/or engine systems, while also having the core engine capable of producing sufficient power to drive primary and secondary fans. The exemplary gas turbine engine of FIG. 4 defines a CDR and a CLR within the area 308.

It will be appreciated that although the discussion above is generally relating to the open rotor engine 100 described above with reference to, e.g., FIG. 8, in various embodiments of the present disclosure, the relationships outlined above with respect to, e.g., Expressions (1) and (2) may be applied to any other suitable engine architecture.

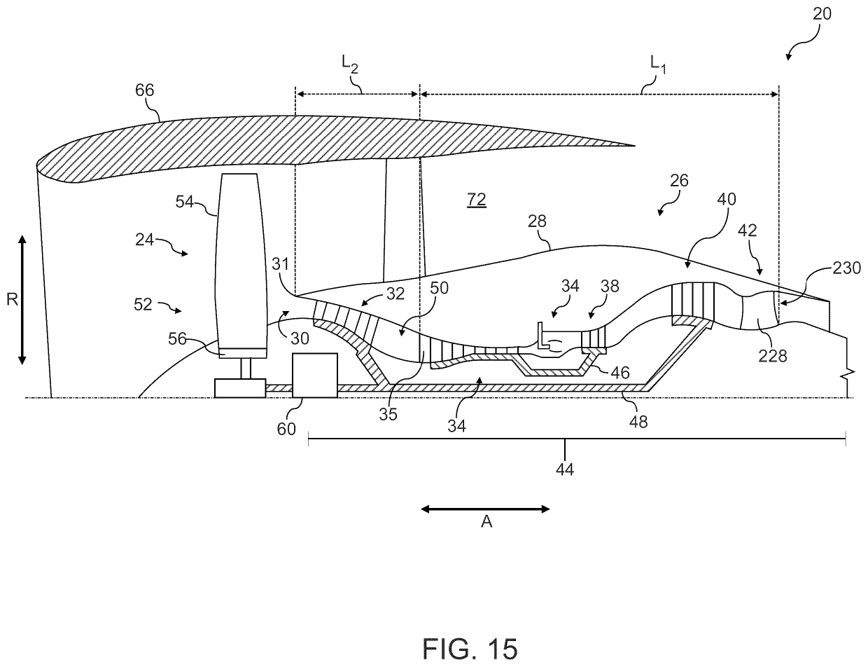

Referring now to FIG. 15, a gas turbine engine 20 in accordance with another exemplary aspect of the present disclosure is provided. The exemplary gas turbine engine of FIG. 15 is configured in a similar manner as the exemplary gas turbine engine 20 described above with reference to FIGS. 2 and 3. Accordingly, the exemplary gas turbine engine 20 of FIG. 15 is configured as a ducted gas turbine engine (i.e., includes a fan 52 with a nacelle 66 enclosing the fan 52). The same or similar numbers may refer to the same or similar parts.

For example, the gas turbine engine 20 generally includes a includes a fan section 24 and a turbomachine 26 disposed downstream from the fan section 24. The exemplary turbomachine 26 depicted generally includes an engine casing or core cowl 28 that defines an annular core inlet 30. The core cowl 28 at least partially encases, in serial flow relationship, a compressor section including a booster or low-pressure compressor 32 and a high-pressure compressor 34, a combustion section 36, a turbine section including a high-pressure turbine 38 and a low-pressure turbine 40, and at least a portion of a jet exhaust nozzle 42. Together, these components or sections make up a core engine 44 of the turbomachine 26.

A high-pressure shaft 46 drivingly connects the high-pressure turbine 38 to the high-pressure compressor 34. A low-pressure shaft 48 drivingly connects the low-pressure turbine 40 to the low-pressure compressor 32. The compressor section, combustion section 36, turbine section, and jet exhaust nozzle 42 together define a working gas flow path 50 through the gas turbine engine 20.

For the embodiment depicted, the fan section 24 includes a fan 52 having a plurality of fan blades 54 coupled to a disk 56 in a spaced apart manner. As depicted, the fan blades 54 extend outwardly from disk 56 generally along the radial direction R. The fan blades 54 are rotatable about the longitudinal centerline 22 by the low-pressure shaft 48.

In an exemplary embodiment, as shown in FIG. 15, the gas turbine engine 20 further includes a gearbox 60. The gearbox 60 includes a plurality of gears for adjusting a rotational speed of the fan 52 relative to a rotational speed of the low-pressure shaft 48, such that the fan 52 and the low-pressure shaft 48 may rotate at more efficient relative speeds. The gearbox 60 may be any type of gearbox suitable to facilitate coupling the low-pressure shaft 48 to the fan 52 while allowing each of the low-pressure turbine 40 and the fan 52 to operate at a desired speed. For example, in some embodiments, the gearbox 60 may be a reduction gearbox.

M ore specifically, in some embodiments, the gearbox 60 may define a gear ratio of the input rotational speed (e.g., the low-pressure shaft 48) to the output rotational speed greater than 3 and less than 14. For example, in certain exemplary embodiments, the gearbox 60 may define a gear ratio greater than 4, such as greater than 5, such as greater than 6 and less than 12, such as less than 11. Inclusion of the gearbox 60 with a relatively high gear ratio may allow for a relatively high diameter fan 52 in combination with a relatively high speed low-pressure turbine 40.

As will also be appreciated, the gas turbine engine 20 defines an under-core cowl axial length (L1) along an axial direction A. M ore specifically, the gas turbine engine 20 includes a high-pressure compressor inlet guide vane 35 having a leading edge (not labeled), where the under-core cowl axial length (L1) is measured along the axial direction A from the leading edge of the high-pressure compressor inlet guide vane 35 to a trailing edge 230 of a strut 228 extending through the exhaust nozzle 42 (which may be a strut of a turbine rear frame). The under-core cowl axial length (L1) is therefore generally a measure along the axial direction A from the high-pressure compressor 34 to the exhaust of the gas turbine engine 20.

Further, the gas turbine engine 20 defines an initial compression axial length (L2) along the axial direction A. The initial compression axial length (L2) is measured along the axial direction A from a splitter 31 positioned at the inlet 30 of the turbomachine 26 to the leading edge of the high-pressure compressor inlet guide vane 35. In the embodiment depicted, the low-pressure compressor 32 is located downstream of the splitter 31 and upstream of the leading edge of the high-pressure compressor inlet guide vane 35 (and is the only compressor within this axial location).

It will be appreciated, however, that in other exemplary embodiments, the compressor section may have one or more intermediate stages of compression (e.g., an intermediate-pressure compressor in addition to the low-pressure compressor 32).

Further, it will be appreciated that the exemplary gas turbine engine 20 depicted in FIG. 15 may be configured as a narrow-body engine (i.e., an engine configured to provide thrust to a narrow-body aircraft). In such a manner, the gas turbine engine 20 may be configured to generate at least 18,000 pounds of thrust and less than 80,000 pounds of thrust during operation at a rated speed during standard day operating conditions, such as between 25,000 and 60,000 pounds of thrust during operation at a rated speed during standard day operating conditions, such as between 25,000 and 50,000 pounds of thrust during operation at a rated speed during standard day operating conditions.

It will be appreciated that although the description of the under-core cowl axial length (L1) and the initial compression axial length (L2) is described above with reference to the gas turbine engine 20 of FIG. 15 (which includes a speed reduction device, i.e., reduction gearbox 60, for transmitting shaft power to the main or primary fan, a nacelle 66 enclosing fan 52; and is a two stream engine, i.e., includes a bypass airflow passage 72 and a working gas flowpath 50, but not a third stream), in other embodiments, aspects of the present disclosure may be applied to other suitable gas turbine engines. For example, in other embodiments, the aspects described herein with respect to the under-core cowl axial length (L1) and the initial compression axial length (L2) (and the ICLR, as defined below), may apply to an unducted gas turbine engine (i.e., does not include a nacelle surrounding the primary fan; see, e.g., FIG. 4), a three stream gas turbine engine (i.e., includes a third stream; see, e.g., FIG. 4), etc. Notably, when applied to a three stream gas turbine engine, the under-core cowl axial length (L1) may be defined from a splitter at an upstream-most inlet to a ducted portion of the engine, downstream of the primary fan (e.g., the splitter at the engine inlet 182 in FIG. 4) to the leading edge of the high-pressure compressor inlet guide vane 35.

As will be appreciated from the description herein, the inventors further discovered, unexpectedly, during the course of designing high bypass gas turbine engines (i.e., bypass ratio above 12) having a variety of turbomachine characteristics, a significant relationship exist in a ratio of the initial compression axial length (L2) to the under-core cowl axial length (L1). This ratio, referred to herein as an initial compression length ratio (ICLR), reflects a space available for packaging, including the portion of the undercowl space available for locating more temperature-sensitive components for engines, and accounting for the less space available because the fan duct size and space typically chosen for storing accessories and power or communications equipment is limited or no longer available (as bypass ratio increases, the weight and drag associated with the fan duct correspondingly increases in size so as to becomes too prohibitive unless the fan duct storage volume is reduced in size, thereby mitigating the drag and weight associated with the higher bypass area).

In some embodiments, when combined with the CDR, it was unexpectedly found that an undercowl space was discovered that best balanced the need for accommodating a high-pressure compressor having 9, 10 or 11 stages; or a high-pressure compressor having less than 8 stages combined with a low-pressure compressor (or booster) having 4, 5 or 6 stages, while meeting a need for reducing a drag profile or skin friction of the engine casing as much as possible. In other embodiments, it was unexpectedly found that an undercowl space was discovered that best balanced the need for accommodating a low-pressure turbine having 4, 5 or 6 stages while balancing the need for reducing a drag profile or skin friction of the engine casing as much as possible. Importantly, in each of these examples the CDR and ICLR values also account for the packaging needed in the casing for components that may no longer be stored in the fan nacelle or when the fan nacelle is no longer present (e.g., as discussed earlier in connection with the open fan).

Compared to more traditional turbofan engines that have a relatively low diameter fan that rotate relatively quickly as a result of being driven directly from a low-pressure turbine of the turbofan engine (i.e., without a reduction gearbox), the inventors have found that by using a higher diameter fan driven through a reduction gearbox, the under-core cowl length (L1) may be reduced. In particular, such allows the primary fan to rotate at a lower angular rate relative to the low-pressure turbine, which efficiency can increase by rotating at a higher rate while maintaining a desired tip speed of the fan. Higher speeds of the low-pressure turbine may allow for less stages while extracting the same (or greater) amount of power. The lower speeds of the fan may allow for the fan to increase in diameter, which leads to a higher bypass ratio and lowered specific fuel consumption.

However, reduction of L1 may impose additional stress on high-pressure components (e.g., the high-pressure compressor and a high-pressure turbine). In particular, increases in initial compression length ratio (ICLR) may generally require the overall compressor ratio to be increased, which generally results in higher temperatures and pressures at an exit of the high-pressure compressor and at an inlet to the high-pressure turbine. Accordingly, increasing the initial compression length ratio (ICLR) too much may create an undesirable amount of stress (and premature wear) on the gas turbine engine.

In addition to yielding an improved turbofan engine, as explained in detail above, utilizing this relationship, the inventors found that the number of suitable or feasible turbofan engine designs capable of meeting both the propulsive efficiency requirements and limited stress and wear requirements could be greatly diminished, thereby facilitating a more rapid down selection of designs to consider as a turbofan engine is being developed. Such a benefit provides more insight to the requirements for a given turbofan engine well before specific technologies, integration and system requirements are developed fully. Such a benefit avoids late-stage redesign.

The desired relationships providing for the improved turbofan engine, discovered by the inventors, are expressed as:

$$ICLR = L 2 / L 1 \qquad ( 3 )$$

where ICLR is a ratio of the initial compression axial length (L2) to the under-core cowl axial length (L1).

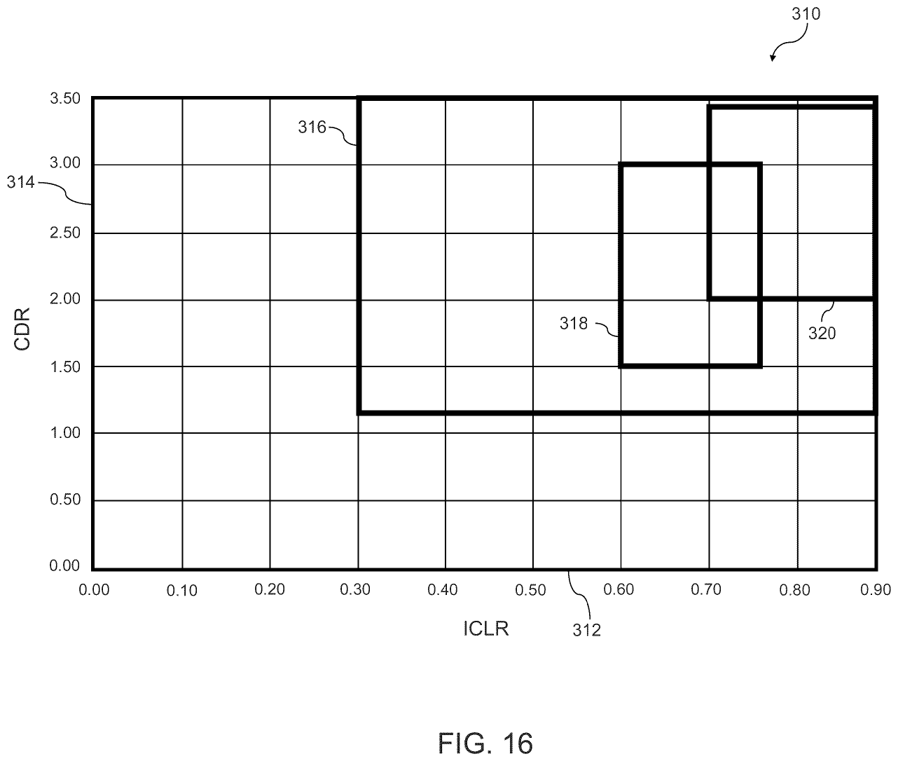

FIG. 16 is a plot 400 illustrating ICLR values, and more specifically, illustrating ICLR values along an X-axis 402 and CDR (Core Cowl Diameter Ratio) along the Y-axis 404. The plot 400 depicts an area 406 of ICLR values of a gas turbine engine in accordance with one or more aspects of the present disclosure where the gas turbine engine would provide desirable propulsive efficiency without overly stressing and wearing the gas turbine engine. The area 405 reflects ICLR values greater than or equal to 0.3 and less than or equal to 0.9, with CDR values greater than or equal to 1.24 and less than or equal to 3.5.

Referring still to the plot 400 of FIG. 16, the plot 400 further defines an area 408 of ICLR values of a gas turbine engine in accordance with one or more additional aspects of the present disclosure. The area 408 reflects ICLR values greater than or equal to 0.60 and less than or equal to 0.75, with C D R values greater than or equal to 1.5 and less than or equal to 3.0. The gas turbine engines of the present disclosure falling within the area 408 may be two stream turbofan engines (i.e., turbofan engines without a third stream), ducted turbofan engines, or both. As will be appreciated, two stream turbofan engines may not require as large of an initial compression axial length L2, and similarly ducted turbofan engines may be limited in maximum fan diameter (which as will be appreciated from the discussion above may similarly limit the ICLR). The exemplary gas turbine engine of FIG. 15 defines an ICLR and CDR within the area 408.

Referring still to the plot 400 of FIG. 16, the plot 400 further defines an area 410 of ICLR values of a gas turbine engine in accordance with one or more further aspects of the present disclosure. The area 410 reflects ICLR values greater than or equal to 0.70 and less than or equal to 0.89, with CDR values greater than or equal to 2.0 and less than or equal to 3.4. The gas turbine engines of the present disclosure falling within the area 410 may be three stream turbofan engines (i.e., turbofan engines including a third stream, such as the turbofan engines of FIGS. 4, 6, 8 and 9 having fan ducts 172), unducted turbofan engines, or both. As will be appreciated, three stream turbofan engines may include a larger initial compression axial length L2 (e.g., by virtue of the mid-fan), and similarly unducted turbofan engines may include a fan with a larger fan diameter (which as will be appreciated from the discussion above may allow for an increase in the ICLR). The exemplary gas turbine engine of FIG. 4 defines an ICLR and CDR within the area 410.

Notably, the above areas 406, 408, 410 may more specifically be directed to narrow-body engines. In such a manner, the gas turbine engines within these ranges may be configured to generate at least 18,000 pounds of thrust and less than 80,000 pounds of thrust during operation at a rated speed during standard day operating conditions, such as between 25,000 and 60,000 pounds of thrust during operation at a rated speed during standard day operating conditions, such as between 25,000 and 50,000 pounds of thrust during operation at a rated speed during standard day operating conditions. As will be appreciated, as an engine extends outside of this thrust class, a relationship of fan diameter, fan speed, high-pressure compressor size, and/or low-pressure turbine size may interact differently, such that the areas of ICLR values may not as readily capture desired gas turbine engines.

Another example of an unducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al.; including an annular fan case 13 surrounding the airfoil blades 21 of rotating element 20 and surrounding vanes 31 of stationary element 30; and including a third stream/fan duct 73 (shown in FIG. 10, described extensively throughout the application)). Various additional aspects of one or more of these embodiments are discussed below. These exemplary aspects may be combined with one or more of the exemplary gas turbine engine(s) discussed above with respect to the figures.

For example, in some embodiments of the present disclosure, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

A s such, it will be appreciated that an engine of such a configuration may be configured to generate at least 25,000 pounds and less than 80,000 of thrust during operation at a rated speed, such as between 25,000 and 50,000 pounds of thrust during operation at a rated speed, such as between 25,000 and 40,000 pounds of thrust during operation at a rated speed. Alternatively, in other exemplary aspects, an engine of the present disclosure may be configured to generate much less power, such as at least 2,000 pounds of thrust during operation at a rated speed.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R1/R2 may be between 1 and 10, or 2 and 7, or at least 3.3, at least 3.5, at least 4 and less than or equal to 7, where R1 is the radius of the primary fan and R2 is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low-pressure shaft coupled to a low-pressure turbine). In some embodiments, a gear ratio of the input rotational speed to the output rotational speed is between 3.0 and 4.0, between 3.2 and 3.5, or between 3.5 and 4.5 (inclusive of the endpoints). In some embodiments, a gear ratio of the input rotational speed to the output rotational speed is greater than 4.1. For example, in particular embodiments, the gear ratio is within a range of 4.1 to 14.0, within a range of 4.5 to 14.0, or within a range of 6.0 to 14.0. In certain embodiments, the gear ratio is within a range of 4.5 to 12 or within a range of 6.0 to 11.0.

With respect to a turbomachine of the gas turbine engine, the compressors and/or turbines can include various stage counts. A s disclosed herein, the stage count includes the number of rotors or blade stages in a particular component (e.g., a compressor or turbine). For example, in some embodiments, a low-pressure compressor may include 1 to 8 stages, a high-pressure compressor may include 4 to 15 stages, a high-pressure turbine may include 1 to 2 stages, and/or a low-pressure turbine (LPT) may include 1 to 7 stages. In particular, the LPT may have 4 stages, or between 4 and 7 stages. For example, in certain embodiments, an engine may include a one stage low-pressure compressor, an 11-stage high-pressure compressor, a two-stage high-pressure turbine, and 4 stages, or between 4 and 7 stages for the LPT. A s another example, an engine can include a three-stage low-pressure compressor, a 10-stage high-pressure compressor, a two stage high-pressure turbine, and a 7 stage low-pressure turbine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

Although depicted above as an unshrouded or open rotor engine in the embodiments depicted above, it should be appreciated that aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (D) of the engine, L/D of the engine, desired cruise altitude, and/or desired operating cruise speed, or combinations thereof.

In certain embodiments of the present disclosure, a gas turbine engine includes a fan cowl that defines an auxiliary or aft portion of a third stream, wherein at least one heat exchanger is coupled to or formed integrally with the fan cowl, such that the heat exchanger itself defines a portion of the flowpath. In this manner, the present disclosure contemplates using relatively cool airflow within the third stream for thermal management of the gas turbine engine (e.g., to cool lubrication oil). Such an arrangement of the fan cowl can provide a space radially outward thereof in which engine accessories can be housed, separate from hotter core engine regions. This can further advantageously allow maintenance personnel easier access to the heat exchanger and accessories by moving or opening a portion of the fan cowl.

Such a gas turbine engine configured in accordance with the description hereinbelow, while also defining a core cowl diameter ratio (CDR) and core cowl length ratio (CLR) in accordance with the description hereinabove, can provide significant benefits. In particular, a gas turbine engine configured in accordance with the description hereinbelow can integrate a fan duct (also referred to as a “third stream”) in a radial space around the combustor casing to integrate the fan stream into the gas turbine engine. Such an arrangement can provide sufficient clearance to mount a heat exchanger at a downstream end of the fan duct.

Moreover, while such an arrangement can take up undercowl space in the core cowl, particularly where such undercowl space is limited, such an arrangement may provide an increased amount of relatively cool undercowl space outward of the fan duct. In particular, such an arrangement may allow for increased accessory systems of the gas turbine engine to be mounted in an undercowl space, with the fan duct blocking heat from a core of the engine from reaching the accessories.

Accordingly, by reducing undercowl volume in one region (through an overall shortened or compact core engine, as given by set forth in CLR), the design may simultaneously increase appropriate mounting locations for certain engine accessories. Consequently, these redesigned undercowl areas not only ease packaging constraints but also help keep accessory system temperatures lower, thereby improving overall engine operability and packaging.

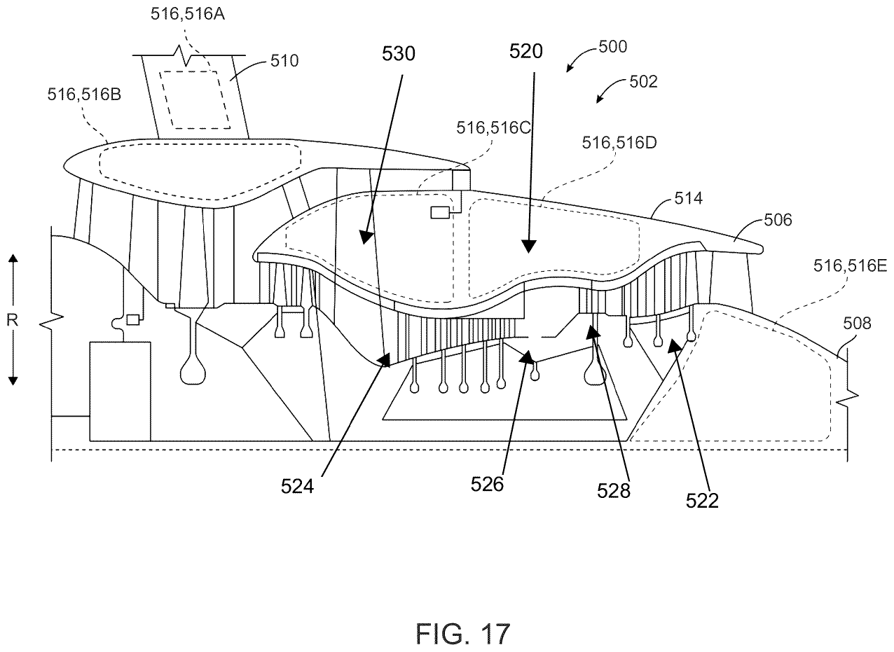

Now referring to FIG. 17, a schematic view of another gas turbine engine 500 is provided. The gas turbine engine 500 may be configured in a similar manner as one or more of the exemplary gas turbine engines described hereinabove. For example, the gas turbine engine 500 includes a turbomachine 502 including a fan cowl 504, a core cowl 506, a tail cone 508, and a pylon 510 extending from the fan cowl 504 to another component of an aircraft, such as a wing. The core cowl 506 includes a forward portion 512 (i.e., a forward 50% lengthwise along an axial direction A) and an aft portion 514 (i.e., an aft 50% lengthwise along the axial direction A). The tail cone 508 is disposed inward of the aft portion 514 in the radial direction R. The fan cowl 504 is disposed outward of the forward portion 512 in the radial direction R.

The gas turbine engine 500 includes a plurality of accessory cavities 516. The accessory cavities 516 are voids in various components of the gas turbine engine 500 that can house one or more other components (accessory systems). The pylon 510 defines a first accessory cavity 516A, the fan cowl 504 defines a second accessory cavity 516B, the forward portion 512 of the core cowl 506 defines a third accessory cavity 516C, the aft portion 514 of the core cowl 506 defines a fourth accessory cavity 516D, and the tail cone 508 defines a fifth accessory cavity 516E. It will be appreciated that other accessory cavities 516 may be defined in other components not shown in FIG. 17.

Briefly, it will further be appreciated that a core 520 of the gas turbine engine 500 and an LP turbine 522 may be cantilever mounted at a forward end of the core 520. The core 520 includes an HP compressor 524, a combustor 526, and an HP turbine 528 of the gas turbine engine 500. The core 520 and LP turbine 522 may be cantilever mounted through a compressor mid-frame 530 of the gas turbine engine 500.

Referring still to FIG. 17, the gas turbine engine 500 includes a plurality of accessory systems 518 positioned within one or more of these accessory cavities 516. In particular, in the embodiment shown, the first accessory cavity 516A defined in the pylon 510 includes a first accessory system 518A. The second accessory cavity 516B defined in the fan coal 504 includes a second accessory system 518B. The third accessory cavity 516C defined in the core cowl 506 includes a third accessory system 518C. The fourth accessory cavity 516D defined in the aft portion 514 of the core cowl 506 includes a fourth accessory system 518D. And the fifth accessory cavity 516E defined in the tail cone 508 includes a fifth accessory system 518C.

The first accessory cavity 516A is the coolest cavity of the above noted cavities 516A-E, and is also positioned in the closest proximity to the aircraft, such that it may be a relatively convenient location for an accessory system needing to communicate with or be in fluid communication or electrical communication with the aircraft. The second accessory cavity 516B is also a relatively cool cavity, with more space than the pylon 510 and in closer proximity to the components of the gas turbine engine 500. The third accessory cavity 516C and fourth accessory cavity 516D are hotter than the first and second accessory cavities 516A, B, but are positioned closer to various rotating components of the gas turbine engine 500, such as the core components of the gas turbine engine 500 (including an HP compressor 128 and an HP turbine 132). The third accessory cavity 516C is cooler than the fourth accessory cavity 516D and allows for more space without affecting the aerodynamic lines of the turbomachine 502. The fifth accessory cavity 516E provides good proximity to an LP shaft 138 of the gas turbine engine 500 and provides some available space.

The accessory systems of the gas turbine engine 500 can include an accessory gearbox and its associated accessories, such as a motor/generator, a fuel pump, an oil pump, etc. The accessory gearbox is generally mechanically coupled to one or more rotating components of the gas turbine engine 500, such as an HP shaft 136 of the gas turbine engine 500. In such a manner, the accessory gearbox can be in the position of the third accessory system 518C, the fourth accessory system 518D, the fifth accessory system 518E, or combinations thereof in FIG. 17. That is, some components of the accessory gearbox may be in multiple positions of the accessory systems 518C-E. Such locations can provide close proximity for a mechanical connection with the HP shaft 136.

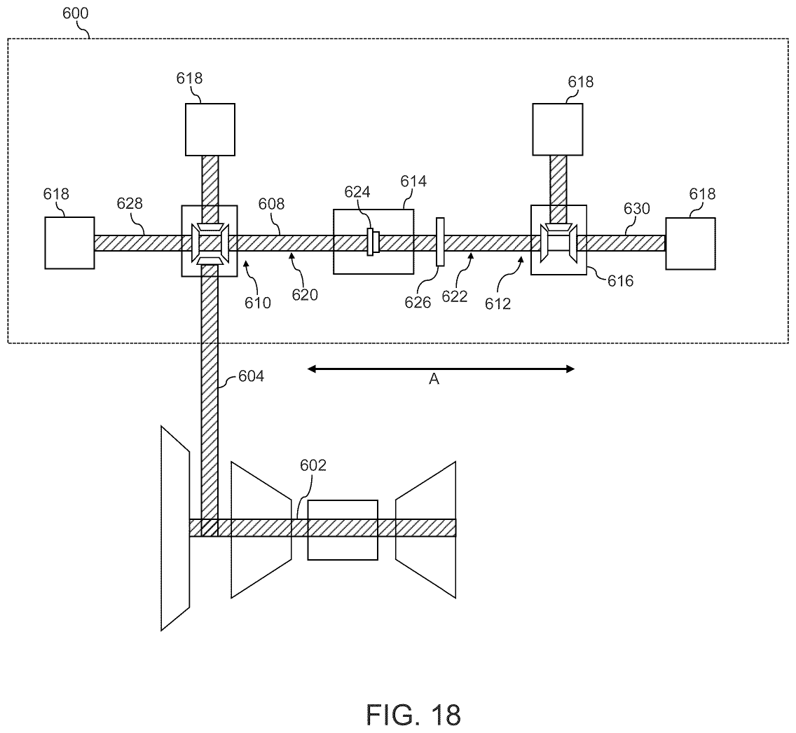

Referring to FIG. 18, an exemplary diagram of an accessory gearbox 600 is generally provided. The accessory gearbox 600 is coupled to an engine shaft 602 (such as an LP shaft 138) via a towershaft 604 rotatable with and extended from the engine shaft 602. In the embodiment shown in FIG. 1, the towershaft 604 is generally extended at least partially along the radial direction R from the engine shaft 602. The towershaft 604 may extend generally perpendicular to the engine shaft 602. In other embodiments, the towershaft 604 may extend at an acute angle relative to an axial centerline such that the accessory gearbox 600 is disposed forward or aft of the engine shaft 602 along the axial direction A.

The towershaft 604 is further coupled to a first gearbox 606 of the accessory gearbox 600. The towershaft 604 transmits mechanical energy to and from the engine shaft 602 through the first gearbox 606. The accessory gearbox 600 generally includes at least a first shaft 608 defining a first end 610 and a second end 612. The first shaft 608 extends from the first end 610 mechanically coupled to the first gearbox 606 and through a torque transfer assembly 614, to which the first shaft 608 is also mechanically coupled. The second end 612 of the first shaft 608 is mechanically coupled to a second gearbox 616.

One or more gearbox accessories 618 are coupled to each of the first gearbox 606 and the second gearbox 616. In various embodiments, the torque transfer assembly 614 defines one or more gearbox accessories 618. Gearbox accessories 618 may include, but are not limited to, one or more of pumps, boosters, scavenges, alternators, generators, starters, and/or blowers. The gearbox accessories 618 may include a fluid, such as fuel, oil, air, hydraulic fluid, or combinations thereof, through which are flowed, pressurized, and/or thermally conditioned. For example, in various embodiments, the torque transfer assembly 614 includes one or more gearbox accessories 618 that define, but are not limited to, an oil or fuel boost pump, a fuel metering unit, an air, fuel, hydraulic fluid, and/or oil heat exchanger, or combinations thereof. The torque transfer assembly 614 transmits power or torque between the first gearbox 606 and the second gearbox 616. In still various embodiments, the one or more gearbox accessories 618 coupled to the first and second gearboxes 606, 616 include a lube pump, a starter, a fuel metering unit, a permanent magnet alternator/generator, a variable frequency generator, or a blower, or combinations thereof.

Each of the first gearbox 606 and the second gearbox 616 may include a plurality of gears coupled within each gearbox 606, 616 to transmit and direct mechanical energy from the first shaft 608. In various embodiments, at least some of the gears are coupled onto the first shaft 608 and in arrangement with other gears to transmit mechanical energy to the gearbox accessories 618.

During operation of the gas turbine engine 100, the accessory gearbox 600 may define a gearbox accessory 618 as a starter, in which the starter provides mechanical energy to the engine shaft 602 through the first or second gearbox 606, 616, through the first shaft 608, and, in various embodiments, through the torque transfer assembly 614. The mechanical energy from the starter begins an initial rotation of the engine shaft 602 and the portions of the compressor section and turbine section to which they are attached.

The engine shaft 602 and the towershaft 604 together transmit mechanical energy to the first gearbox 606 in serial arrangement. The torque transfer assembly 614 transmits mechanical energy to the gearbox accessories 618 of the first gearbox 606 and the second gearbox 616 in parallel arrangement. In various embodiments, the one or more gearbox accessories 618 of the first gearbox 606 receive or transmit mechanical energy from/to the first gearbox 606 in parallel arrangement relative to one another. The one or more gearbox accessories 618 of the second gearbox 616 receive or transmit mechanical energy from/to the second gearbox 616 in parallel arrangement relative to one another.

The first shaft 608 defines a drive shaft 620 and a quill shaft 622. The drive shaft 620 is disposed at least partially within the quill shaft 622. The drive shaft 620 may be disposed at least partially within the quill shaft 622. The first shaft 608 may further include a locking mechanism 624 to engage or disengage the drive shaft 620 from the quill shaft 622 or the gearbox accessories 618 from the gearboxes 606, 616. The locking mechanism 624 may include a clamp or collar disposed on the first shaft 608 and/or within the gearboxes 606, 616. In one embodiment, the first shaft 608 further includes a stop collar 626 that sets a maximum lateral movement of the drive shaft 620 relative to the quill shaft 622. For example, the drive shaft 620 may engage or disengage from the quill shaft 622 along the axial direction A. The stop collar 626 may define a maximum distance along the axial direction A to which the drive shaft 620 may displace within the quill shaft 622. The drive shaft 620 and the quill shaft 622 may further engage or disengage within and from the torque transfer assembly 614. For example, the locking mechanism may engage/disengage the first gearbox 606 and/or the second gearbox 616 from the torque transfer assembly 614. A s such, the first shaft 608 enables assembly/disassembly of the torque transfer assembly 614 from the first gearbox 606 and the second gearbox 616 without assembling/disassembling the entire accessory gearbox assembly 100 to/from the engine 10.

The accessory gearbox 600 further includes a first gearbox shaft 628 driving the first gearbox 606 and its gearbox accessories 618 and a second gearbox shaft 630 driving the second gearbox 616 and its gearbox accessories 618. The first gearbox shaft 628 and the second gearbox shaft 630 are generally co-axial with the first shaft 608 defining the drive shaft 620 and the quill shaft 622. The drive shaft 620 may be moved into the first gearbox shaft 628, the second gearbox shaft 630, or both generally along the axial direction A or to the quill shaft 622 to remove the torque transfer assembly 614. In various embodiments, the first gearbox 606 and the second gearbox 616 are generally fixed within the accessory gearbox 600 such that the torque transfer assembly 614 is generally only displaced (e.g., removed) during maintenance of the accessory gearbox 600.

Referring back to FIG. 17, the accessory systems of the gas turbine engine 500 can include a Full Authority Digital Engine Control (“FADEC”), which is a computer system for controlling aspects of the gas turbine engine 500, e.g., using data from sensors to automatically adjust engine settings based on measurements of engine temperature, pressure, fuel flow, and air density. The FADEC can be located in the position of the first accessory system 516A, which would provide for a relatively cool mounting environment and close proximity to the rest of the aircraft.

However, space can be limited in the pylon 510. In such a manner, the FADEC can additionally or alternatively be located in the position of the second accessory system 518B, which would have the added benefit of positioning the FADEC in closer proximity to various sensors and control aspects of the gas turbine engine 500.

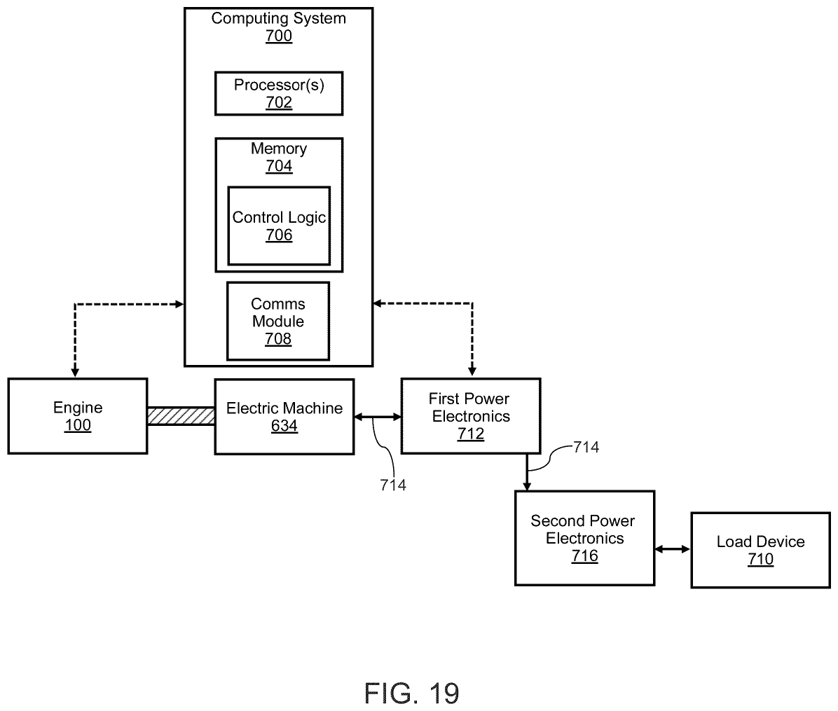

With reference to FIG. 19, a computing system 700 for a gas turbine engine is provided. The FADEC noted above may be configured in a similar manner as the computing system 700 of FIG. 19.

The computing system 700 is configured to output command controls, perform operations, and/or store one or more charts, graphs, tables, curves, limits, or schedules in accordance with operations, instructions, steps, or methods described herein. The computing system 700 is communicatively coupled to the gas turbine engine 100 to generate power or torque to be extracted by the electric machine 634 to generate electric power to another component, represented in FIG. 19 as a load device 710. The computing system 700 may be a full authority digital engine control (FADEC) configured to control components of the gas turbine engine 100. The computing system 700 includes a processor 702, a memory 704 including control logic 706, and a communications module 708.

The computing system 700 is communicatively coupled a first power electronics device 712. The first power electronics device 712 is any appropriate power conditioning device for converting a current to or from DC to AC, or DC to DC, in accordance with aspects of this disclosure. In a particular embodiment, the first power electronics device 712 is a first inverter. The first power electronics device 712 is configured in a power or torque control mode. As such, the first power electronics device 712 regulates or otherwise controls an amount of power extracted by the electric machine 634 from the gas turbine engine 100 within a torque limit associated with the gas turbine engine 100. In particular embodiments, the first power electronics device 712 commands the electric machine 634 to extract power from the gas turbine engine 100. Power extraction by the electric machine 634 from the engine 100 is correspondingly within a voltage limit at an electric bus 714.

The computing system 700 is in operable communication with the first power electronics device 712 and the gas turbine engine 100 via the communications module 708. As such, the computing system 700 provides and outputs control commands to the gas turbine engine 100 to generate power or torque in accordance with one or more engine operating limits. The engine operating limits include, but are not limited to, surge margin or stall margin at one or more compressors (e.g., LP compressor 126, HP compressor 128), an exhaust gas temperature (e.g., combustion gases generated by the combustion section and expanded through the turbines 132, 134), one or more pressure ratios (e.g., compressor pressure ratio at one or both compressors 126, 128, fan pressure ratio), rotational speed (e.g., at one or more spools), or combinations thereof, or minimum and/or maximum limits associated therewith, or changes therein, or rates of change therein. The engine operating limits may generally include any appropriate limit, margin, range, or ratio associated with operability, performance, health, safety, or desired durability of a gas turbine engine. Furthermore, the computing system 700 provides and outputs control commands associate with desired power outputs from the electric machine 634 to the load device 710. The first power electronics device 712, in a power or torque control configuration, alters or modulates torque extracted by the electric machine 634 from the gas turbine engine 100. The amount of torque extracted accordingly controls or modulates an amount of power output through the electric bus 714 operably connecting the first power electronics device 712 to a second power electronics device 716 and load device 710.

The second power electronics device 716 is any appropriate power conditioning device for converting a current to or from DC to AC, or DC to DC, in accordance with aspects of this disclosure. In a particular embodiment, the second power electronics device 716 is a second inverter. The second power electronics device 716 is configured in a voltage control mode. As such, the second power electronics device 716 regulates or otherwise controls an amount of power, or current, provided from the first power electronics device 712 to the load device 710. In particular embodiments, the second power electronics device 716 regulates the amount of power provided to the load device 710 based on a voltage at the electric bus 714, such as a voltage limit.

Referring back to FIG. 17, the accessory systems of the gas turbine engine 500 can include a heat exchanger assembly in thermal communication with various other accessory systems for accepting heat from these other accessory systems. The heat exchanger assembly can be located in between the second accessory cavity 516B and the third accessory cavity 516C, within a fan duct 172 of the gas turbine engine 500. In such a manner, the heat exchanger assembly 800 can reject heat to an airflow through the fan duct 172. Moreover, the position of the heat exchanger assembly 800 can allow for the heat exchanger assembly 800 to receive heat from various accessory systems located, e.g., in the second accessory cavity 516B, the third accessory cavity 516C, the fourth accessory cavity 516D, or a combination thereof.

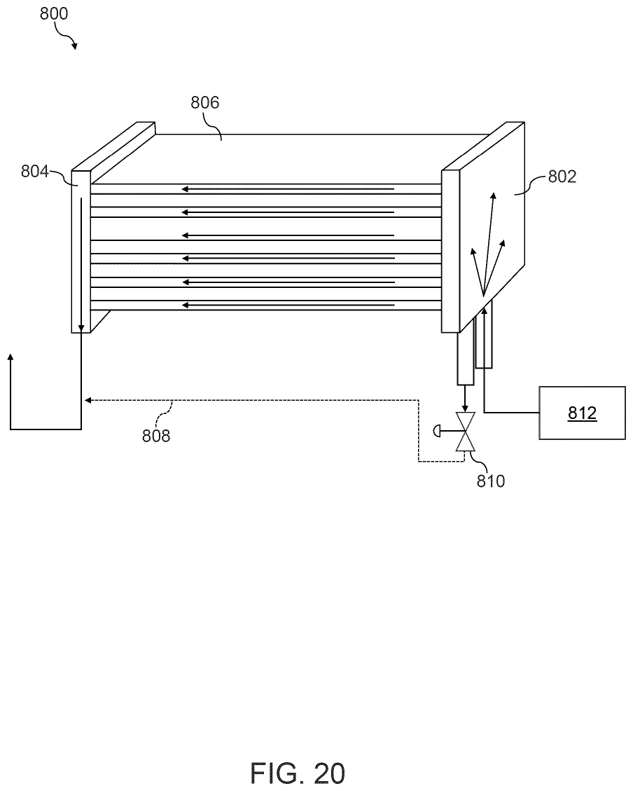

With reference now to FIG. 20, a heat exchanger assembly 800 for a gas turbine engine is provided, which can be located in between the second accessory cavity 516B and the third accessory cavity 516C, within a fan duct 172 of the gas turbine engine 500 of FIG. 17.

With reference to FIG. 20, a schematic view of the heat exchanger assembly 800 is provided. The heat exchanger assembly 800 includes an inlet manifold 802, an outlet manifold 804, a plurality of plates 806 extending from the inlet manifold 802 to the outlet manifold 804, a bypass channel 808, a flow controller 810 in fluid communication with the bypass channel 808, and a heated fluid supply 812. The heat exchanger assembly 800 described herein may be substantially hollow, such that a plurality of individualized fluid circuits are defined within the heat exchanger assembly 800. The plurality of individualized fluid circuits allow for multiple different motive fluids (e.g. from various systems of an aircraft engine) to pass through the heat exchanger assembly 800 simultaneously and thermally communicate with one another and with the air passing through the engine 100. For example, both the inlet and outlet manifolds 802, 804 and the plates 806 may include various fluid passages and channels defined therein to permit a working fluid (such as a coolant or other motive fluid) to travel therethrough during operation.

The inlet and outlet manifolds 802, 804 act as fluid routing manifolds, which route the fluid to and from the various passages defined in the plates 806. The inlet manifold 802 may be shaped generally as a rectangular prism having a singular curved surface, such as a radially outward surface. Likewise, the outlet manifold 804 may be shaped generally as a rectangular prism having a singular curved surface, such as a radially outward surface. The curved surfaces may conform to the shape of the fan duct 172, the core cowl 122, the fan cowl 170, or any other curved structure to which the heat exchanger assembly 800 is attached.

The plurality of plates 806 are supported by the inlet manifold 802 and the outlet manifold 804. As described above, the plates 806 allow the fluid to move from the inlet manifold 802 to the outlet manifold 804, transferring heat to and from air passing across exterior surfaces of the plates 806. When the fluid is congealed, the fluid may be too viscous to flow through the plates 806, and the fluid may accumulate in the inlet manifold 802. As will be described in further detail below, when the plates 806 are heated, the fluid therein loosens, decreasing its viscosity and resuming flow to the outlet manifold 804.

The bypass channel 808 extends from the inlet manifold 802 to the outlet manifold 804 to allow the fluid to move from the inlet manifold 802 to the outlet manifold 804 without flowing through the plurality of plates 806, i.e., “bypassing” the plates 806. By bypassing the plates 806, the bypass channel 808 allows the fluid to heat the inlet manifold 802 and the outlet manifold 804, decongealing the fluid disposed in the plurality of plates 806.

To provide the heat source to decongeal the fluid in the plates 806, the flow controller 810 fluidly connects the inlet manifold 802 to the outlet manifold 804. In this context, a “flow controller” is a structure or device that controls the flow of the fluid from the heated fluid supply to the bypass channel 808. The flow controller 810 may be a one-way valve, such as a pressure-relief valve, that allows the heated fluid to flow through the bypass channel 808, heating the inlet manifold 802 and the outlet manifold. The flow controller 810 may be actuated in any suitable way, such as a thermal actuation, a servo, a pressure actuation, or combinations thereof.

The heated fluid supply 812 provides a heated fluid, such as oil or another coolant, to the inlet manifold 802. The inlet manifold 802 is connected to the bypass channel 808, which transmits the heated fluid to the outlet manifold 804. Flowing the heated fluid from the inlet manifold 802 through the bypass channel 808 to the outlet manifold 804 heats the plates 806, decongealing oil therein.

Referring back to FIG. 17, the accessory systems of the gas turbine engine 500 can include a fan pitch actuation system (FPAS) that controls a pitch angle of fan blades 154 of a primary fan 152. Components of the FPAS are located in the position of the second accessory cavity 516B, proximate to the fan blades 154 while contained in the fan cowl 504. Moving the components away from the primary fan 152 and into the fan cowl 504 reduces the amount of space used in the core cowl 506.

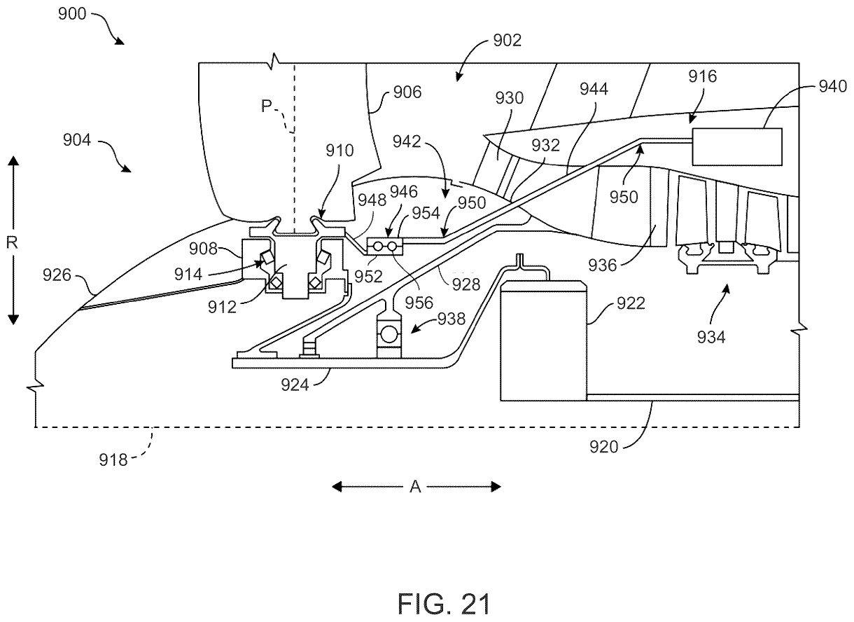

Referring now to FIG. 21, a schematic, cross-sectional view of a forward end of a gas turbine engine 900 in accordance with an exemplary embodiment of the present disclosure is provided. As depicted in FIG. 21, the gas turbine engine 900 generally defines an axial direction A and a radial direction R. Moreover, the gas turbine engine 900 defines a circumferential direction C (see FIG. 3) extending about the axial direction A.

A fan section 902 generally includes a variable pitch fan 904 having a plurality of fan blades 906 coupled to a disk 908. M ore specifically, each fan blade 906 defines a base 910 at an inner end along the radial direction R. Each fan blade 906 is coupled at the base 910 to the disk 908 via a respective trunnion mechanism 912. The disk 908 includes a plurality of bearings 914 such that the trunnion mechanism 912 is rotatably mounted within the disk 908 the trunnion mechanism 912 thus facilitating rotation of a respective fan blade 906 about a pitch axis P of the respective fan blades 906. Furthermore, as will be discussed in greater detail below, the exemplary gas turbine engine 900 depicted includes an actuation device 916 operable with the plurality of fan blades 906 for rotating the plurality of fan blades 906 about their respective pitch axes P.

For the embodiment depicted, the base 910 is configured as a dovetail received within a correspondingly shaped dovetail slot of the trunnion mechanism 912. However, in other exemplary embodiments, the base 910 may be any suitable fan blade attachment feature for attaching the blade 906 to the trunnion mechanism 912. For example, the base 910 may be attached to the trunnion mechanism 912 using a pinned connection, or any other suitable connection. In still other exemplary embodiments, the base 910 may be formed integrally with the trunnion mechanism 912.

The fan 904 of the exemplary gas turbine engine 900 depicted in FIG. 21 is mechanically coupled to a core. M ore particularly, the exemplary variable pitch fan 904 of the gas turbine engine 900 of FIG. 21 is rotatable about a longitudinal axis 918 by an LP shaft 920 across a power gearbox 922. For the embodiment depicted, the disk 908 is attached to the power gearbox 922 through a fan rotor 924. The power gearbox 922 is, in turn, attached to the LP shaft 920, such that rotation of the LP shaft 920 correspondingly rotates the fan rotor 924, disk 908, and the plurality of fan blades 906. Notably, as is also depicted, the fan section 902 additionally includes a front hub 926 (which is rotatable with, e.g., the disk 908 and plurality of fan blades 906).

Moreover, the fan 904 includes a static or stationary fan frame 928. The fan frame 928 is connected through a core air flowpath to the core, or more particularly to an outer casing of the core. For the embodiment depicted, the core includes a forward strut, or vane, 930 and a main strut 932, each providing structural support between the outer casing of the core and the fan frame 928. Additionally, an LP compressor 934 includes an inlet guide vane 936. The forward vane 930, main strut 932, and inlet guide vane 936 may additionally be configured to condition and direct the portion of the flow of air over the fan 904 provided to the core air flowpath to, e.g., increase an efficiency of the compressor section.

Furthermore, the fan 904 includes one or more fan bearings 938 for supporting rotation of the various rotating components of the fan 904, such as the plurality of fan blades 906. M ore particularly, the fan frame 928 supports the various rotating components of the fan 904 through the one or more fan bearings 938. For the embodiment depicted, the one or more fan bearings 938 include a ball bearing and a roller bearing. However, in other exemplary embodiments, any other suitable number and/or type of bearings may be provided for supporting rotation of the plurality of fan blades 906. For example, in other exemplary embodiments, the one or more fan bearings 938 may include a pair (two) tapered roller bearings, or any other suitable bearings. Additionally, in certain exemplary embodiments, the one or more fan bearings 938 may be formed of any suitable material. For example, in at least certain exemplary embodiments, the one or more fan bearings 938 may be formed of a suitable metal material, such as a stainless steel. Alternatively, however, in other exemplary embodiments the one or more fan bearings 938 may include one or more components formed of a suitable ceramic material.

Referring still to FIG. 21, as briefly discussed above, the gas turbine engine 900 includes the actuation device 916 operable with the plurality of fan blades 906 for rotating the plurality of fan blades 906 about their respective pitch axes P. As is depicted, the actuation device 916 includes an actuator 940 located outward of the core air flowpath of the gas turbine engine 900. M ore specifically, for the embodiment depicted, the actuator 940 is positioned outward of the core air flowpath along the radial direction R, and further is positioned outward of the LP compressor 934 of the compressor section of the core along the radial direction R.

Moreover, the exemplary actuation device 916 depicted further includes a connection assembly 942 extending from the actuator 940 for operably connecting the actuator 940 to the plurality fan blades 906 through the core air flowpath. The exemplary connection assembly 942 generally includes a non-rotating mechanical coupling 944, a rotating to static transfer device 946, and a rotating mechanical coupling 948. The exemplary non-rotating mechanical coupling 944 extends between the rotating to static transfer device 946 and the actuator 940, through the core air flowpath, or more particularly, through the main strut 932 of the core. Further, for the embodiment depicted, the non-rotating mechanical coupling 944 is formed of one or more connection rods. As used herein, the term “rods” refers to any substantially inflexible mechanical component. Accordingly, the connection rods may be any suitable rod, shaft, beam, etc. Further, the one or more connection rods may be formed of any suitable material, such as a suitable metal material capable of withstanding an anticipated load thereon.

Moreover, for the embodiment depicted, the one or more connection rods include a plurality of connection rods. The plurality of connection rods depicted are formed integrally at various joints 950, e.g., by welding. However, in other exemplary embodiments, the plurality of connection rods may be rotatably or pivotably joined at the joints 950 to allow for some angular movement between the attached connection rods during operation of the actuator 940. Additionally, in still other exemplary embodiments, the one or more connection rods may be a single connection rod bent or otherwise machined to the desired shape.

Furthermore, for the embodiment depicted, the rotating to static transfer device 946 is positioned in the fan section 902 of the gas turbine engine 900, inward of the core air flowpath. The rotating to static transfer device 946 is formed generally of an inner race 952, an outer race 954, and a plurality of bearings 956 located between the inner race 952 and the outer race 954. The plurality of bearings 956 facilitate a relative movement between the inner race 952 and the outer race 954. Specifically, for the embodiment depicted, inner race 952 is a rotatable inner race configured to rotate with, e.g., the disk 908 and plurality of fan blades 906, and the outer race 954 is a static outer race configured to remain stationary relative to, e.g., the disk 908 and plurality of fan blades 906. Accordingly, for the embodiment depicted, the non-rotating mechanical coupling 944 is attached to the static outer race 954, and the rotating mechanical coupling 948 is attached to the rotating inner race 952. However, in other exemplary embodiments, the outer race 954 may instead be a rotatable outer race and the inner race 952 may be a static inner race. In such an exemplary embodiment, the non-rotating mechanical coupling 944 may be attached to the static inner race and the rotatable mechanical couplings may be attached to the rotatable outer race.

Referring back to FIG. 17, the accessory systems of the gas turbine engine 500 can include electronic components of a hybrid-electric engine. The electronic components, such as electric machines, electric busses, electric control devices, electric power sources, and the like, benefit from cooler environments, such as the pylon 510 or the fan cowl 504. Accordingly, the electric components may be located in the first accessory cavity 516A and/or the second accessory cavity 516B.

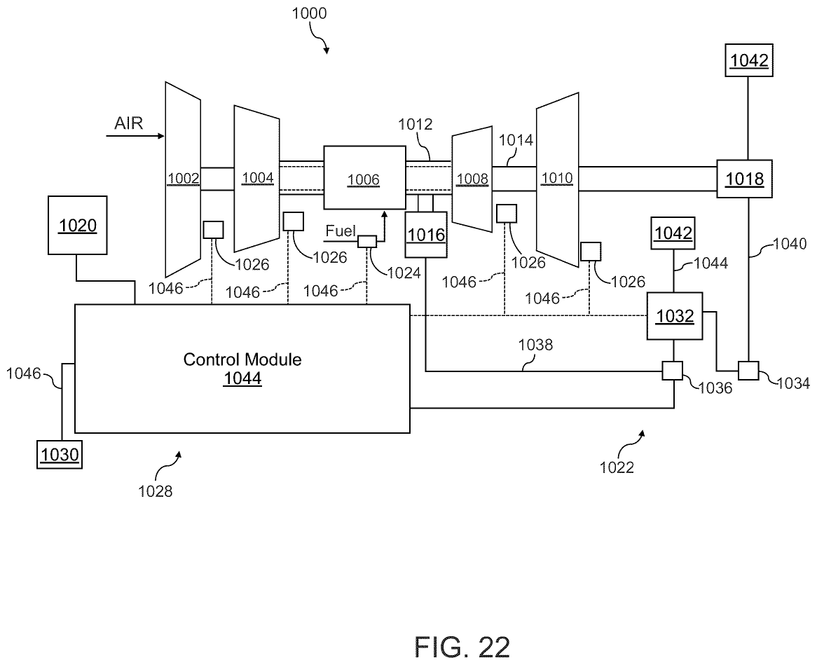

With reference to FIG. 22, a schematic diagram of an exemplary gas turbine engine 1000 is provided. The gas turbine engine 1000 is a hybrid-electric engine that includes a plurality of components, including an LP compressor 1002, an HP compressor 1004, a combustor 1006, an LP turbine 1008, and an HP turbine 1010. A n HP shaft 1012 connects the HP compressor 1004 and the HP turbine 1010, and an LP shaft 1014 connects the LP compressor 1002 and the LP turbine 1008. A first electric machine 1016 is operably connected to the HP shaft 1012, and a second electric machine 1018 is operably connected to the LP shaft 1014. The gas turbine engine 1000 further includes a thrust input device 1020, an electrical power system 1022, one or more fuel control devices 1024, one or more sensors 1026, and a control system 1028.

The thrust input device 1020 adjusts thrust output of the gas turbine engine 1000 based on changes to thrust demand. The thrust input device 1020 may include manual devices (such as power or thrust levels movable by a user in a cockpit) and a flight control system 1030 (such as an autopilot system). The thrust input device 1020 is operable to change thrust output based on changes in thrust demand and to provide data indicating the change in thrust demand and output.

The electrical power system 1022 provides electricity to components of the gas turbine engine 1000. Specifically, the electrical power system 1022 includes one or more electrical power sources 1032, a first electrical control device 1034, and a second electrical control device 1036. For instance, the first and second electrical control devices 1034, 1036 may include a set of inverters, converters, variable frequency drives (VFD), rectifiers, devices operable to control the flow of electrical current, etc., and combinations thereof. Although the first and second electrical control devices 1034, 1036 are shown schematically in FIG. 22 as separate from the electrical power source 1032, and separate from the first and second electric machines 1016, 1018, it will be appreciated that one or both of first and second electrical control devices 1034, 1036 can be located onboard the electrical power source 1032, the first electric machine 1016, the second electric machine 1018, or combinations thereof.

The first and second electric machines 1016, 1018 can be selectively electrically coupled with the one or more electrical power sources 1032, e.g., via a first power bus 1038, and a second power bus 1040. The first and second electric machines 1016, 1018 can be further selectively electrically coupled with the set of electrical loads 1042, e.g., via a third power bus 1044. The first and second electric machines 1016, 1018 can be configured to receive electrical power from the one or more electrical power sources 1032. The one or more electrical power sources 1032 can be any suitable power source. For example, the one or more electrical power source 1032 can be, without limitation, one or more energy storage device (e.g., one or more batteries), electric generator, auxiliary power unit W U), photovoltaic panel, DC power supply, AC power supply, or any other known source of electrical power, or a combination thereof. The one or more electrical power source 1032 can be located onboard the gas turbine engine 1000, or mounted or positioned offboard of the gas turbine engine 1000.

The set of electrical loads 1042 can include for example, without limitation, a battery bank, lighting, pump, heater, instrument, radio, flap, landing gear, or other systems or operative structures.

The fuel control devices 1024 control fuel flow to the gas turbine engine 1000. Specifically, the fuel control devices 1024 control fuel provided to the combustion chamber of the combustor 1006, such as an amount of fuel, a timing of fuel injection into the combustion chamber, an air/fuel ratio, or combinations thereof.

The one or more sensors 1026 collect data about components of the gas turbine engine 1000. For instance, one or more sensors 1026 can be positioned at the LP compressor 1002, one or more sensors 1026 can be positioned at the HP compressor 1004, one or more sensors 1026 can be positioned at the HP turbine 1010, and one or more sensors 1026 can be positioned at the LP turbine 1008, among other possible locations. The sensors 1026 can sense or measure various engine conditions, e.g., pressures and temperatures, and one or more signals may be provided from the set of sensors 1026 to the control system 1028 for processing. It will be appreciated that the gas turbine engine 1000 can include any number of sensors 1026 at other suitable stations along the core air flow path.

The gas turbine engine 1000 includes the control system 1028. The control system 1028 is operable to control an operation of the gas turbine engine 1000. M ore specifically, the control system 1028 includes a control module 1044 that is communicatively coupled to the thrust input device 1020, the electrical power system 1022, the fuel control devices 1024, and the sensors 1026 for receiving and sending data and instructions.

The control module 1044 can be a system of controllers or a single controller. M ore specifically, the control module 1044 can be a controller dedicated to control of an operation of the gas turbine engine 1000 and associated electrical components, or can be an engine controller configured to control the gas turbine engine 1000 and its associated electrical components. The control module 1044 can be, for example, an Electronic Engine Controller (EEC) or an Electronic Control Unit (ECU) of a Full Authority Digital Engine Control (FADEC) system.

The control module 1044 can receive one or more inputs 1046. The inputs 1046 can be in the form of analog or digital electrical signals. For example, the control module 1044 can receive an input 144 from the thrust input device 1020, or the flight control system 102, indicative of the change in thrust demand. Additionally, the control module 1044 can receive one or more inputs 1046 indicative of one or more parameters of the gas turbine engine 1000. The control module 1044 can receive the one or more inputs 1046 from one or more sensors 1026, via a user input, from control logic operable to calculate the value of the parameters or conditions based at least in part on the received sensor outputs, from one or more models, or automatically based on commands from a flight control system 102, and various combinations thereof.

The control module 1044 can further control the first and second electric machines 1016, 1018 to selectively operate in one of the motor mode and the generator mode. The first and second electric machines 1016, 1018 can be selectively operated in the motor mode in response to the electrical power received from the at least one electrical power source 1032. Alternatively, the first and second electric machines 1016, 1018 can be selectively operated in the generating mode in response to a rotation of the HP and LP shafts 1012, 1014 coupled to the first and second electric machines 1016, 1018.

For example, to selectively operate the first and second electric machines 1016, 1018 in the motor mode, the control module 1044 can be configured to control the first electrical control device 1034 and the second electrical control device 1036 to selectively provide electrical power to the first or second electric machines 1016, 1018 via the first and second power buses 1038, 1040, or both. Conversely, to selectively operate the first and second electric machines 1016, 1018 in the generator mode, the control module 1044 can be configured to control the first electrical control device 1034 and the second electrical control device 1036 to selectively cease providing electrical power to the first and or second electric machines 1016, 1018 during a rotation of the HP shaft 1012 or LP shaft 1014.

Referring back to FIG. 17, and from the discussion above with reference to FIGS. 18-22, it will be appreciated that each of the accessory cavities 516A-E can be used to house a variety of accessory systems 518A-E.

For example, the first accessory cavity 516A in the pylon 510 may house components that benefit from colder environments and are small enough to fit within the pylon 510. Such components of the accessory system 518A that may be housed in the first accessory cavity 516A include, but are not limited to, a portion of an accessory gearbox 600 (FIG. 18), one or more accessories coupled to the accessory gearbox 600, a FADEC or other engine control system/a computing system 700 (FIG. 19), power electronics 712, 716 (FIG. 19), a load device 710 (FIG. 19), an electrical power source 1032 (FIG. 22), electrical control devices 1034, 1036 (FIG. 22), or a control module 1044 (FIG. 22).

A s another example, the second accessory cavity 516B in the fan cowl 504 may house components that benefit from colder environments but are too large to fit within the pylon 510. Such components of the accessory system 518B that may be housed in the second accessory cavity 516B include, but are not limited to, a heat exchanger assembly 800 (FIG. 20), a trunnion mechanism 912 (FIG. 21), an actuator 940 (FIG. 21), as well as the components that can also be housed in the first accessory cavity 516A but may preferentially be housed in the second accessory cavity 516B, such as the FADEC or other engine control system/a computing system (FIG. 19), the electric machine 634 (FIGS. 18-19), or the control module 1044 (FIG. 22).

As another example, the third accessory cavity 516C in the forward portion 512 of the core cowl 506 may house components that are heat resistant and benefit from proximity to forward-located components of the turbomachine 502, such as compressors. Such components of the accessory system 518C that may be housed in the third accessory cavity 516C include, but are not limited to, the accessory gearbox 600 and one or more accessories coupled to the accessory gearbox (FIG. 18), the heat exchanger assembly 800 (FIG. 20), the trunnion mechanism 912 (FIG. 21), the actuator 940 (FIG. 21), or the control module 1044 (FIG. 22).

A s another example, the fourth accessory cavity 516D in the aft portion 514 of the core cowl 506 may house components that are heat resistant and benefit from proximity to aft-located components of the turbomachine 502, such as turbines. Such components of the accessory system 518D that may be housed in the fourth accessory cavity 516D include, but are not limited to, the accessory gearbox 600 (FIG. 18), the heat exchanger assembly 800 (FIG. 20), the trunnion mechanism 912 (FIG. 21), the actuator 940 (FIG. 21), or the control module 1044 (FIG. 22).

As another example, the fifth accessory cavity 516E in the tail cone 508 may house components that are heat resistant and benefit from proximity to an exhaust of the gas turbine engine 500, the LP shaft or LP compressor of the gas turbine engine 500, or both. Such components of the accessory system 518E that may be housed in the fifth accessory cavity 516E include, but are not limited to, an electric machine, the heat exchanger assembly 800 (FIG. 20; e.g., as a waste heat recovery heat exchanger), or a heated fluid supply 812 (FIG. 20).

In various embodiments, referring back to FIG. 17, a core of the gas turbine engine 500 and an LP turbine may be cantilever mounted at a forward end. A conventional approach to accessory placement can cause droop or deflection issues for the core, as large hardware mounted near the aft portion 514 can create torque imbalances. To address this concern, certain accessory systems 518 positioned in the accessory cavities 516 may be selectively located and oriented to offset vibrations, counterbalance mass distribution, and reduce bending moments on the core and LP turbine. For instance, selecting the accessory cavity 516B in the fan cowl 504 for a heavier accessory (e.g., an electric machine or generator) can reduce vibrations originating in other sections of the core, thus reducing the mechanical load on the core mounts.

Furthermore, the inventors found that it may be desirable to evaluate a mass and vibratory characteristic of each accessory system prior to installation in any of the accessory cavities 516A-E. The accessory cavities 516 closer to the rotating components (e.g., the third cavity 516C or the fourth cavity 516D) may be better suited for accessories 518 that generate rotating inertial loads, as these accessories can be positioned to offset vibration harmonics. Conversely, accessories having relatively sensitive electronic components, such as a computing system 700 or a FADEC, may be placed in either the first accessory cavity 516A or the second accessory cavity 516B to ensure a cooler and more stable environment while simultaneously leveraging the mass of these components for dynamic balancing. In this manner, introducing heavier accessory systems into a particular cavity may be beneficial in balancing vibratory modes produced by the core and/or LP turbine during operation.

In addition, other dynamically sensitive or vibration-susceptible systems within the engine 500 can be mounted with similar considerations. By spacing and orienting these systems within different cavities 516, the overall vibrational profile of the engine 500 can be altered to minimize stress concentrations in the cantilevered core or LP turbine mounts. For instance, an actuation system such as the fan pitch actuation system (FPAS) or a heat exchanger assembly 800 can be mounted in a manner that not only satisfies thermal and packaging requirements but also takes into account potential dynamic loads arising from the rotation of the fan 904 or engine shafts 136, 138.

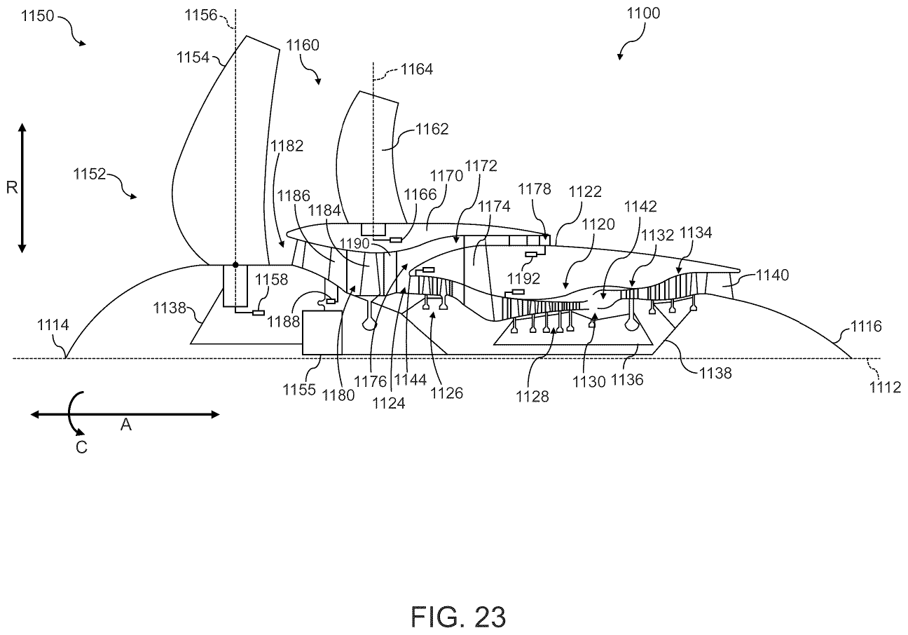

Referring now to FIG. 23, a schematic cross-sectional view of a gas turbine engine 1100 is provided according to an example embodiment of the present disclosure. Particularly, FIG. 23 provides an open rotor gas turbine engine having a rotor assembly with a single stage of unducted rotor blades. In such a manner, the rotor assembly may be referred to herein as an “unducted fan,” or the entire engine 1100 may be referred to as an “unducted gas turbine engine.” In addition, the engine 1100 of FIG. 23 includes a third stream extending from the compressor section to a rotor assembly flowpath over the turbomachine, as will be explained in more detail below.

For reference, the engine 1100 defines an axial direction A, a radial direction R, and a circumferential direction C. Moreover, the engine 1100 defines an axial centerline or longitudinal axis 1112 that extends along the axial direction A. In general, the axial direction A extends parallel to the longitudinal axis 1112, the radial direction R extends outward from and inward to the longitudinal axis 1112 in a direction orthogonal to the axial direction A, and the circumferential direction extends three hundred sixty degrees (360°) around the longitudinal axis 1112. The engine 1100 extends between a forward end 1114 and an aft end 1116, e.g., along the axial direction A.

The engine 1100 includes a turbomachine 1120 and a rotor assembly, also referred to as a fan section 1150, positioned upstream thereof. Generally, the turbomachine 1120 includes, in serial flow order, a compressor section, a combustion section, a turbine section, and an exhaust section. Particularly, as shown in FIG. 23, the turbomachine 1120 includes a core cowl 1122 that defines an annular core inlet 1124. The core cowl 1122 further encloses at least in part a low pressure system and a high pressure system. For example, the core cowl 1122 depicted encloses and supports at least in part a booster or low pressure (“LP”) compressor 1126 for pressurizing the air that enters the turbomachine 1120 through core inlet 1124. A high pressure (“HP”), multi-stage, axial-flow compressor 1128 receives pressurized air from the LP compressor 1126 and further increases the pressure of the air. The pressurized air stream flows downstream to a combustor 1130 of the combustion section where fuel is injected into the pressurized air stream and ignited to raise the temperature and energy level of the pressurized air.

The high energy combustion products flow from the combustor 1130 downstream to a high pressure turbine 1132. The high pressure turbine 1132 drives the high pressure compressor 1128 through a high pressure shaft 1136. In this regard, the high pressure turbine 1132 is drivingly coupled with the high pressure compressor 1128. As will be appreciated, the high pressure compressor 1128, the combustor 1130, and the high pressure turbine 1132 may collectively be referred to as the “core” of the engine 1100. The high energy combustion products then flow to a low pressure turbine 1134. The low pressure turbine 1134 drives the low pressure compressor 1126 and components of the fan section 1150 through a low pressure shaft 1138. In this regard, the low pressure turbine 1134 is drivingly coupled with the low pressure compressor 1126 and components of the fan section 1150. The LP shaft 1138 is coaxial with the HP shaft 1136 in this example embodiment. After driving each of the turbines 1132, 1134, the combustion products exit the turbomachine 1120 through a turbomachine exhaust nozzle 1140.

Accordingly, the turbomachine 1120 defines a working gas flowpath or core duct 1142 that extends between the core inlet 1124 and the turbomachine exhaust nozzle 1140. The core duct 1142 is an annular duct positioned generally inward of the core cowl 1122 along the radial direction R. The core duct 1142 (e.g., the working gas flowpath through the turbomachine 1120) may be referred to as a second stream.

The fan section 1150 includes a fan 1152, which is the primary fan in this example embodiment. For the depicted embodiment of FIG. 23, the fan 1152 is an open rotor or unducted fan 1152. In such a manner, the engine 1100 may be referred to as an open rotor engine.

As depicted, the fan 1152 includes an array of fan blades 1154 (only one shown in FIG. 23). The fan blades 1154 are rotatable, e.g., about the longitudinal axis 1112. As noted above, the fan 1152 is drivingly coupled with the low pressure turbine 1134 via the LP shaft 1138. For the embodiments shown in FIG. 23, the fan 1152 is coupled with the LP shaft 1138 via a speed reduction gearbox 1155, e.g., in an indirect-drive or geared-drive configuration.

Moreover, the array of fan blades 1154 can be arranged in equal spacing around the longitudinal axis 1112. Each fan blade 1154 has a root and a tip and a span defined therebetween. As will be appreciated, a distance from the base of each fan blade 1154 to a tip of the respective fan blade 1154 is referred to as a span of the respective fan blade 1154. Each fan blade 1154 defines a central blade axis 1156. For this embodiment, each fan blade 1154 of the fan 1152 is rotatable about its respective central blade axis 1156, e.g., in unison with one another. One or more actuators 1158 are provided to facilitate such rotation and therefore may be used to change a pitch of the fan blades 1154 about their respective central blades' axes 1156.

The fan section 1150 further includes a fan guide vane array 1160 that includes fan guide vanes 1162 (only one shown in FIG. 23) disposed around the longitudinal axis 1112. For this embodiment, the fan guide vanes 1162 are not rotatable about the longitudinal axis 1112. Each fan guide vane 1162 has a root and a tip and a span defined therebetween. The fan guide vanes 1162 may be unshrouded as shown in FIG. 23 or, alternatively, may be shrouded, e.g., by an annular shroud spaced outward from the tips of the fan guide vanes 1162 along the radial direction R or attached to the fan guide vanes 1162.

Each fan guide vane 1162 defines a central blade axis 1164. For this embodiment, each fan guide vane 1162 of the fan guide vane array 1160 is rotatable about its respective central blade axis 1164, e.g., in unison with one another. One or more actuators 1166 are provided to facilitate such rotation and therefore may be used to change a pitch of the fan guide vane 1162 about its respective central blade axis 1164. However, in other embodiments, each fan guide vane 1162 may be fixed or unable to be pitched about its central blade axis 1164. The fan guide vanes 1162 are mounted to a fan cowl 1170.

As shown in FIG. 23, in addition to the fan 1152, which is unducted, a ducted fan 1184 is included aft of the fan 1152, such that the engine 1100 includes both a ducted and an unducted fan which both serve to generate thrust through the movement of air without passage through at least a portion of the turbomachine 1120 (e.g., without passage through the HP compressor 1128 and combustion section for the embodiment depicted). The ducted fan 1184 is rotatable about the same axis (e.g., the longitudinal axis 1112) as the fan blade 1154. The ducted fan 1184 is, for the embodiment depicted, driven by the low pressure turbine 1134 (e.g., coupled to the LP shaft 1138). In the embodiment depicted, as noted above, the fan 1152 may be referred to as the primary fan, and the ducted fan 1184 may be referred to as a secondary fan. It will be appreciated that these terms “primary” and “secondary” are terms of convenience, and do not imply any particular importance, power, or the like.

The ducted fan 1184 includes a plurality of fan blades 1185 arranged in a single stage, such that the ducted fan 1184 may be referred to as a single stage fan. The fan blades of the ducted fan 1184 can be arranged in equal spacing around the longitudinal axis 1112. Each blade of the ducted fan 1184 has a root and a tip and a span defined therebetween. As will be appreciated, a distance from the base of each fan blade of the ducted fan 1184 to a tip of the respective fan blade is referred to as a span of the respective fan blade.

The fan cowl 1170 annularly encases at least a portion of the core cowl 1122 and is generally positioned outward of at least a portion of the core cowl 1122 along the radial direction R. Particularly, a downstream section of the fan cowl 1170 extends over a forward portion of the core cowl 1122 to define a fan duct flowpath, or simply a fan duct 1172. According to this embodiment, the fan flowpath or fan duct 1172 may be understood as forming at least a portion of the third stream of the engine 1100.

Incoming air may enter through the fan duct 1172 through a fan duct inlet 1176 and may exit through a fan exhaust nozzle 1178 to produce propulsive thrust. The fan duct 1172 is an annular duct positioned generally outward of the core duct 1142 along the radial direction R. The fan cowl 1170 and the core cowl 1122 are connected together and supported by a plurality of substantially radially-extending, circumferentially-spaced stationary struts 1174 (only one shown in FIG. 23). The stationary struts 1174 may each be aerodynamically contoured to direct air flowing thereby. Other struts in addition to the stationary struts 1174 may be used to connect and support the fan cowl 1170 and/or core cowl 1122. In many embodiments, the fan duct 1172 and the core duct 1142 may at least partially co-extend (generally axially) on opposite sides (e.g., opposite radial sides) of the core cowl 1122. For example, the fan duct 1172 and the core duct 1142 may each extend directly from a leading edge 1144 of the core cowl 1122 and may partially co-extend generally axially on opposite radial sides of the core cowl 1122.

The engine 1100 also defines or includes an inlet duct 1180. The inlet duct 1180 extends between an engine inlet 1182 and the core inlet 1124/fan duct inlet 1176. The engine inlet 1182 is defined generally at the forward end of the fan cowl 1170 and is positioned between the fan 1152 and the fan guide vane array 1160 along the axial direction A. The inlet duct 1180 is an annular duct that is positioned inward of the fan cowl 1170 along the radial direction R. Air flowing downstream along the inlet duct 1180 is split, not necessarily evenly, into the core duct 1142 and the fan duct 1172 by a fan duct splitter or leading edge 1144 of the core cowl 1122. The inlet duct 1180 is wider than the core duct 1142 along the radial direction R. The inlet duct 1180 is also wider than the fan duct 1172 along the radial direction R. The ducted fan 1184 is positioned at least partially in the inlet duct 1180.

Notably, for the embodiment depicted, the engine 1100 includes one or more features to increase an efficiency of a third stream thrust (e.g., a thrust generated by an airflow through the fan duct 1172 exiting through the fan exhaust nozzle 1178, generated at least in part by the ducted fan 1184). In particular, the engine 1100 further includes an array of inlet guide vanes 1186 positioned in the inlet duct 1180 upstream of the ducted fan 1184 and downstream of the engine inlet 1182. The array of inlet guide vanes 1186 are arranged around the longitudinal axis 1112. For this embodiment, the inlet guide vanes 1186 are not rotatable about the longitudinal axis 1112. Each inlet guide vane 1186 defines a central blade axis (not labeled for clarity), and is rotatable about its respective central blade axis, e.g., in unison with one another. In such a manner, the inlet guide vanes 1186 may be considered a variable geometry component. One or more actuators 1188 are provided to facilitate such rotation and therefore may be used to change a pitch of the inlet guide vanes 1186 about their respective central blade axes. However, in other embodiments, each inlet guide vanes 1186 may be fixed or unable to be pitched about its central blade axis.

Further, located downstream of the ducted fan 1184 and upstream of the fan duct inlet 1176, the engine 1100 includes an array of outlet guide vanes 1190. As with the array of inlet guide vanes 1186, the array of outlet guide vanes 1190 are not rotatable about the longitudinal axis 1112. However, for the embodiment depicted, unlike the array of inlet guide vanes 1186, the array of outlet guide vanes 1190 are configured as fixed-pitch outlet guide vanes.

Further, it will be appreciated that for the embodiment depicted, the fan exhaust nozzle 1178 of the fan duct 1172 is further configured as a variable geometry exhaust nozzle. In such a manner, the engine 1100 includes one or more actuators 1192 for modulating the variable geometry exhaust nozzle. For example, the variable geometry exhaust nozzle may be configured to vary a total cross-sectional area (e.g., an area of the nozzle in a plane perpendicular to the longitudinal axis 1112) to modulate an amount of thrust generated based on one or more engine operating conditions (e.g., temperature, pressure, mass flowrate, etc. of an airflow through the fan duct 1172). A fixed geometry exhaust nozzle may also be adopted.

The combination of the array of inlet guide vanes 1186 located upstream of the ducted fan 1184, the array of outlet guide vanes 1190 located downstream of the ducted fan 1184, and the fan exhaust nozzle 1178 may result in a more efficient generation of third stream thrust, during one or more engine operating conditions. Further, by introducing a variability in the geometry of the inlet guide vanes 1186 and the fan exhaust nozzle 1178, the engine 1100 may be capable of generating more efficient third stream thrust, across a relatively wide array of engine operating conditions, including takeoff and climb (where a maximum total engine thrust is generally needed) as well as cruise (where a lesser amount of total engine thrust is generally needed).

Moreover, referring still to FIG. 23, in exemplary embodiments, air passing through the fan duct 1172 may be relatively cooler (e.g., lower temperature) than one or more fluids utilized in the turbomachine 1120. In this way, one or more heat exchangers 1191 may be positioned in thermal communication with the fan duct 1172. For example, one or more heat exchangers 1191 may be disposed within the fan duct 1172 and utilized to cool one or more fluids from the core engine with the air passing through the fan duct 1172, as a resource for removing heat from a fluid, e.g., compressor bleed air, oil or fuel. As depicted in the exemplary embodiment, the one or more heat exchangers 1191 are positioned in an aft portion of the fan duct, and more specifically, the one or more heat exchangers is located in an aft 50% of the fan duct.

It should be appreciated that in alternative exemplary embodiments one or more heat exchangers 1191 may define at least a portion of the fan duct 1172. In such a manner the one or more heat exchangers 1191 may eliminate the need for additional structure that may define the fan duct 1172.

Although not depicted, the heat exchanger 1191 may be an annular heat exchanger extending substantially 360 degrees in the fan duct 1172 (e.g., at least 300 degrees, such as at least 330 degrees). In such a manner, the heat exchanger 1191 may effectively utilize the air passing through the fan duct 1172 to cool one or more systems of the engine 1100 (e.g., lubrication oil systems, compressor bleed air, electrical components, etc.). The heat exchanger 1191 uses the air passing through duct 1172 as a heat sink and correspondingly increases the temperature of the air downstream of the heat exchanger 1191 and exiting the fan exhaust nozzle 1178.

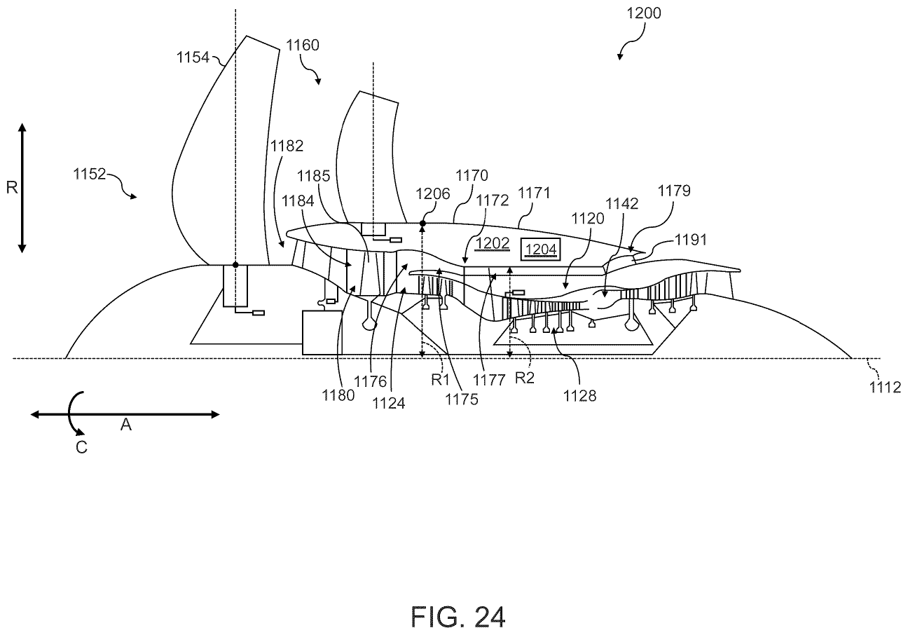

Referring now to FIG. 24, a schematic cross-sectional view of a gas turbine engine 1200 is provided according to another example embodiment of the present disclosure. The exemplary gas turbine engine 1200 of FIG. 24 may be configured in substantially the same manner as the exemplary gas turbine engine 1100 of FIG. 23, and accordingly, the same or similar numbers may refer to the same or similar parts.

For example, the exemplary gas turbine engine of FIG. 24 generally includes a turbomachine 1120 defining an engine inlet 1182 to an inlet duct 1180, a fan duct inlet 1176 to a fan duct 1172, and a core inlet 1124 to a core duct 1142. Additionally, the exemplary gas turbine engine 1200 generally includes a primary fan, or rather fan 1152 having fan blades 1154 and a secondary fan or rather ducted fan 1184 having fan blades 1185.

However, for the embodiment of FIG. 24, a fan cowl 1170 is now configured to define an auxiliary space 1202 that may have at least one engine accessory 1204 mounted within. M ore particularly, the fan cowl 1170 is positioned outward of the fan duct 1172 along a radial direction R of the gas turbine engine 1200, and the auxiliary space 1202 is within the fan cowl 1170. As will be appreciated, the auxiliary space 1202 is an annular auxiliary space 1202 extending substantially 360 degrees within the fan cowl 1170 (e.g., at least 300 degrees, such as at least 330 degrees). During an operation condition of the gas turbine engine 1200, the radially outward positioning of the auxiliary space 1202 may allow the fan duct 1172 to attenuate heat transfer from the core engine to the auxiliary space 1202. This may allow the auxiliary space 1202 to be relatively cooler (e.g., lower temperature) than the core engine. It should be appreciated that the relatively cooler auxiliary space 1202 may allow for an increased life expectancy of the at least one engine accessory 1204 mounted within the auxiliary space 1202.

It should be appreciated that the at least one engine accessory 1204 may include but is not limited to valves, electronic accessory systems including engine and system controllers, fire and overheat detection system components, fire extinguisher components, heat exchangers, pumps, generators, etc.

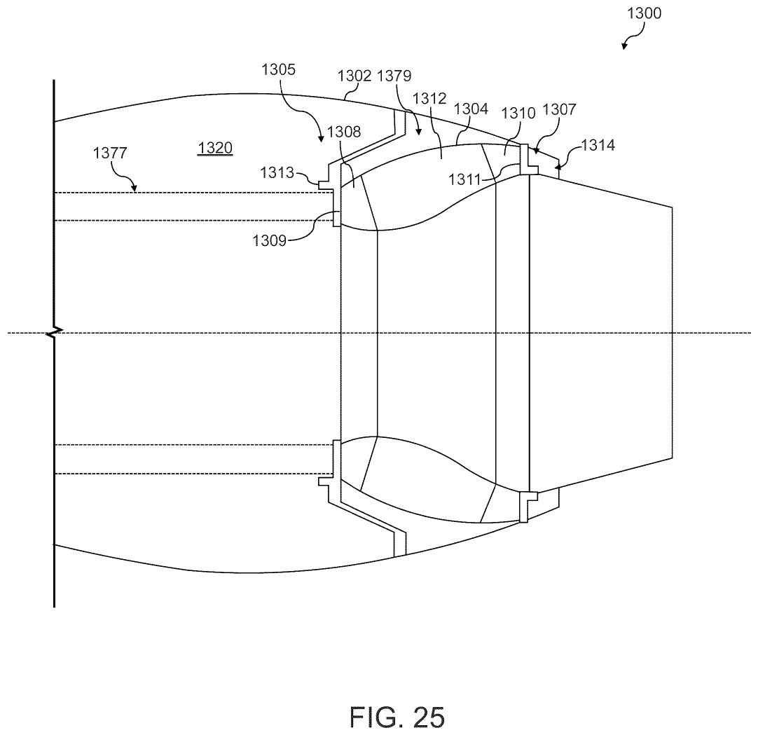

In addition, for the embodiment of FIG. 24, at least a portion of the one or more heat exchangers 1191 are now configured to be formed integrally with or coupled to the fan cowl 1170. Further, the one or more heat exchangers 1191 of the exemplary embodiment define at least a portion of the fan duct 1172. M ore particularly as depicted, the heat exchanger 1191 is coupled to an aft portion of the fan cowl 1170 such that the heat exchanger 1191 defines an aft portion of the fan duct 1172. In addition, the heat exchanger 1191 may generally include an inlet and an outlet (not depicted in FIG. 24 for clarity; see FIG. 25) that may be formed integrally with or coupled to the fan cowl 1170. It should be appreciated that the use of the heat exchanger 1191 to define a portion of the fan duct 1172 may eliminate the need for additional structure (e.g., a dedicated duct) to define the fan duct 1172 at this location.

Further, the fan cowl 1170 defines a maximum radius R1 of the fan cowl 1170 from a longitudinal axis 1112 to a radially outward most point 1206 of the fan cowl 1170. It should be appreciated that the radially outward most point 1206 of the fan cowl 1170 refers to a point on an outer surface of the fan cowl 1170 where the radius from the longitudinal axis 1112 to the outer surface is the greatest. A s depicted, the radially outward most point 1206 of the fan cowl 1170 is aft of a fan guide vane array 1160. In addition, at least a portion of the heat exchanger 1191 may be positioned aft of the maximum radius R1 of the fan cowl 1170 and radially inward of the maximum radius R1 of the fan cowl 1170.

It should be appreciated that in alternative exemplary embodiments the radially outward most point 1206 may be positioned at any suitable location along the outer surface of the fan cowl 1170.

In addition, it will be appreciated that the fan duct 1172 includes an inlet portion 1175, a forward portion 1177, and an aft portion 1179. The aft portion 1179 is positioned aft of the forward portion 1177, and the forward portion 1177 is positioned aft of the inlet portion 1175. In the embodiment depicted, the forward portion 1177 extends over the high pressure compressor 1128 of the compressor section of the turbomachine 1120. In particular, the forward portion 1177 extends along an axial direction A at a location outward of the high pressure compressor 1128 along the radial direction R. For the embodiment depicted, the forward portion 1177 extends over an entire length of the high pressure compressor 1128 and over a portion of the combustion section. Further, for the embodiment depicted, the forward portion 1177 of the fan duct is an annular portion of the fan duct 1172 that generally extends parallel to the longitudinal axis 1112.

In addition, it will be appreciated that the aft portion 1179 extends outward along the radial direction R from the forward portion 1177, and that the aft portion 1179 is formed at least in part by the heat exchanger 1191. Such a configuration may allow for an increased volume heat exchanger as compared to a location within the forward portion 1177 of the fan duct 1172.

Referring still to FIG. 24, the fan duct 1172 defines a maximum radius R2 from longitudinal axis 1112 to the forward portion 1177 of the fan duct 1172. Further it should be appreciated that the maximum radius R2 of the fan duct 1172 is at most 65% of the maximum radius R1 of the fan cowl 1170 (e.g., such as at most 40%, such as at most 55%).

Referring now to FIG. 25, a schematic cross-sectional view of a cowl assembly 1300 in accordance with an exemplary aspect of the present disclosure is provided. As is depicted, the cowl assembly 1300 generally includes an outer cowl 1302 and a heat exchanger 1304 coupled to the outer cowl 1302. The exemplary cowl assembly 1300 may be incorporated into a gas turbine engine such as the gas turbine engines 1100 and 1200 of FIGS. 23 and 24. M ore particularly, when incorporated into the gas turbine engine the outer cowl 1302 may be configured as a fan cowl (see e.g., fan cowl 1170).

The cowl assembly 1300 generally defines an annular auxiliary space 1320. When incorporated into a gas turbine engine, at least one engine accessory (see e.g., at least one engine accessory 1204 of FIG. 24) may be mounted within the auxiliary space 1320. It should be appreciated that at least a portion of the heat exchanger 1304 may be aft of the auxiliary space 1320.

As depicted, the heat exchanger 1304 is coupled to the outer cowl 1302 of the cowl assembly 1300. In addition, the exemplary heat exchanger 1304 is an annular heat exchanger that may extend substantially 360 degrees in the outer cowl 1302 (e.g., at least 300 degrees, such as at least 330 degrees). The heat exchanger 1304 may be a single heat exchanger extending annularly, or may be a plurality of heat exchangers extending annularly, the plurality of heat exchangers spaced along a circumferential direction. Further, the heat exchanger 1304 includes an inlet 1308, a main body 1312, and an outlet 1310 in serial flow order.

M ore specifically, for the embodiment depicted, the cowl assembly 1300 further includes a forward bracket 1305 and an aft bracket 1307. The forward bracket 1305 extends inwardly from the outer cowl 1302 along a radial direction R and includes a heat exchanger interface 1309 coupled to a forward end of the heat exchanger 1304, and more specifically coupled to the inlet 1308 of the heat exchanger 1304. The aft bracket 1307 similarly extends inwardly from the outer cowl 1302 along the radial direction R and includes a heat exchanger interface 1311 coupled to an aft end of the heat exchanger 1304, and more specifically coupled to the outlet 1310 of the heat exchanger 1304. In such a manner, the heat exchanger 1304 is coupled to the outer cowl 1302.

Notably, the forward bracket 1305 further includes a fan duct interface 1313 configured to couple with a forward portion 1377 of a fan duct (depicted in phantom in FIG. 25). In such a manner, the forward bracket 1305 may couple the heat exchanger 1304 to the forward portion 1377 of the fan duct when assembled.

Further, it will be appreciated that with the exemplary configuration depicted, the heat exchanger 1304 forms an aft portion 1379 of the fan duct, such that no additional or dedicated ducting structures are required to form the aft portion 1379 of the fan duct.

As noted above, during operation of a gas turbine engine, air passing through the forward portion 1377 of the fan duct may be relatively cooler (e.g., lower temperature) than one or more fluids utilized in a turbomachine (see e.g., turbomachine 1120 of FIG. 23). Thus, the heat exchanger 1304 may be utilized to cool one or more fluids from the core engine with the air passing through the fan duct, as a resource for removing heat from a fluid, e.g., a compressor bleed air, oil, or fuel.

When incorporated into a gas turbine engine (see, e.g., gas turbine engines 1100 and 1200 of FIGS. 23 and 24), as noted above, the inlet 1308 of the heat exchanger 1304 may fluidly couple to the forward portion 1377 of the fan duct (depicted in phantom; see, e.g., fan duct 1172 of FIGS. 23 and 24). During operation of the gas turbine engine air flowing through the forward portion 1377 of the fan duct may be directed or routed into the main body 1312 of the heat exchanger 1304 through the inlet 1308. In such a manner, the main body 1312 may use the air passing therethrough to cool one or more systems of the gas turbine engine. Further, during operation, the main body 1312 may use the air passing through as a heat sink and correspondingly increase the temperature of the air that is directed or routed into the outlet 1310 of the heat exchanger 1304. The outlet 1310 then directs or routes the air to an exhaust nozzle 1314 where it may exit the gas turbine engine.

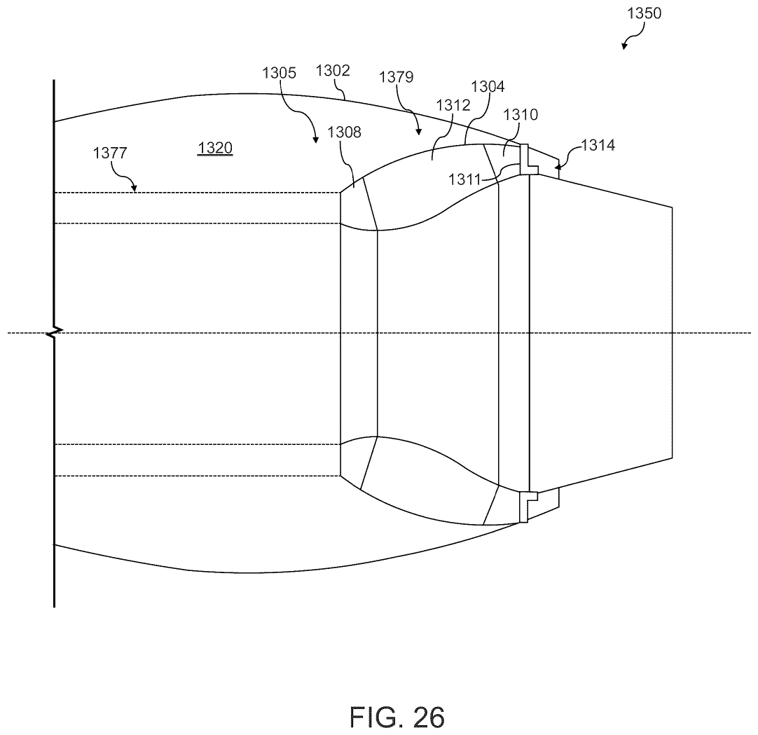

Referring now to FIG. 26, a schematic cross-sectional view of a cowl assembly 1350 in accordance with another exemplary aspect of the present disclosure is provided. The exemplary cowl assembly 1350 of FIG. 26 may be configured in substantially the same manner as the exemplary cowl assembly 1300 of FIG. 25, and accordingly, the same or similar numbers may refer to the same or similar parts.

For example, the exemplary cowl assembly 1350 of FIG. 26 generally includes an outer cowl 1302 and a heat exchanger 1304 that includes an inlet 1308, a main body 1312, and an outlet 1310 in serial flow order. In addition, the exemplary cowl assembly 1350 generally defines an annular auxiliary space 1320. However, for the embodiment of FIG. 26, the heat exchanger 1304 of the cowl assembly 1350 is now formed integrally with the outer cowl 1302. Further, for the embodiment of FIG. 26, the heat exchanger 1304 forms an aft portion 1379 of the fan duct, such that no additional or dedicated ducting structures are required to form the aft portion 1379 of the fan duct. In addition, it should be appreciated that the inlet 1308 of the heat exchanger 1304 couples with a forward portion 1377 of a fan duct (depicted in phantom in FIG. 25).

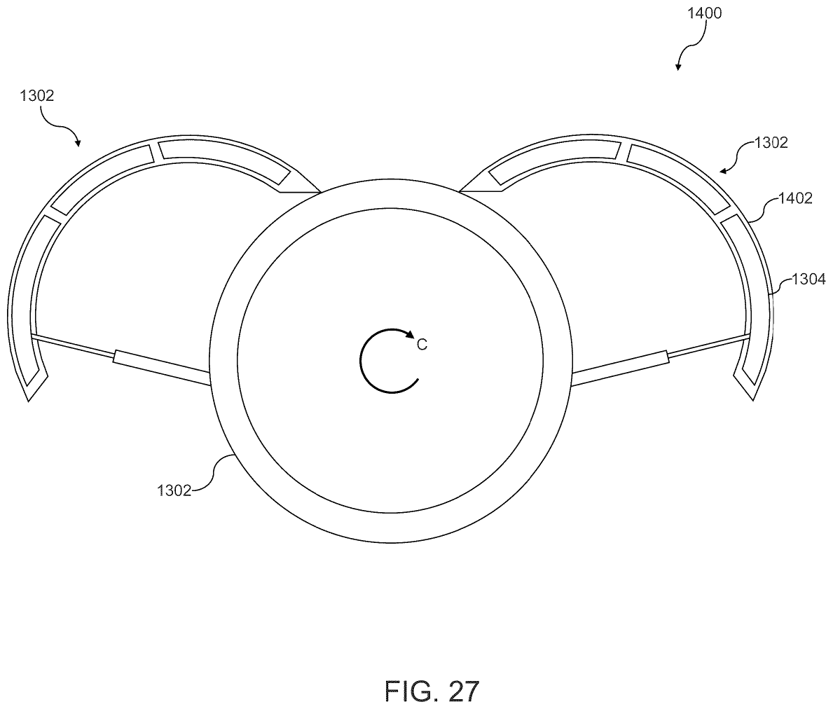

Referring now to FIG. 27, an aft looking forward view of a cowl assembly 1400 in accordance with another exemplary aspect of the present disclosure is provided. The exemplary cowl assembly 1400 of FIG. 27 may be configured in substantially the same manner as the exemplary cowl assembly 1300 of FIG. 25, and accordingly, the same or similar numbers may refer to the same or similar parts.

For example, the exemplary cowl assembly 1400 of FIG. 27 generally includes an outer cowl 1302. At least a portion of the outer cowl 1302 is moveable away from a turbomachine (e.g., turbomachine 1120 of FIGS. 23 and 24) during a maintenance operating condition of a gas turbine engine that the exemplary cowl assembly may be incorporated into. It should be appreciated that “moveable away” as used herein refers to the outer cowl 1302, or a portion of the outer cowl 1302, being moveable relative to a turbomachine of a gas turbine engine during a maintenance operating condition such that a maintenance personnel may access the interior of the outer cowl 1302 to repair and maintain the engine. For example, the entirety of the outer cowl 1302, including a heat exchanger may be moveable away from the turbomachine during a maintenance operating condition of a gas turbine engine. Additionally, or alternatively, the outer cowl 1302 may include one or more outer cowl doors 1402 that are moveable away from a turbomachine during a maintenance operating condition of the gas turbine engine.

As depicted, the outer cowl 1302 includes one or more outer cowl doors 1402 that are moveable away from a turbomachine such that they are moveable between an open position (shown in FIG. 27) and a closed position (see, e.g., FIGS. 24 and 25). In addition, for the exemplary embodiment depicted, the cowl assembly 1400 includes one or more heat exchangers 1304 that are formed integrally with or coupled to the outer cowl 1302, and more specifically to the outer cowl doors 1402 (e.g., in the same manner shown in FIG. 25). It should be appreciated that the exemplary cowl assembly 1400 may be incorporated into a gas turbine engine (see, e.g., gas turbine engines 1100 and 1200 of FIGS. 23 and 24) such that the outer cowl 1302 of the cowl assembly 1400 is a fan cowl (see e.g., fan cowl 1170 of FIGS. 23 and 24) of the gas turbine engine. Moreover, it should be appreciated that for the embodiment depicted, the one or more heat exchangers 1304 includes a plurality of heat exchangers 1304 spaced along a circumferential direction. Such a configuration may allow for the plurality of heat exchangers 1304 to independently operate with different accessory systems. Alternatively, however, the one or more heat exchangers 1304 may include a single, annular heat exchanger.

As depicted, the one or more outer cowl doors 1402 are in the open position such as to allow a maintenance personnel to access the interior of the outer cowl 1302 to repair and maintain an engine during a maintenance operating condition of the gas turbine engine. During an operating condition of the gas turbine engine, the one or more doors 1402 of the cowl assembly 1400 may be in the closed position, and more particularly, the one or more heat exchangers 1304 may define a portion of a fan duct (see e.g., fan duct 1172 of FIGS. 23 and 24).

This written description uses examples to disclose the present disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine defining an axial direction and a radial direction, the gas turbine engine comprising a turbomachine having an unducted primary fan, a core engine including a combustor and a combustor casing enclosing the combustor and defining an outer surface, and a core cowl surrounding at least a portion of the core engine and defining an inner surface and an outer surface. Wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction, wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L), and wherein the CDR is between 2.7 and 3.5 and wherein the CLR is between 0.25 and 0.50.

The gas turbine engine of the preceding clause, wherein the CDR is between 2.8 and 3.3.

The gas turbine engine of any preceding clause, wherein the CLR is between 0.3 and 0.45.

The gas turbine engine of any preceding clause, wherein the CLR is between 0.40 and 0.45.

The gas turbine engine of any preceding clause, wherein a void is defined between the outer surface of the combustor casing and the inner surface of the core cowl.

The gas turbine engine of any preceding clause, further comprising at least one engine accessory coupled to the inner surface of the core cowl.

The gas turbine engine of any preceding clause, further comprising a rear frame including a strut having a trailing edge, wherein the primary fan includes a primary fan blade having a leading edge, and wherein the overall core axial length (L) along the axial direction is measured from the leading edge of the primary fan blade to the trailing edge of the strut.

The gas turbine engine of any preceding clause, further comprising a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The gas turbine engine of any preceding clause, further comprising a ducted secondary fan disposed downstream from the primary fan.

The gas turbine engine of any preceding clause, wherein the ducted secondary fan is a single stage secondary fan.

The gas turbine engine of any preceding clause, wherein the gas turbine engine is a three-stream gas turbine engine.

A n aircraft, comprising a wing and a gas turbine engine mounted to the wing, the gas turbine engine defining an axial direction and a radial direction, the gas turbine engine comprising: a turbomachine having an unducted primary fan, a core engine including a combustor and a combustor casing enclosing the combustor and defining an outer surface, a core cowl surrounding at least a portion of the core engine and defining an inner surface and an outer surface. Wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction. W herein the gas turbine engine defines a core cowl diameter ratio (C D R) equal to the peak cowl diameter (D) divided by the maximum combustor casing diameter (d) and a core cowl length ratio (CLR) equal to the under-core cowl axial length (L1) divided by the overall core axial length (L). W herein the CDR is between 2.7 and 3.5 and wherein the CLR is between 0.25 and 0.50.

The aircraft as in the preceding clause, wherein the CDR is between 2.8 and 3.3.

The aircraft of any preceding clause, wherein the CLR is between 0.3 and 0.45.

The aircraft of any preceding clause, wherein the CLR is between 0.40 and 0.45.

The aircraft of any preceding clause, wherein a void is defined between the outer surface of the combustor casing and the inner surface of the core cowl of the gas turbine engine, and wherein at least one engine accessory is coupled to the inner surface of the core cowl.

The aircraft of any preceding clause, wherein the gas turbine engine further comprises a rear frame including a strut having a trailing edge, wherein the primary fan includes a plurality of primary fan blades where each primary fan blade has a leading edge, and wherein the overall core axial length (L) along the axial direction is measured from a leading edge of a respective primary fan blade of the plurality of primary fan blades to the trailing edge of the strut.

The aircraft of any preceding clause, wherein the gas turbine engine further comprises a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The aircraft of any preceding clause, the gas turbine engine further comprising a ducted secondary fan disposed downstream from the unducted primary fan.

A gas turbine engine, comprising: a core engine; a core cowl at least partially encasing a portion of the core engine, the core cowl having an inner surface and defining in part a void is between the inner surface and the core engine, the core cowl moveable relative to the core engine; and an engine component selectively coupled to the core engine or the core cowl.

The gas turbine engine of the preceding clause, wherein the core cowl is pivotable relative to the core engine.

A gas turbine engine, comprising a turbomachine and a housing at least partially encasing a portion of the turbomachine, the housing having an inner surface and defining in part a void between the inner surface and the portion of the turbomachine, the housing moveable relative to the portion of the turbomachine; and an engine component selectively coupled to the portion of the turbomachine or to the housing.

The gas turbine engine of the preceding clause, wherein the turbomachinery comprises a core engine, the housing comprises a core cowl at least partially encasing a portion of the core engine, the core cowl having an inner surface and defining in part a void between the inner surface and the core engine, wherein the core cowl is moveable relative to the core engine, and an engine component selectively coupled to the core engine or the core cowl, and wherein the core cowl is pivotable relative to the core engine.

The gas turbine engine of any preceding clause, wherein when the engine component is selectively coupled to the core cowl, the engine component travels with the core cowl when the core cowl is moved away from the core engine.

The gas turbine engine of any preceding clause, wherein the engine component is one of a heat exchanger, a sensor, a controller, a pump, a duct, a fire and overheat component, a generator, or a valve.

The gas turbine engine of any preceding clause, further comprising: a fastener, wherein the engine component is selectively connected to the core engine or the core cowl via the fastener.

The gas turbine engine of any preceding clause, wherein the core cowl defines an access opening, wherein the fastener is accessible through the access opening.

The gas turbine engine of any preceding clause, wherein the fastener includes a plurality of articulating tabs, wherein in a first position the plurality of articulating tabs engages with the core engine and the engine component and in a second position the plurality of tabs engages with the core cowl and the engine component.

The gas turbine engine of any preceding clause, further comprising a push-pull mechanism including a first pin, wherein the engine component is selectively coupled to the core engine or the core cowl via the push-pull mechanism, wherein the first pin engages with the core engine and the engine component when the push-pull mechanism is in a first position, and the first pin engages with the engine component and the core cowl when the push-pull mechanism is in a second position.

The gas turbine engine of any preceding clause, wherein the push-pull mechanism is manually actuated between the first position and the second position.

The gas turbine engine of any preceding clause, wherein the push-pull mechanism is electrically actuated between the first position and the second position.

The gas turbine engine of any preceding clause, wherein the push-pull mechanism includes a second pin, wherein the second pin engages with a door counterbalance mechanism when the first pin is engaged with the engine component and the core cowl.

The gas turbine engine of any preceding clause, wherein the gas turbine engine includes an unducted primary fan.

The gas turbine engine of any preceding clause, further comprising a ducted secondary fan disposed downstream from the primary fan, wherein the ducted secondary fan is a single stage secondary fan or a multi-stage secondary fan.

A n aircraft, comprising a core engine and a core cowl at least partially encasing a portion of the core engine. The core cowl having an inner surface, wherein a void is defined between the inner surface and the core engine, wherein the core cowl is pivotally mounted to the gas turbine engine, and an engine component selectively coupled to the core engine or the core cowl.

The aircraft as in the preceding clause, wherein the engine component is selectively coupled to the core cowl, and wherein the engine component travels with the core cowl when the core cowl is pivoted away from the core engine.

The aircraft of any preceding clause, wherein the engine component is one of a heat exchanger, a sensor, a controller, a pump, a duct, a fire and overheat component, a generator, or a valve.

The aircraft of any preceding clause, wherein the engine component is selectively coupled to the core engine or the core cowl via a fastener, wherein the fastener is accessible from outside of the core cowl, wherein the fastener includes a plurality of articulating tabs, and wherein in a first position the plurality of articulating tabs engages with the core engine and the engine component, and in a second position the plurality of articulating tabs engages with the core cowl and the engine component.

The aircraft of any preceding clause, wherein the engine component is selectively coupled to the core engine or the core cowl via a push-pull mechanism including a first pin, wherein the first pin engages with the core engine and the engine component when the push-pull mechanism is in a first position, and the first pin engages with the engine component and the core cowl when the push-pull mechanism is in a second position.

The aircraft of any preceding clause, wherein the push-pull mechanism is manually actuated between the first position and the second position.

The aircraft of any preceding clause, wherein the push-pull mechanism includes a second pin, wherein the second pin engages with a door counterbalance mechanism when the first pin is engaged with the core cowl and the engine component.

The aircraft of any preceding clause, wherein the engine component is selectively connected to the core engine or the core cowl via a push-pull mechanism including a first pin, wherein the first pin engages with the core engine and the engine component when the push-pull mechanism is in a first position, and the first pin engages with the engine component and the core cowl when the push-pull mechanism is in a second position, wherein the push-pull mechanism is manually actuatable between the first position and the second position.

The aircraft of any preceding clause, wherein the gas turbine engine includes a ducted primary fan.

The gas turbine engine of any preceding clause, wherein the engine component is positioned within the core cowl.

The gas turbine engine of any preceding clause, wherein the engine component is one of a heat exchanger, a sensor, a controller, a pump, a duct, a fire and overheat component, a generator, or a valve.

The gas turbine engine of any preceding clause, wherein the engine component is an engine controller.

The gas turbine engine of any preceding clause, wherein the engine component is power electronics, a lubrication oil tank, a lubrication oil pump, an electric machine, or a combination thereof.

The gas turbine engine of any preceding clause, wherein the gas turbine engine is incorporated into an aircraft configured to cruise at an altitude between 28,000 feet and 65,000 feet.

The gas turbine engine of any preceding clause, wherein the gas turbine engine is configured to generate at least 18,000 pounds of thrust and less than 80,000 pounds of thrust when operated at a rated speed during standard day operating conditions.

A gas turbine engine defining an axial direction, the gas turbine engine comprising: a turbomachine having a primary fan, a core engine, and a core cowl surrounding at least a portion of the core engine, the turbomachine defining an under-core cowl axial length (L1) along the axial direction and an initial compression axial length (L2), the core engine comprising a gearbox, the primary fan being drivingly coupled to the core engine across the gearbox; wherein the gas turbine engine is configured to generate at least 18,000 pounds of thrust and less than 80,000 pounds of thrust when operated at a rated speed during standard day operating conditions, wherein the turbomachine defines an initial compression length ratio (ICLR) equal to the initial compression axial length (L2) divided by the under-core cowl axial length (L1), wherein the ICLR is greater than or equal to 0.55 and less than or equal to 0.9.

A gas turbine engine defining an axial direction, the gas turbine engine comprising: a turbomachine having a primary fan, a core engine, and a core cowl surrounding at least a portion of the core engine, the turbomachine defining an under-core cowl axial length (L1) along the axial direction and an initial compression axial length (L2), the core engine comprising a gearbox and a turbine section having a low-pressure turbine, the primary fan being drivingly coupled to the low-pressure turbine across the gearbox; wherein the low-pressure turbine comprises at least a total of four stages of low-pressure turbine rotor blades and up to six stages of low-pressure turbine rotor blades; wherein the turbomachine defines an initial compression length ratio (ICLR) equal to the initial compression axial length (L2) divided by the under-core cowl axial length (L1), wherein the ICLR is greater than or equal to 0.3 and less than or equal to 0.9.

A gas turbine engine defining an axial direction, the gas turbine engine comprising: a turbomachine having a primary fan, a core engine, and a core cowl surrounding at least a portion of the core engine, the turbomachine defining an under-core cowl axial length (L1) along the axial direction and an initial compression axial length (L2), the core engine comprising a gearbox having a gear ratio greater than or equal to 3.2:1 and less than or equal to 14:1, the primary fan being drivingly coupled to the core engine across the gearbox; wherein the turbomachine defines an initial compression length ratio (ICLR) equal to the initial compression axial length (L2) divided by the under-core cowl axial length (L1), wherein the ICLR is greater than or equal to 0.3 and less than or equal to 0.9.

A gas turbine engine defining an axial direction, the gas turbine engine comprising: a turbomachine having a primary fan, a core engine, and a core cowl surrounding at least a portion of the core engine, the core engine comprising a high-pressure compressor comprising at least a total of eight stages of high-pressure compressor rotor blades and up to a total of 11 stages of high-pressure compressor rotor blades, the core engine further comprising a gearbox, the primary fan being drivingly coupled to the core engine across the gearbox; wherein the turbomachine defines an under-core cowl axial length (L1) along the axial direction and an initial compression axial length (L2), wherein the turbomachine defines an initial compression length ratio (ICLR) equal to the initial compression axial length (L2) divided by the under-core cowl axial length (L1), wherein the ICLR is greater than or equal to 0.3 and less than or equal to 0.9.

The gas turbine engine of any preceding clause, wherein the ICLR is greater than or equal to 0.55 and less than or equal to 0.9.

The gas turbine engine of any preceding clause, wherein the ICLR is greater than or equal to 0.6 and less than or equal to 0.89.

The gas turbine engine of any preceding clause, wherein the primary fan is an unducted primary fan, and wherein the ICLR is greater than or equal to 0.7.

The gas turbine engine of any preceding clause, wherein the turbomachine further includes a fan cowl and defines a fan duct between the fan cowl and the core cowl configured as a third stream, and wherein the ICLR is greater than or equal to 0.7.

The gas turbine engine of any preceding clause, further comprising a nacelle surrounding at least in part the primary fan, and wherein the ICLR is greater than or equal to 0.6 and less than or equal to 0.75.

The gas turbine engine of any preceding clause, wherein the gas turbine engine is a two stream engine, and wherein the ICLR is greater than or equal to 0.6 and less than or equal to 0.75.

The gas turbine engine of any preceding clause, wherein the core engine comprises a compressor section and a turbine section, wherein the compressor section has a high-pressure compressor comprising a total of eight to ten stages of high-pressure compressor rotor blades, and wherein the turbine section has a low-pressure turbine comprising a total of three to five stages of low-pressure turbine rotor blades.

The gas turbine engine of any preceding clause, wherein the gas turbine engine is configured to generate at least 18,000 pounds of thrust and less than 80,000 pounds of thrust when operated at a rated speed during standard day operating conditions.

The gas turbine engine of any preceding clause, wherein the gas turbine engine is configured to generate between 25,000 and 60,000 pounds of thrust during operation at the rated speed during standard day operating conditions.

The gas turbine engine of any preceding clause, wherein the high-pressure compressor comprises a total of nine stages.

The gas turbine engine of any preceding clause, wherein the low-pressure turbine comprises a total of four stages.

A gas turbine engine defining an axial direction and a radial direction, the gas turbine engine comprising a turbomachine having an unducted primary fan, a core engine including a combustor and a combustor casing enclosing the combustor and defining an outer surface, and a core cowl surrounding at least a portion of the core engine and defining an inner surface and an outer surface. Wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction, wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L), and wherein the CDR is between 2.7 and 3.5 and wherein the CLR is between 0.25 and 0.50.

The gas turbine engine of any preceding clause, wherein the CDR is between 2.8 and 3.3.

The gas turbine engine of any preceding clause, wherein the CLR is between 0.3 and 0.45.

The gas turbine engine of any preceding clause, wherein the CLR is between 0.40 and 0.45.

The gas turbine engine of any preceding clause, wherein a void is defined between the outer surface of the combustor casing and the inner surface of the core cowl.

The gas turbine engine of any preceding clause, further comprising at least one engine accessory coupled to the inner surface of the core cowl.

The gas turbine engine of any preceding clause, further comprising a rear frame including a strut having a trailing edge, wherein the primary fan includes a primary fan blade having a leading edge, and wherein the overall core axial length (L) along the axial direction is measured from the leading edge of the primary fan blade to the trailing edge of the strut.

The gas turbine engine of any preceding clause, further comprising a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The gas turbine engine of any preceding clause, further comprising a ducted secondary fan disposed downstream from the primary fan.

The gas turbine engine of any preceding clause, wherein the ducted secondary fan is a single stage secondary fan.

The gas turbine engine of any preceding clause, wherein the gas turbine engine is a three-stream gas turbine engine.

An aircraft, comprising a wing and a gas turbine engine mounted to the wing, the gas turbine engine defining an axial direction and a radial direction, the gas turbine engine comprising: a turbomachine having an unducted primary fan, a core engine including a combustor and a combustor casing enclosing the combustor and defining an outer surface, a core cowl surrounding at least a portion of the core engine and defining an inner surface and an outer surface. W herein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction. W herein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L). W herein the CD R is between 2.7 and 3.5 and wherein the CLR is between 0.25 and 0.50.

The aircraft as in the preceding clause, wherein the CDR is between 2.8 and 3.3.

The aircraft of any preceding clause, wherein the CLR is between 0.3 and 0.45.

The aircraft of any preceding clause, wherein the CLR is between 0.40 and 0.45.

The aircraft of any preceding clause, wherein a void is defined between the outer surface of the combustor casing and the inner surface of the core cowl of the gas turbine engine, and wherein at least one engine accessory is coupled to the inner surface of the core cowl.

The aircraft of any preceding clause, wherein the gas turbine engine further comprises a rear frame including a strut having a trailing edge, wherein the primary fan includes a plurality of primary fan blades where each primary fan blade has a leading edge, and wherein the overall core axial length (L) along the axial direction is measured from a leading edge of a respective primary fan blade of the plurality of primary fan blades to the trailing edge of the strut.

The aircraft of any preceding clause, wherein the gas turbine engine further comprises a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The aircraft of any preceding clause, the gas turbine engine further comprising a ducted secondary fan disposed downstream from the unducted primary fan.

A gas turbine engine, comprising: a core engine; a core cowl at least partially encasing a portion of the core engine, the core cowl having an inner surface and defining in part a void is between the inner surface and the core engine, the core cowl moveable relative to the core engine; and an engine component selectively coupled to the core engine or the core cowl.

The gas turbine engine of the preceding clause, wherein the core cowl is pivotable relative to the core engine.

A gas turbine engine, comprising a turbomachine and a housing at least partially encasing a portion of the turbomachine, the housing having an inner surface and defining in part a void between the inner surface and the portion of the turbomachine, the housing moveable relative to the portion of the turbomachine; and an engine component selectively coupled to the portion of the turbomachine or to the housing.

The gas turbine engine of the preceding clause, wherein the turbomachinery comprises a core engine, the housing comprises a core cowl at least partially encasing a portion of the core engine, the core cowl having an inner surface and defining in part a void between the inner surface and the core engine, wherein the core cowl is moveable relative to the core engine, and an engine component selectively coupled to the core engine or the core cowl, and wherein the core cowl is pivotable relative to the core engine.

The gas turbine engine of any preceding clause, wherein when the engine component is selectively coupled to the core cowl, the engine component travels with the core cowl when the core cowl is moved away from the core engine.

The gas turbine engine of any preceding clause, wherein the engine component is one of a heat exchanger, a sensor, a controller, a pump, a duct, a fire and overheat component, a generator, or a valve.

The gas turbine engine of any preceding clause, further comprising: a fastener, wherein the engine component is selectively connected to the core engine or the core cowl via the fastener.

The gas turbine engine of any preceding clause, wherein the core cowl defines an access opening, wherein the fastener is accessible through the access opening.

The gas turbine engine of any preceding clause, wherein the fastener includes a plurality of articulating tabs, wherein in a first position the plurality of articulating tabs engages with the core engine and the engine component and in a second position the plurality of tabs engages with the core cowl and the engine component.

The gas turbine engine of any preceding clause, further comprising a push-pull mechanism including a first pin, wherein the engine component is selectively coupled to the core engine or the core cowl via the push-pull mechanism, wherein the first pin engages with the core engine and the engine component when the push-pull mechanism is in a first position, and the first pin engages with the engine component and the core cowl when the push-pull mechanism is in a second position.

The gas turbine engine of any preceding clause, wherein the push-pull mechanism is manually actuated between the first position and the second position.

The gas turbine engine of any preceding clause, wherein the push-pull mechanism is electrically actuated between the first position and the second position.

The gas turbine engine of any preceding clause, wherein the push-pull mechanism includes a second pin, wherein the second pin engages with a door counterbalance mechanism when the first pin is engaged with the engine component and the core cowl.

The gas turbine engine of any preceding clause, wherein the gas turbine engine includes an unducted primary fan.

The gas turbine engine of any preceding clause, further comprising a ducted secondary fan disposed downstream from the primary fan, wherein the ducted secondary fan is a single stage secondary fan or a multi-stage secondary fan.

A n aircraft, comprising a core engine and a core cowl at least partially encasing a portion of the core engine. The core cowl having an inner surface, wherein a void is defined between the inner surface and the core engine, wherein the core cowl is pivotally mounted to the gas turbine engine, and an engine component selectively coupled to the core engine or the core cowl.

The aircraft as in the preceding clause, wherein the engine component is selectively coupled to the core cowl, and wherein the engine component travels with the core cowl when the core cowl is pivoted away from the core engine.

The aircraft of any preceding clause, wherein the engine component is one of a heat exchanger, a sensor, a controller, a pump, a duct, a fire and overheat component, a generator, or a valve.

The aircraft of any preceding clause, wherein the engine component is selectively coupled to the core engine or the core cowl via a fastener, wherein the fastener is accessible from outside of the core cowl, wherein the fastener includes a plurality of articulating tabs, and wherein in a first position the plurality of articulating tabs engages with the core engine and the engine component, and in a second position the plurality of articulating tabs engages with the core cowl and the engine component.

The aircraft of any preceding clause, wherein the engine component is selectively coupled to the core engine or the core cowl via a push-pull mechanism including a first pin, wherein the first pin engages with the core engine and the engine component when the push-pull mechanism is in a first position, and the first pin engages with the engine component and the core cowl when the push-pull mechanism is in a second position.

The aircraft of any preceding clause, wherein the push-pull mechanism is manually actuated between the first position and the second position.

The aircraft of any preceding clause, wherein the push-pull mechanism includes a second pin, wherein the second pin engages with a door counterbalance mechanism when the first pin is engaged with the core cowl and the engine component.

The aircraft of any preceding clause, wherein the engine component is selectively connected to the core engine or the core cowl via a push-pull mechanism including a first pin, wherein the first pin engages with the core engine and the engine component when the push-pull mechanism is in a first position, and the first pin engages with the engine component and the core cowl when the push-pull mechanism is in a second position, wherein the push-pull mechanism is manually actuatable between the first position and the second position.

The aircraft of any preceding clause, wherein the gas turbine engine includes a ducted primary fan.

The gas turbine engine of any preceding clause, wherein the engine component is positioned within the core cowl.

The gas turbine engine of any preceding clause, wherein the engine component is one of a heat exchanger, a sensor, a controller, a pump, a duct, a fire and overheat component, a generator, or a valve.

The gas turbine engine of any preceding clause, wherein the engine component is an engine controller.

The gas turbine engine of any preceding clause, wherein the engine component is power electronics, a lubrication oil tank, a lubrication oil pump, an electric machine, or a combination thereof.

The gas turbine engine of any preceding clause, wherein the gas turbine engine is incorporated into an aircraft configured to cruise at an altitude between 28,000 feet and 65,000 feet.

The gas turbine engine of any preceding clause, wherein the gas turbine engine is configured to generate at least 18,000 pounds of thrust and less than 80,000 pounds of thrust when operated at a rated speed during standard day operating conditions.

A gas turbine engine defining an axial direction, the gas turbine engine comprising: a turbomachine having a primary fan, a core engine, and a core cowl surrounding at least a portion of the core engine, the turbomachine defining an under-core cowl axial length (L1) along the axial direction and an initial compression axial length (L2), the core engine comprising a gearbox, the primary fan being drivingly coupled to the core engine across the gearbox; wherein the gas turbine engine is configured to generate at least 18,000 pounds of thrust and less than 80,000 pounds of thrust when operated at a rated speed during standard day operating conditions, wherein the turbomachine defines an initial compression length ratio (ICLR) equal to the initial compression axial length (L2) divided by the under-core cowl axial length (L1), wherein the ICLR is greater than or equal to 0.55 and less than or equal to 0.9.

A gas turbine engine defining an axial direction, the gas turbine engine comprising: a turbomachine having a primary fan, a core engine, and a core cowl surrounding at least a portion of the core engine, the turbomachine defining an under-core cowl axial length (L1) along the axial direction and an initial compression axial length (L2), the core engine comprising a gearbox and a turbine section having a low-pressure turbine, the primary fan being drivingly coupled to the low-pressure turbine across the gearbox; wherein the low-pressure turbine comprises at least a total of four stages of low-pressure turbine rotor blades and up to six stages of low-pressure turbine rotor blades; wherein the turbomachine defines an initial compression length ratio (ICLR) equal to the initial compression axial length (L2) divided by the under-core cowl axial length (L1), wherein the ICLR is greater than or equal to 0.3 and less than or equal to 0.9.

A gas turbine engine defining an axial direction, the gas turbine engine comprising: a turbomachine having a primary fan, a core engine, and a core cowl surrounding at least a portion of the core engine, the turbomachine defining an under-core cowl axial length (L1) along the axial direction and an initial compression axial length (L2), the core engine comprising a gearbox having a gear ratio greater than or equal to 3.2:1 and less than or equal to 14:1, the primary fan being drivingly coupled to the core engine across the gearbox; wherein the turbomachine defines an initial compression length ratio (ICLR) equal to the initial compression axial length (L2) divided by the under-core cowl axial length (L1), wherein the ICLR is greater than or equal to 0.3 and less than or equal to 0.9.

A gas turbine engine defining an axial direction, the gas turbine engine comprising: a turbomachine having a primary fan, a core engine, and a core cowl surrounding at least a portion of the core engine, the core engine comprising a high-pressure compressor comprising at least a total of eight stages of high-pressure compressor rotor blades and up to a total of 11 stages of high-pressure compressor rotor blades, the core engine further comprising a gearbox, the primary fan being drivingly coupled to the core engine across the gearbox; wherein the turbomachine defines an under-core cowl axial length (L1) along the axial direction and an initial compression axial length (L2), wherein the turbomachine defines an initial compression length ratio (ICLR) equal to the initial compression axial length (L2) divided by the under-core cowl axial length (L1), wherein the ICLR is greater than or equal to 0.3 and less than or equal to 0.9.

The gas turbine engine of any preceding clause, wherein the ICLR is greater than or equal to 0.55 and less than or equal to 0.9.

The gas turbine engine of any preceding clause, wherein the ICLR is greater than or equal to 0.6 and less than or equal to 0.89.

The gas turbine engine of any preceding clause, wherein the primary fan is an unducted primary fan, and wherein the ICLR is greater than or equal to 0.7.

The gas turbine engine of any preceding clause, wherein the turbomachine further includes a fan cowl and defines a fan duct between the fan cowl and the core cowl configured as a third stream, and wherein the ICLR is greater than or equal to 0.7.

The gas turbine engine of any preceding clause, further comprising a nacelle surrounding at least in part the primary fan, and wherein the ICLR is greater than or equal to 0.6 and less than or equal to 0.75.

The gas turbine engine of any preceding clause, wherein the gas turbine engine is a two stream engine, and wherein the ICLR is greater than or equal to 0.6 and less than or equal to 0.75.

The gas turbine engine of any preceding clause, wherein the core engine comprises a compressor section and a turbine section, wherein the compressor section has a high-pressure compressor comprising a total of eight to ten stages of high-pressure compressor rotor blades, and wherein the turbine section has a low-pressure turbine comprising a total of three to five stages of low-pressure turbine rotor blades.

The gas turbine engine of any preceding clause, wherein the gas turbine engine is configured to generate at least 18,000 pounds of thrust and less than 80,000 pounds of thrust when operated at a rated speed during standard day operating conditions.

The gas turbine engine of any preceding clause, wherein the gas turbine engine is configured to generate between 25,000 and 60,000 pounds of thrust during operation at the rated speed during standard day operating conditions.

The gas turbine engine of any preceding clause, wherein the high-pressure compressor comprises a total of nine stages.

The gas turbine engine of any preceding clause, wherein the low-pressure turbine comprises a total of four stages.

A gas turbine engine defining an axial direction and a radial direction, the gas turbine engine including a turbomachine including an unducted primary fan, a core engine including a combustor and a combustor casing enclosing the combustor and defining an outer surface, a core cowl surrounding at least a portion of the core engine and defining an inner surface and an outer surface, the core cowl including a forward portion and an aft portion, a tail cone disposed inward of the aft portion of the core cowl in the radial direction, a fan cowl disposed outward of the forward portion the core cowl in the radial direction, and a pylon extending from the fan cowl, wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction, wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L), wherein the CDR is between 2.7 and 3.5 and wherein the CLR is between 0.25 and 0.50, wherein the turbomachine defines an accessory cavity for housing an accessory system.

The gas turbine engine of any preceding clause, wherein the CDR is between 2.8 and 3.3.

The gas turbine engine as in any preceding clause, wherein the CLR is between 0.3 and 0.45.

The gas turbine engine as in any preceding clause, wherein the CLR is between 0.40 and 0.45.

The gas turbine engine as in any preceding clause, wherein the accessory cavity is defined in at least one of the pylon, the fan cowl, the forward portion of the core cowl, the aft portion of the core cowl, or the tail cone.

The gas turbine engine as in any preceding clause, further including a rear frame including a strut having a trailing edge, wherein the primary fan includes a primary fan blade having a leading edge, and wherein the overall core axial length (L) along the axial direction is measured from the leading edge of the primary fan blade to the trailing edge of the strut.

The gas turbine engine as in any preceding clause, further including a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The gas turbine engine as in any preceding clause, wherein the accessory system includes at least one of an accessory gearbox, a computing system, an electric machine, a power electronics device, a heat exchanger assembly, and a trunnion mechanism for a variable pitch fan.

The gas turbine engine as in any preceding clause, wherein the accessory cavity is a first accessory cavity defined in the pylon, and the accessory system includes at least one of the accessory gearbox or the computing system.

The gas turbine engine as in any preceding clause, wherein the accessory cavity is a second accessory cavity defined in the fan cowl, and the accessory system includes at least one of the accessory gearbox, the computing system, or the heat exchanger assembly.

The gas turbine engine as in any preceding clause, wherein the accessory cavity is a third accessory cavity defined in the forward portion of the core cowl, and the accessory system includes at least one of the heat exchanger assembly, the accessory gearbox, or the trunnion mechanism.

The gas turbine engine as in any preceding clause, wherein the accessory cavity is a fourth accessory cavity defined in the aft portion of the core cowl, and the accessory system includes at least one of the heat exchanger assembly or the trunnion mechanism.

The gas turbine engine as in any preceding clause, wherein the accessory cavity is a fifth accessory cavity defined in the tail cone, and the accessory system includes at least one of the accessory gearbox, the computing system, the electric machine, the power electronics device, or the heat exchanger assembly.

A n aircraft, including a wing and a gas turbine engine mounted to the wing, the gas turbine engine defining an axial direction and a radial direction, the gas turbine engine including a turbomachine including an unducted primary fan, a core engine including a combustor and a combustor casing enclosing the combustor and defining an outer surface, a core cowl surrounding at least a portion of the core engine and defining an inner surface and an outer surface, the core cowl including a forward portion and an aft portion, a tail cone disposed inward of the aft portion of the core cowl in the radial direction, a fan cowl disposed outward of the forward portion the core cowl in the radial direction, and a pylon extending from the fan cowl, wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction, wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L), wherein the CDR is between 2.7 and 3.5 and wherein the CLR is between 0.25 and 0.50, wherein the turbomachine defines an accessory cavity for housing an accessory system.

The aircraft as in any preceding clause, wherein the accessory system includes at least one of an accessory gearbox, a computing system, an electric machine, a heat exchanger assembly, a power electronics device, and a trunnion mechanism for a variable pitch fan.

The aircraft as in any preceding clause, wherein the accessory cavity is a first accessory cavity defined in the pylon, and the accessory system includes at least one of the accessory gearbox or the computing system.

The aircraft as in any preceding clause, wherein the accessory cavity is a second accessory cavity defined in the fan cowl, and the accessory system includes at least one of the accessory gearbox, the computing system, or the heat exchanger assembly.

The aircraft as in any preceding clause, wherein the accessory cavity is a third accessory cavity defined in the forward portion of the core cowl, and the accessory system includes at least one of the heat exchanger assembly, the accessory gearbox or the trunnion mechanism.

The aircraft as in any preceding clause, wherein the accessory cavity is a fourth accessory cavity defined in the aft portion of the core cowl, and the accessory system includes at least one of the heat exchanger assembly or the trunnion mechanism.

The aircraft as in any preceding clause, wherein the accessory cavity is a fifth accessory cavity defined in the tail cone, and the accessory system includes at least one of the accessory gearbox, the computing system, the electric machine, the power electronics device, or the heat exchanger assembly.

A gas turbine engine comprising: a turbomachine comprising a compressor section, a combustion section, and a turbine section arranged in serial flow order, the turbomachine including an inlet duct defining an engine inlet, a fan duct defining a fan duct inlet, and a core duct defining a core duct inlet; a fan cowl disposed circumferentially around the turbomachine; and a heat exchanger defining a portion of the fan duct, at least a portion of the heat exchanger formed integrally with or coupled to the fan cowl.

The gas turbine engine of any preceding clause, wherein the fan cowl defines a maximum radius, wherein the fan duct comprises a forward portion, wherein the forward portion of the fan duct defines a maximum radius, and wherein the maximum radius of the fan duct is at most 65% of the maximum radius of the fan cowl.

The gas turbine engine of any preceding clause, wherein a forward bracket is configured to couple the heat exchanger to the forward portion of the fan duct.

The gas turbine engine of any preceding clause, wherein an aft bracket is configured to couple the heat exchanger to the outer cowl.

The gas turbine engine of any preceding clause, wherein the compressor section comprises a high pressure compressor, and wherein the forward portion extends over the high pressure compressor.

The gas turbine engine of any preceding clause, wherein the heat exchanger is formed integrally with or coupled to an aft portion of the fan cowl.

The gas turbine engine of any preceding clause, wherein at least a portion of the fan cowl is moveable away from the turbomachine during a maintenance operating condition of the gas turbine engine.

The gas turbine engine of any preceding clause, wherein the fan cowl includes one or more fan cowl doors moveable away from the turbomachine during the maintenance operating condition of the gas turbine engine, and wherein the heat exchanger is moveable away from the turbomachine with the one or more fan cowl doors during the maintenance operating condition of the gas turbine engine.

The gas turbine engine of any preceding clause, wherein the fan duct comprises a forward portion and an aft portion, and wherein the heat exchanger forms the aft portion of the fan duct.

The gas turbine engine of any preceding clause, wherein the heat exchanger is located in an aft 50% of the fan duct.

The gas turbine engine of any preceding clause, wherein the compressor section comprises a high pressure compressor, wherein the fan duct comprises a forward portion that extends over the high pressure compressor and an aft portion located aft of the forward portion, and wherein the heat exchanger forms the aft portion of the fan duct.

The gas turbine engine of any preceding clause, wherein the heat exchanger comprises an inlet, a main body, and an outlet, and wherein the inlet and the outlet are formed integrally with or coupled to the fan cowl.

A gas turbine engine comprising: a turbomachine comprising a compressor section, a combustion section, and a turbine section arranged in serial flow order, the turbomachine including an inlet duct defining an engine inlet, a fan duct defining a fan duct inlet, and a core duct defining a core duct inlet; a primary fan driven by the turbomachine; a secondary fan located downstream of the primary fan within the inlet duct; and a heat exchanger located in an aft 50% of the fan duct.

The gas turbine engine of any preceding clause, further comprising: an outer cowl assembly comprising: an outer cowl disposed circumferentially around the turbomachine; wherein the heat exchanger is configured as part of the outer cowl assembly.

The gas turbine engine of any preceding clause, wherein the outer cowl defines a maximum radius, wherein the fan duct comprises a forward portion, wherein the forward portion of the fan duct defines a maximum radius, and wherein the maximum radius of the fan duct is at most 65% of the maximum radius of the outer cowl.

The gas turbine engine of any preceding clause, wherein the heat exchanger is formed integrally with or coupled to an aft portion of the outer cowl.

The gas turbine engine of any preceding clause, wherein at least a portion of the outer cowl is moveable away from the turbomachine during a maintenance operating condition of the gas turbine engine.

The gas turbine engine of any preceding clause, wherein the outer cowl includes one or more outer cowl doors moveable away from the turbomachine during the maintenance operating condition of the gas turbine engine, and wherein the heat exchanger is moveable away from the turbomachine with the one or more outer cowl doors during the maintenance operating condition of the gas turbine engine.

The gas turbine engine of any preceding clause, wherein the heat exchanger comprises an inlet, a main body, and an outlet, and wherein the inlet and the outlet are formed integrally with or coupled to the outer cowl.

The gas turbine engine of any preceding clause, wherein the fan duct comprises a forward portion and an aft portion, and wherein the heat exchanger forms the aft portion of the fan duct.

The gas turbine engine of any preceding clause, wherein the heat exchanger is located in an aft 50% of the fan duct.

The gas turbine engine of any preceding clause, wherein the compressor section comprises a high pressure compressor, wherein the fan duct comprises a forward portion that extends over the high pressure compressor and an aft portion located aft of the forward portion, and wherein the heat exchanger forms the aft portion of the fan duct.

A gas turbine engine defining an axial direction and a radial direction, the gas turbine engine comprising: a turbomachine having an unducted primary fan, a core engine including a combustor and a combustor casing enclosing the combustor and defining an outer surface, a core cowl surrounding at least a portion of the core engine and defining an inner surface and an outer surface, the inner surface defining in part an accessory cavity and the turbomachine comprising an accessory system mounted at least partially within the accessory cavity; wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction, wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L), wherein the CDR is between 2.7 and 3.5 and wherein the CLR is between 0.25 and 0.50.

The gas turbine engine of any preceding clause, wherein the accessory cavity is defined in a forward portion of the core cowl.

The gas turbine engine of any preceding clause, wherein the accessory system includes at least one of the heat exchanger assembly or an accessory gearbox.

The gas turbine engine of any preceding clause, wherein the accessory system includes at least one of an accessory gearbox, a computing system, an electric machine, a power electronics device, and a heat exchanger assembly.

The gas turbine engine of any preceding clause, wherein the accessory cavity is defined in an aft portion of the core cowl.

The gas turbine engine of any preceding clause, wherein the turbomachine comprises at least in part a fan duct and a heat exchanger located in an aft 50% of the fan duct.

The gas turbine engine of any preceding clause, further comprising: an outer cowl assembly comprising an outer cowl disposed circumferentially around the turbomachine, wherein the outer cowl defines a maximum radius, wherein the fan duct comprises a forward portion, wherein the forward portion of the fan duct defines a maximum radius, and wherein the maximum radius of the fan duct is at most 65% of the maximum radius of the outer cowl.

The gas turbine engine as in any preceding clause, wherein the heat exchanger is configured as part of the outer cowl assembly the CD R is between 2.8 and 3.3.

The gas turbine engine as in any preceding clause, wherein the core engine is cantilever mounted at a forward end, and wherein the accessory system is mounted within the accessory cavity to reduce a vibratory response of the core engine during operation.

The gas turbine engine as in any preceding clause, wherein the CLR is between 0.3 and 0.45, and wherein the CLR is between 0.40 and 0.45.

The gas turbine engine as in any preceding clause, wherein a void is defined between the outer surface of the combustor casing and the inner surface of the core cowl.

The gas turbine engine as in any preceding clause, further comprising at least one engine accessory coupled to the inner surface of the core cowl.

The gas turbine engine as in any preceding clause, further comprising: a rear frame including a strut having a trailing edge, wherein the primary fan includes a primary fan blade having a leading edge, and wherein the overall core axial length (L) along the axial direction is measured from the leading edge of the primary fan blade to the trailing edge of the strut.

The gas turbine engine as in any preceding clause, further comprising: a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The gas turbine engine as in any preceding clause, further comprising a ducted secondary fan disposed downstream from the primary fan.

The gas turbine engine as in any preceding clause, wherein the ducted secondary fan is a single stage secondary fan.

The gas turbine engine as in any preceding clause, wherein the gas turbine engine is a three-stream gas turbine engine.

A n aircraft, comprising: a wing; and a gas turbine engine mounted to the wing, the gas turbine engine defining an axial direction and a radial direction, the gas turbine engine comprising: a turbomachine having an unducted primary fan, a core engine including a combustor and a combustor casing enclosing the combustor and defining an outer surface, a core cowl surrounding at least a portion of the core engine and defining an inner surface and an outer surface, the inner surface defining in part an accessory cavity and the turbomachine comprising an accessory system mounted at least partially within the accessory cavity; wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction, wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L), wherein the CDR is between 2.7 and 3.5 and wherein the CLR is between 0.25 and 0.50.

The aircraft as in any preceding clause, wherein the accessory cavity is defined in a forward portion of the core cowl.

The aircraft as in any preceding clause, wherein the accessory system includes at least one of the heat exchanger assembly or an accessory gearbox.

We claim:

1. A gas turbine engine defining an axial direction and a radial direction, the gas turbine engine comprising:
a turbomachine having an unducted primary fan, a core engine including a combustor and a combustor casing enclosing the combustor and defining an outer surface, a core cowl surrounding at least a portion of the core engine and defining an inner surface and an outer surface, the inner surface defining in part an accessory cavity and the turbomachine comprising an accessory system mounted at least partially within the accessory cavity;
wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction,
wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L),
wherein the CDR is between 2.7 and 3.5 and wherein the CLR is between 0.25 and 0.50.

2. The gas turbine engine of claim 1, wherein the accessory cavity is defined in a forward portion of the core cowl.

3. The gas turbine engine of claim 2, wherein the accessory system includes at least one of the heat exchanger assembly or an accessory gearbox.

4. The gas turbine engine of claim 1, wherein the accessory system includes at least one of an accessory gearbox, a computing system, an electric machine, a power electronics device, and a heat exchanger assembly.

5. The gas turbine engine of claim 1, wherein the accessory cavity is defined in an aft portion of the core cowl.

6. The gas turbine engine of claim 1, wherein the turbomachine comprises at least in part a fan duct and a heat exchanger located in an aft 50% of the fan duct.

7. The gas turbine engine of claim 6, further comprising:
an outer cowl assembly comprising an outer cowl disposed circumferentially around the turbomachine, wherein the outer cowl defines a maximum radius, wherein the fan duct comprises a forward portion, wherein the forward portion of the fan duct defines a maximum radius, and wherein the maximum radius of the fan duct is at most 65% of the maximum radius of the outer cowl.

8. The gas turbine engine as in claim 1, wherein the heat exchanger is configured as part of the outer cowl assembly the CD R is between 2.8 and 3.3.

9. The gas turbine engine as in claim 1, wherein the core engine is cantilever mounted at a forward end, and wherein the accessory system is mounted within the accessory cavity to reduce a vibratory response of the core engine during operation.

10. The gas turbine engine as in claim 1, wherein the CLR is between 0.3 and 0.45, and wherein the CLR is between 0.40 and 0.45.

11. The gas turbine engine as in claim 1, wherein a void is defined between the outer surface of the combustor casing and the inner surface of the core cowl.

12. The gas turbine engine as in claim 11, further comprising at least one engine accessory coupled to the inner surface of the core cowl.

13. The gas turbine engine as in claim 1, further comprising:
a rear frame including a strut having a trailing edge, wherein the primary fan includes a primary fan blade having a leading edge, and wherein the overall core axial length (L) along the axial direction is measured from the leading edge of the primary fan blade to the trailing edge of the strut.

14. The gas turbine engine as in claim 1, further comprising:
a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

15. The gas turbine engine as in claim 1, further comprising a ducted secondary fan disposed downstream from the primary fan.

16. The gas turbine engine as in claim 15, wherein the ducted secondary fan is a single stage secondary fan.

17. The gas turbine engine as in claim 15, wherein the gas turbine engine is a three-stream gas turbine engine.

18. An aircraft, comprising:
a wing; and
a gas turbine engine mounted to the wing, the gas turbine engine defining an axial direction and a radial direction, the gas turbine engine comprising:
a turbomachine having an unducted primary fan, a core engine including a combustor and a combustor casing enclosing the combustor and defining an outer surface, a core cowl surrounding at least a portion of the core engine and defining an inner surface and an outer surface, the inner surface defining in part an accessory cavity and the turbomachine comprising an accessory system mounted at least partially within the accessory cavity;
wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction,
wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L),
wherein the CDR is between 2.7 and 3.5 and wherein the CLR is between 0.25 and 0.50.

19. The aircraft as in claim 18, wherein the accessory cavity is defined in a forward portion of the core cowl.

20. The aircraft as in claim 18, wherein the accessory system includes at least one of the heat exchanger assembly or an accessory gearbox.
